(19) United States
(12) Patent Application Publication
(10) Pub. No.: US 2026/0271880 A1
(43) Pub. Date: Sep. 17, 2026

(54) Phylogenetic-Based Knowledge Curation System for Cross-Generational Animal Behavior Transfer

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/177,640

(22) Filed: Apr. 14, 2025

Related U.S. Application Data
(63) Continuation-in-part of application No. 19/172,638, filed on Apr. 7, 2025.
Application No. 19/172,638 is a continuation-in-part of application No. 19/094,808, filed on Mar. 28, 2025.
Application No. 19/094,808 is a continuation-in-part of application No. 19/078,192, filed on Mar. 12, 2025.

(51) Int. Cl. A01K 15/02; G06N 5/022; G10L 17/26

(52) U.S. Cl. CPC A01K 15/02; G06N 5/022; G10L 17/26

(57) ABSTRACT

A phylogenetic-based knowledge curation system implements adaptive information transfer protocols for cross-generational transmission of behavioral patterns in animals. The system comprises a neural signal acquisition subsystem that captures multi-channel electrophysiological data; a phylogenetic analysis framework that quantifies evolutionary communication pattern divergence; and a hierarchical knowledge repository architecture that encodes successful behavioral adaptations with mathematically optimized information density. The disclosed methods implement information-theoretic algorithms to maximize information transfer during knowledge transfer operations while minimizing computational and information complexity in the transmitted behavioral patterns and information to drive significant improvements in knowledge acquisition efficiency and transfer across multiple taxonomic lineages. The system dynamically modulates transmission protocols based on species-specific neural plasticity coefficients, enabling accelerated training paradigms for service animals through targeted neuromodulatory stimuli delivery.

### CROSS-REFERENCE TO RELATED APPLICATIONS

Priority is claimed in the application data sheet to the following patents or patent applications, each of which is expressly incorporated herein by reference in its entirety:
Ser. No. 19/172,638
Ser. No. 19/094,808
Ser. No. 19/078,192

### BACKGROUND OF THE INVENTION

### Field of the Art

The present disclosure relates to the field of animal study. More specifically, the disclosure pertains to systems and methods that focus on animal behavior.

### Discussion of the State of the Art

Throughout history, humans and animals have formed a symbiotic bond, influencing both civilization and daily life. This relationship is built on mutual benefit. For example, humans offer shelter and care, while animals contribute through labor, transportation, companionship, and even survival assistance. Horses revolutionized transportation, enabling people to travel faster and over greater distances. Historically, horses were also central to warfare, pulling chariots, carrying soldiers, and serving as a vital component of cavalry units. Additionally, mules have been used for hauling heavy loads in mining, agriculture, and construction, especially in rugged terrains where machinery is impractical. In a similar manner, oxen have been critical in farming, pulling plows and carts to cultivate large areas of land, especially before the advent of modern machinery. Dogs have been indispensable in hunting, helping track and retrieve game. Dogs also have been used for guarding livestock, property, and even as loyal companions. These partnerships highlight how humans have invested time in the training of various animals in order to solve problems, build societies, and advance technologies.

### SUMMARY OF THE INVENTION

Disclosed embodiments provide phylogenetic-based systems and methods for curating and transferring knowledge across generations of animals, incorporating information theory principles to optimize communication patterns. The disclosed techniques include maintaining a dynamic knowledge repository that captures successful behavioral patterns, communication strategies, and environmental adaptations, enabling the transmission of vital survival and operational knowledge across generations while minimizing complexity and maximizing information transfer efficiency.

Improperly trained service dogs, especially those used for scent detection in law enforcement and search-and-rescue operations, can pose significant risks and disadvantages. A poorly trained detection dog may produce false positives or fail to detect critical scents, leading to wrongful searches, overlooked evidence, or delays in locating missing persons. In high-stakes situations, such as narcotics detection or suspect pursuit, an unreliable canine can mislead officers, wasting valuable time and resources. Similarly, search-and-rescue dogs that lack proper training may struggle to track victims or cadavers effectively, potentially compromising emergency response efforts. Without rigorous and ongoing training, these dogs may also become distracted or respond inconsistently to commands, reducing their effectiveness in critical situations.

Training service dogs is a complex and time-intensive process that requires months or even years of rigorous conditioning, and not all animals are ultimately suited for the job. The selection process itself is demanding, as only a fraction of candidates possess the necessary temperament, intelligence, and physical endurance to succeed. Even among those selected, some may struggle to meet performance standards despite extensive training, leading to the difficult decision of removing them from the program. The long training period also reduces the overall time a service dog can actively work before retirement, limiting their years of effectiveness. Additionally, maintaining high training standards requires continuous reinforcement, handler compatibility, and adaptation to evolving tasks, all of which add to the challenge. Factors such as stress, burnout, and potential health issues further complicate the process, making service animal training both resource-intensive and unpredictable.

Disclosed embodiments can leverage the successful training of previous generations of animals that have learned to perform various tasks. Such tasks can include search and rescue, exploration, surveillance, and more. Disclosed embodiments provide a phylogenetic-based system for curating and transferring knowledge across generations of animals that presents a revolutionary approach to training by leveraging principles of information theory and neural conditioning. By maintaining a dynamic knowledge repository that captures successful behavioral patterns, communication strategies, and environmental adaptations, this system ensures that vital survival and operational knowledge is efficiently transmitted while minimizing cognitive load and training complexity. This database can include detailed neural response records from previously trained animals, such as EEG (electroencephalography) brainwave data, allowing for an optimized training process that builds on the cognitive foundations of prior generations.

By analyzing neural activity from successfully trained animals, disclosed embodiments can identify optimal learning pathways and key response patterns that led to task mastery. These neural patterns are then reintroduced into newer generations through targeted stimuli, such as aural cues, haptic feedback, and visual patterns, to evoke similar cognitive and behavioral responses. These techniques can accelerate the learning process by conditioning animals to recognize and respond to training cues more rapidly, effectively priming their neural networks for specific tasks. Such an approach reduces overall training time while improving consistency and efficiency, allowing service animals to begin active duty sooner while ensuring a higher success rate. Additionally, disclosed embodiments can provide an adaptive framework where training methodologies can evolve over time, continuously refining best practices for animal communication and task execution. Moreover, disclosed embodiments can also provide guidance for trainers, including training strategies, schedules, and/or other recommendations. One or more embodiments can further integrate with training devices, such as scent dispensing systems, and/or other visual, haptic, and/or aural stimulation systems to enable accelerated training of service animals.

According to a preferred embodiment, there is provided a system for phylogenetic-based curating and transferring of knowledge across generations of animals, comprising: a computing device comprising at least a memory and a processor; and a plurality of programming instructions that, when operating on the processor, cause the computing device to: receive non-human animal neural signal data; receive non-human animal vocalization data that corresponds to the neural signal data; receive non-human animal behavioral data that corresponds to the vocalization data; receive metadata that corresponds to the neural signal data; process the neural signal data, vocalization data, behavioral data, and metadata through a knowledge curation and generational learning subsystem, wherein the knowledge curation and generational learning subsystem is configured to: associate received metadata with the neural signal data, vocalization data, and behavioral data; input the neural signal data, vocalization data, behavioral data, and associated metadata to a large language model (LLM); obtain an adaptive animal training curriculum from the LLM; and render and present an audio/visual form of the adaptive animal training curriculum on an output device of the computing device.

According to another preferred embodiment, there is provided a method for phylogenetic-based curating and transferring of knowledge across generations of animals, comprising: receiving non-human animal neural signal data; receiving non-human animal vocalization data that corresponds to the neural signal data; receiving non-human animal behavioral data that corresponds to the vocalization data; receiving metadata that corresponds to the neural signal data; processing the neural signal data, vocalization data, behavioral data, and metadata through a knowledge curation and generational learning subsystem, wherein the knowledge curation and generational learning subsystem is configured to: associating received metadata with the neural signal data, vocalization data, and behavioral data; inputting the neural signal data, vocalization data, behavioral data, and associated metadata to a large language model (LLM); obtaining an adaptive animal training curriculum from the LLM; and rendering and presenting an audio/visual form of the adaptive animal training curriculum on an output device of a computing device.

According to another embodiment, there is further included a phylogenetic analyst agent, wherein the phylogenetic analyst agent is configured to generate a phylogenetic tree based on the received non-human animal vocalization data.

According to another embodiment, the phylogenetic analyst agent is further configured to generate a time-calibrated phylogenetic tree based on the generated phylogenetic tree, based on divergence times encoded into the received metadata.

According to another embodiment, the LLM is further configured to generate one or more trait distributions based on the received non-human animal vocalization data, and wherein the knowledge curation and generational learning subsystem further comprises an embeddings cache, wherein the embeddings cache is configured to enable storage and retrieval of intermediate embeddings corresponding to the one or more trait distributions.

According to another embodiment, the knowledge curation and generational learning subsystem further comprises a knowledge base, wherein the knowledge base is configured to enable storage and retrieval of knowledge representations derived from one or more animals.

According to another embodiment, the knowledge curation and generational learning subsystem further comprises a geospatial information system, wherein the geospatial information system is configured to enable spatiotemporal tagging of the received non-human animal neural signal data.

According to another embodiment, the knowledge curation and generational learning subsystem further comprises a multimodal reinforcement module, wherein the multimodal reinforcement module is configured to output one or more neural hints with audio patterns that correspond to the adaptive animal training curriculum.

According to another embodiment, the multimodal reinforcement module is further configured to modify at least one of a pitch, tempo, and rhythm of the audio patterns.

According to another embodiment, there is provided a non-transitory, computer-readable medium comprising programming instructions for an electronic computation device executable by a processor to cause the electronic computation device to: receive non-human animal neural signal data; receive non-human animal vocalization data that corresponds to the neural signal data; receive non-human animal behavioral data that corresponds to the vocalization data; receive metadata that corresponds to the neural signal data; process the neural signal data, vocalization data, behavioral data, and metadata through a knowledge curation and generational learning subsystem, wherein the knowledge curation and generational learning subsystem is configured to: associate received metadata with the neural signal data, vocalization data, and behavioral data; input the neural signal data, vocalization data, behavioral data, and associated metadata to a large language model (LLM); obtain an adaptive animal training curriculum from the LLM; and render and present an audio/visual form of the adaptive animal training curriculum on an output device of the computing device. In embodiments, the output device an include an electronic display.

### BRIEF DESCRIPTION OF THE DRAWING FIGURES

FIG. 1 shows an exemplary environment in which a system for multimodal orchestration for human-animal-robot collaborative task execution can be used, in accordance with one or more embodiments.

FIG. 2 is a block diagram illustrating components of a system for multimodal orchestration for human-animal-robot collaborative task execution, in accordance with one or more embodiments.

FIG. 3 is a block diagram illustrating details of a neural interface component, in accordance with one or more embodiments.

FIG. 4 is a block diagram illustrating details of a translation processing unit, in accordance with one or more embodiments.

FIG. 5 is a block diagram illustrating details of a multi-species output unit, in accordance with one or more embodiments.

FIG. 6 is a block diagram illustrating details of a multi-species collaboration layer, in accordance with one or more embodiments.

FIG. 7 is a block diagram illustrating details of a large language model (LLM) or other AI or symbolic reasoning or neurosymbolic orchestration system, in accordance with one or more embodiments.

FIG. 8 is a block diagram illustrating details of a Simultaneous Localization and Mapping (SLAM) system, in accordance with one or more embodiments.

FIG. 9 is a block diagram illustrating an exemplary training system for multimodal orchestration for human-animal-robot collaborative task execution, in accordance with one or more embodiments.

FIG. 10 is a block diagram illustrating components of a system for phylogenetic-based knowledge curation and transferring of knowledge across generations of animals, in accordance with one or more embodiments.

FIG. 11 shows an exemplary phylogenetic tree for studying animal communication, in accordance with one or more embodiments.

FIG. 12 shows an exemplary environment in which a system for phylogenetic-based knowledge curation and transferring of knowledge across generations of animals can be used, in accordance with one or more embodiments.

FIG. 13 shows a block diagram of an exemplary non-invasive sensor, in accordance with one or more embodiments.

FIG. 14 is a flow diagram illustrating an exemplary method for phylogenetic-based knowledge curation and transferring of knowledge across generations of animals, in accordance with one or more embodiments.

FIG. 15 is a flow diagram illustrating an exemplary method for training a system for phylogenetic-based knowledge curation and transferring of knowledge across generations of animals, according to one or more embodiments.

FIG. 16 illustrates an exemplary computing environment on which an embodiment described herein may be implemented, in full or in part.

FIG. 17 is a block diagram of an exemplary architecture of a phylogenetic knowledge repository system, a sophisticated platform designed to systematically acquire, process, store, generalize, and deploy behavioral and cognitive knowledge across successive generations of diverse animal species.

FIG. 18 is a block diagram illustrating an exemplary architecture of a comprehensive framework for an advanced bidirectional BCI-LLM fusion system, representing a sophisticated technological platform engineered to facilitate nuanced, contextually-aware communication between humans and diverse species.

FIG. 19 is a block diagram illustrating an exemplary architecture of a multi-agent LLM orchestration system, a sophisticated technological framework designed to enable seamless coordination and nuanced interaction among heterogeneous physical agents including humans, animals, and robotic entities.

FIG. 20 is a block diagram illustrating an exemplary architecture of an advanced ethical AI integration and neurosymbolic deontic reasoning system specifically designed to ensure and enhance animal welfare in training, communication, and interaction contexts.

FIG. 21 is a block diagram illustrating an exemplary architecture of an advanced personalization and continual learning framework designed to dynamically optimize animal training methodologies through sophisticated machine learning techniques and adaptive feedback mechanisms.

FIG. 22 is a block diagram illustrating an exemplary embodiment of a distributed neural synchronization framework.

FIG. 23 is a block diagram illustrating an exemplary embodiment of an advanced neuromorphic cross-modal biological signal integration framework.

FIG. 24 is a block diagram illustrating an exemplary architecture of an advanced orchestration system specifically designed to manage edge cases and ensure enhanced robustness in complex interactions between humans, animals, and robotic agents.

FIG. 25 is a block diagram illustrating an exemplary architecture of an information-theoretic optimization system designed for cross-generational knowledge transfer in animal populations.

FIG. 26 is a block diagram illustrating an exemplary architecture of a speculative decoding system for natural language processing applications that incorporates a dynamically optimized tree structure and employs an advanced token sampling and verification methodology to enhance decoding efficiency and accuracy.

FIG. 27 is a block diagram illustrating a hierarchical multi-hop attention aggregation system.

FIG. 28 is a block diagram illustrating a hierarchical multi-dimensional mesh network architecture representing an advanced interconnect system designed to enhance computational performance through intelligent workload-specific routing optimizations and adaptive link utilization.

FIG. 29 is a block diagram illustrating an integrated intelligence orchestration environment representing a comprehensive hardware-software ecosystem.

The drawings are not necessarily to scale. The drawings are merely schematic representations, not intended to portray specific parameters of the disclosed embodiments. The drawings are intended to depict only typical embodiments of the invention, and therefore should not be considered as limiting in scope.

### DETAILED DESCRIPTION OF THE INVENTION

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or FIGURES that form a part of the present disclosure, and in which are shown, by way of illustration, specific arrangements of one or more of the aspects. It should be appreciated, however, that such features are not limited to use in the one or more particular aspects or FIGURES with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in FIGURES should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “phylogenetic tree” refers to a branching diagram that represents the evolutionary relationships among species based on shared ancestry. A phylogenetic tree can visually depict how different organisms have diverged from common ancestors over time, using genetic, morphological, or behavioral data. Thus, a phylogenetic tree can serve as a hierarchical map of evolutionary history, illustrating the connections between species or traits.

As used herein, “Simultaneous Localization and Mapping” (SLAM) is a technique where a robot or device or data processing system can simultaneously build a map or word representation of an unknown or partially observed environment and determine, refine, or estimate its position within that map, space, or world representation. SLAM is well-suited for autonomous navigation in scenarios where pre-existing maps or space characterizations are unavailable.

As used herein, “Geospatial Information System” (GIS) refers to a technology used to collect, store, analyze, and visualize spatial or geographic data. A GIS enables users to understand patterns, relationships, and trends by mapping and analyzing data tied to specific locations.

As used herein, “Canine” refers to members of the Canidae family, which includes domestic dogs (Canis lupus familiaris), and particularly to domestic dogs.

### Conceptual Architecture

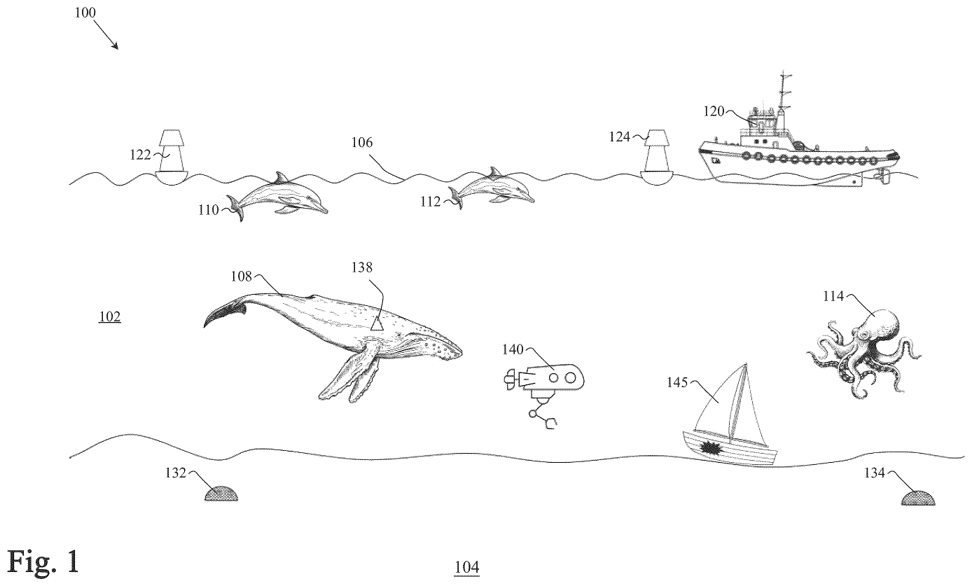

FIG. 1 shows an exemplary environment in which a system for multimodal orchestration for human-animal-robot collaborative task execution can be used, in accordance with one or more embodiments. Environment 100 can include a large body of water 102. However, disclosed embodiments are not limited to use in aquatic environments. Some embodiments may interact with land animals and/or flying animals and may be used in environments involving aquatic, land-based, and/or above-ground environments. Large body of water 102 can include an ocean (e.g., Pacific Ocean, Atlantic Ocean, etc.), a sea, (e.g., Mediterranean Sea, Baltic Sea, etc.), a lake (e.g., Lake Superior, Lake Victoria, etc.), a river (e.g., Mississippi River), a gulf (e.g., Gulf of Mexico), a bay (e.g., Hudson Bay), a strait (e.g., Bering Strait), a fjord, an estuary, a man-made reservoir, and/or other suitable large body of water.

The environment 100 can include one or more buoys, indicated as 122 and 124 in environment 100. In one or more embodiments, the buoys (122, 124) float on the surface 106 of the body of water 102, and can include a variety of equipment for sensing, receiving, storing, and/or transmitting data, as well as one or more output devices. The buoys can include one or more atmospheric sensors. The atmospheric sensors can include a wind speed sensor, wind direction sensor, air temperature sensor, air humidity sensor, barometric pressure sensor, solar radiation sensor, microphone, and/or other suitable atmospheric sensors.

The buoys can include one or more water-based sensors. The water-based sensors can include temperature sensors (to measure surface water temperature), salinity sensors (to determine the salt content of the water), pH sensors (to measure acidity/alkalinity), dissolved oxygen sensors (to monitor oxygen levels for aquatic life), and/or turbidity sensors (to measure water clarity). The water-based sensors may include wave height and direction sensors to measure ocean swell and surface conditions, current velocity sensors (to track underwater currents), tide and sea level sensors, and/or chlorophyll sensors (to estimate plankton levels and water productivity). The water-based sensors may include underwater microphones to detect underwater sounds from aquatic life and/or marine craft. The buoys can include one or more meteorological sensors, such as rain gauges and/or lightning detectors.

The buoys can include a variety of communication equipment, such as satellite transmitters (e.g., Iridium) for long-range communication. The buoys may include cellular modems, suitable for communication within areas of network coverage. The buoys may include radio transmitters to enable short-range transmission for local stations or vessels. The buoys may include Wi-Fi and/or Bluetooth modules to support local data access when in close proximity. The buoys may include GPS receivers to track buoy position and movement. Other communication systems may be present on the buoys in one or more embodiments. The buoys can include a wide variety of output devices, including, but not limited to, signal lights, audible alarms, underwater speakers, out-of-water speakers, and/or digital displays. The buoys can include a variety of computing devices, such as embedded microcontrollers, edge processors, data loggers, and/or other suitable computing equipment. In one or more embodiments, the buoys may include AI-based edge devices for advanced tasks such as detecting patterns, identifying marine life, and/or predictive analysis.

The environment 100 may further include one or more seafloor detection devices, that are located on seafloor 104, indicated at 132 and 134. Each seafloor detection device (132, 134) can include a seismometer, hydrophone array, and a wide range of other sensors and technologies for monitoring vibrations, seismic activity, and underwater sounds. The seafloor detection device can include a broadband seismometer for capturing a wide range of seismic frequencies. The seafloor detection device can further include a short-period seismometer to focus on high-frequency vibrations. The seafloor detection device can further include one or more accelerometers for measuring ground accelerations for vibrations caused by earthquakes, underwater landslides, or human-made activities such as drilling.

The hydrophone array within the seafloor detection devices can enable detecting soundwaves from marine mammals such as whales and dolphins. Other sounds may also be detected by the hydrophone array. These sounds can include sounds from underwater explosions, ship noise, or submarine movements. One or more hydrophones within the hydrophone array may be tuned for capturing low-frequency sounds from large marine animals and/or geological events. The seafloor detection devices may further include a current meter to track underwater currents that may result from tectonic and/or seismic activity.

In one or more embodiments, the seafloor detection devices may be communicatively coupled to one or more surface devices, such as buoys (122, 124), and/or ship 120. The communicative coupling can include cables, such as copper cables, fiber-optic cables, or the like, between a seafloor detection device and a buoy. The communicative coupling can include wireless communication such as RF-based communication and/or acoustic modems that can transmit data via sound waves to nearby surface buoys, ships, or other underwater devices.

In one or more embodiments, the seafloor detection devices may be communicatively coupled not only to fixed surface platforms (such as buoys (122, 124) or ship 120) via traditional hard-wired connections (e.g., copper cables, fiber-optic cables), but also to an array of additional surface and mobile devices. In these embodiments, the coupling architecture is expanded to include hybrid interconnects that integrate both cabled and wireless communication methods. For example, fiber-optic cables may be deployed in a dual role where they serve as both high-bandwidth data conduits and distributed acoustic sensors (DAS) capable of real-time seismic and ambient sound monitoring. In parallel, inductive modem telemetry may be employed along these cables, facilitating real-time data relay from the seafloor to surface nodes even under conditions of cable movement or dynamic environmental stresses.

Furthermore, the system optionally integrates a comprehensive suite of sea sensors, whereby the seafloor detection device is equipped with a modular sensor pod that includes:

Environmental Monitoring Sensors: Embedded microelectromechanical systems (MEMS) that measure parameters such as temperature, salinity, turbidity, pH, dissolved oxygen, and chlorophyll levels. These sensors are calibrated to operate across a wide range of oceanographic conditions and are integrated into self-diagnostic arrays for continuous quality assurance.

Motion and Depth Sensors: Precision pressure transducers and inertial measurement units (IMUs) to capture fine-grained metrics of depth, tilt, and acceleration, enabling accurate mapping of both the seafloor topography and the dynamic response of the detection device to underwater currents.

Acoustic Sensors: Broadband hydrophones and DAS-enabled fiber-optic sensors that capture ambient and transient acoustic signatures, enabling the detection of seismic activity, marine life vocalizations, and anthropogenic noise. These acoustic channels are integrated with digital signal processing modules that implement robust error correction and adaptive filtering algorithms.

Electromagnetic and Optical Sensors: Advanced electromagnetic (EM) sensors for controlled-source electromagnetic (MCSEM) measurements, and optical sensors (such as low-light CCD or CMOS arrays) for capturing light intensity variations, which can be used for biodetection and habitat mapping. Integrated sensor systems may combine these modalities to provide a composite picture of both the chemical and physical state of the underwater environment.

In addition to fixed sensor modules, the system architecture supports integration with mobile sensor platforms. Autonomous underwater vehicles (AUVs) and remotely operated vehicles (ROVs) may be dynamically linked into the network via short-range optical communication or low-power acoustic modems. These mobile nodes serve both as data mules-relaying high-resolution sensor data from hard-to-reach areas- and as adaptive measurement platforms that can reposition in response to detected anomalies. Wireless Sensor Networks (WSNs) based on protocols such as ZigBee or custom cluster-based routing algorithms are utilized to form a mesh network, which allows for robust, energy-efficient inter-node communication over large spatial scales. The network architecture further supports multi-hop relay strategies to overcome the intrinsic limitations of underwater radio-frequency propagation, thereby ensuring reliable data transmission even in the presence of severe attenuation or multipath effects.

To enable scalable and real-time data fusion, the communications framework incorporates a hierarchical protocol stack. At the lowest level, raw sensor data is pre-processed using on-board microcontrollers employing advanced signal conditioning and compression algorithms. This pre-processed data is then transmitted either over a dedicated cabled channel (using fiber-optic or copper-based links) or via an RF/acoustic/wireless interface to a surface gateway. At the gateway, a high-performance computing module aggregates data streams from multiple seafloor devices and mobile platforms, executing machine learning-driven analytics to extract environmental trends and detect anomalies. The system is further configured for bi-directional communication, allowing for remote reconfiguration of sensor parameters and adaptive control of the mobile nodes in response to real-time analysis.

Collectively, these embodiments describe a versatile and integrative underwater monitoring system that leverages state-of-the-art sensor technologies and a multi-modal communication framework. By enabling both fixed and mobile sensor integration through a combination of wired and wireless methodologies, the system provides a robust, scalable solution for continuous, high-resolution monitoring of underwater environments. This innovative approach is particularly advantageous for applications in oceanographic research, habitat monitoring, maritime security, and sustainable resource management, where comprehensive real-time data acquisition and analysis are critical.

The environment 100 can include ship 120. Ship 120 can contain one or more computing devices, such as a data server, virtualized computing environment, and/or other computing devices for enabling and/or supporting the multimodal orchestration system of disclosed embodiments. Additionally, ship 120 can provide long range communication to one or more remote servers, via the Internet. In one or more embodiments, ship 120 may be equipped with satellite communication (SATCOM). In embodiments, the ship 120 can be equipped with a satellite antenna. The satellite antenna can enable a connection with a geostationary satellite and/or a low-Earth-orbit (LEO) satellite, that in turn relays data to a ground station connected to the internet. The ship 120 may further be equipped with a cellular transceiver to utilize a cellular network when within the range of coastal areas.

Within the body of water 102, a wide variety of aquatic life may be present. The aquatic life can include one or more dolphins/porpoises, indicated at 110 and 112. These can include the Bottlenose Dolphin (Tursiops truncatus), Common Dolphin (Delphinus delphis), Dusky Dolphin (Lagenorhynchus obscurus), Harbor Porpoise (Phocoena phocoena), Spectacled Porpoise (Phocoena dioptrica), Orca or Killer Whale (Orcinus orca), and/or other varieties of dolphin/porpoise. These intelligent and diverse marine mammals contribute significantly to marine ecosystems and hold a special place in human culture and scientific research. Each species has its unique adaptations to its habitat, from the open ocean to coastal regions and even rivers. In embodiments, communication between the dolphins/porpoises for the multimodal orchestration system of disclosed embodiments may be accomplished by sending acoustic signals to the dolphins/porpoises and/or receiving acoustic signals from the dolphins/porpoises via buoys (122, 124) and/or seafloor detection devices (132, 134).

The aquatic life within body of water 102 can include one or more octopus/squid, indicated at 114. The octopus can include a Common Octopus (Octopus vulgaris), Giant Pacific Octopus (Enteroctopus dofleini), Mimic Octopus (Thaumoctopus mimicus), and/or other types of octopus. The squids can include a Giant Squid (Architeuthis dux), Colossal Squid (Mesonychoteuthis Hamiltoni), Common Squid (Loligo vulgaris), and/or other types of squids. Both octopuses and squids are among the most intelligent invertebrates, exhibiting behaviors that suggest advanced cognitive abilities, such as learning, problem-solving, and communication. In particular, octopuses have been known for their ability to solve complex puzzles, such as opening jars, navigating mazes, and manipulating objects in creative ways. Octopuses like the common octopus (Octopus vulgaris) have demonstrated learning through observation and trial-and-error. Additionally, some squids can learn to avoid predators by associating specific cues (like the presence of certain predators) with danger. These traits and abilities can be used for enabling multimodal orchestration for human-animal-robot collaborative task execution.

The aquatic life within body of water 102 can include one or more whales, indicated generally at 108. The whales can include Baleen whales (Mysticeti) and/or toothed whales (Odontoceti). The Baleen whales can include the Blue Whale (Balaenoptera musculus), Humpback Whale (Megaptera novaeangliae), Fin Whale (Balaenoptera physalus), Minke Whale (Balaenoptera acutorostrata), and/or other varieties of Baleen whale. The toothed whales can include a Sperm Whale (Physeter macrocephalus), Beluga Whale (Delphinapterus leucas), Narwhal (Monodon monoceros), and/or other types of toothed whale.

Beyond whales, embodiments of the present invention provide for communication with a broad array of underwater animals—including marine mammals, fish, reptiles, invertebrates, and amphibians—each of which employs distinct modalities such as acoustic, electrical, optical, chemical, or tactile signals. In one exemplary embodiment, the system comprises a communication interface that integrates multi-modal sensors, wireless transceivers, and advanced signal processing units that are configured to capture and decode the native communicative signals of underwater species and, reciprocally, translate human-generated commands into stimuli that these animals can interpret.

For instance, with respect to marine mammals, the system incorporates specialized hydrophones and piezoelectric transducers that capture the rich vocal repertoire of dolphins (e.g., Tursiops truncatus), including clicks, whistles, and burst-pulse signals used both in echolocation and social communication. These sensors are coupled with digital signal processors (DSPs) that execute real-time spectral analysis, employing Fourier and wavelet transforms to extract key frequency and temporal features. Machine learning algorithms—trained on extensive acoustic datasets—map these features to behavioral or cognitive states, thereby enabling the system to recognize, for example, signature whistle patterns or mimicry cues. Similar sensor and processing arrangements are applied to seals and sea lions, where low-frequency vocalizations are analyzed in conjunction with visual data from integrated underwater camera arrays to resolve context-dependent social signals such as mother-pup calls or territorial disputes.

For communication with fish species, embodiments extend to the use of bioelectrical sensors and high-precision analog-to-digital converters (ADCs) that capture electric organ discharges (EODs) in electric fish, such as electric eels. The system digitizes these bioelectrical signals and subjects them to advanced pattern recognition techniques, including principal component analysis (PCA) and convolutional neural networks (CNNs), to classify signals corresponding to aggressive, courtship, or aggregation behaviors. In addition, for drumming fish (e.g., croakers and drums), piezoelectric pressure sensors are tuned to detect the rhythmic low-frequency sounds produced by swim bladder vibrations. These signals are processed using adaptive time-frequency analysis and error-correction algorithms to separate them from environmental noise and to decode specific communicative markers.

Communication with reptiles, such as sea turtles, is enabled through the integration of ultra-sensitive directional acoustic arrays and low-noise pre-amplifiers capable of capturing the subtle vocalizations or vibratory signals that synchronize hatching events or indicate mating readiness. The captured signals undergo denoising via adaptive filtering and are then analyzed by neural network classifiers to isolate the unique low-amplitude sound patterns from ambient underwater noise.

In embodiments addressing invertebrates, the system leverages high-resolution, underwater imaging sensors that monitor rapid chromatophore changes in octopuses. Advanced computer vision algorithms analyze color and texture dynamics to interpret communicative gestures that may be analogous to language. Additionally, miniature piezoelectric sensors affixed to specific invertebrate habitats capture the transient clapping sounds of cleaner shrimp, while micro-accelerometers and substrate vibration sensors monitor the rhythmic tapping of fiddler crabs. These data streams are processed via a combination of statistical pattern recognition and unsupervised clustering techniques, allowing the system to discern communicative patterns that can be correlated to social or territorial behaviors.

Finally, embodiments extend to aquatic amphibians, such as pipid frogs, where waterproof acoustic sensors and synchronized high-speed video capture the dual auditory-visual signatures of underwater clicking noises and associated behavioral cues. Here, the system employs synchronized time-frequency analysis and deep learning-based classifiers to decode the signals used for mate attraction or territory defense.

In a comprehensive communication framework, all sensor outputs are integrated within a hierarchical network. At the device level, raw signals are conditioned using on-board microcontrollers that perform initial analog filtering and digital compression. Data is then transmitted via a combination of cabled (copper, fiber-optic) and wireless links—including acoustic modems, electromagnetic transceivers, and short-range optical communication modules—to surface nodes or mobile platforms (e.g., autonomous underwater vehicles or remotely operated vehicles). These nodes serve as gateways that relay the pre-processed data to a centralized processing system, where high-performance computing units perform real-time data fusion, anomaly detection, and bi-directional signal translation. The central processor employs a multi-layer neural network architecture incorporating recurrent and convolutional elements to map animal signals to behavioral states and to generate corresponding stimuli (acoustic, electrical, or haptic) for human-to-animal communication.

Collectively, these embodiments provide a novel, bold, and fully enabled interspecies communication system that not only captures the diverse natural signals of underwater animals but also translates and transmits human-generated commands into stimuli intelligible to these species. This integrative approach—leveraging environmental, motion, acoustic, electromagnetic, optical, and multi-modal sensor technologies—opens new avenues for environmental monitoring, scientific research, and marine resource management by enabling dynamic, two-way communication across a broad spectrum of underwater life.

The environment 100 may include one or more marine life wearable electronic devices, such as indicated at 138, affixed to whale 108. The marine life wearable electronic device 138 can include one or more sensors, such as a GPS receiver. The GPS receiver may obtain geolocation data for the whale 108 at times when the whale surfaces. The marine life wearable electronic device 138 may further include one or more acoustic positioning sensors for using triangulation with other devices, such as buoys (122, 124) and/or seafloor detection devices (132, 134) to determine a relative position. The marine life wearable electronic device 138 may further include an accelerometer and gyroscope for tracking movement data, including swimming behavior, diving depth, and/or orientation.

Since whales may communicate via sound, and some whales use echolocation to navigate and find prey, the marine life wearable device 138 may include sensors to detect these sounds or transmit sounds to communicate with the whale 108. The sensors can include a hydrophone to detect vocalizations from the whale (such as songs, calls, or clicks) and record ambient underwater sounds. The marine life wearable device 138 may further include a transducer configured and disposed to emit sounds or vocalizations that can be heard by the whale, facilitating communication and/or behavioral studies. In embodiments, the transducer is tuned to output sounds in frequencies that whales can hear and interact with. In one or more embodiments, the marine life wearable device 138 may further include a haptic module. The haptic module can enable the marine life wearable device 138 to provide tactile feedback to the whale. The haptic vibrations can be delivered through components such as a waterproof vibration device that creates a physical sensation, in order to provide feedback to the whale.

The acoustic communication with whale 108 can include complex vocalizations and communication methods. These sounds can serve various purposes, including navigation, identification, mating, and social interactions. The types of sounds whales produce and the patterns they follow depend on the species, as different whales communicate in different ways. The sounds can include ‘songs.’ These songs are complex, long sequences of sounds that often repeat in patterns and can last for several minutes to hours. Male humpback whales are especially known for their songs, which may be used for mating purposes. The songs consist of different “themes” that are repeated in a specific order and may change over time. The songs can carry for miles underwater, allowing males to attract females or compete with other males.

The sounds can include clicks. The clicks can be short, sharp sounds that are used primarily for echolocation (a form of biological sonar). By emitting clicks and analyzing the returning echoes, whales can navigate and detect prey. In some species, clicks are used for communication, especially in social species like orcas and dolphins, where they may serve to coordinate group behavior or signal social intentions. The sounds can include low-frequency sounds. The low-frequency sounds vary from low-frequency moans and grunts to more intense roars, which are thought to be used for communication over long distances. The sounds are often very deep and can travel hundreds of miles across the ocean. The sounds can include non-vocal sounds, such as tail slaps. Some whales, such as humpback whales, may use physical slaps of their tails (flukes) or pectoral fins to produce sounds that may be used for communication, signaling aggression, or coordinating with others in their group. In one or more embodiments, the sound patterns, and corresponding animal behaviors may be stored in a database or other suitable format to serve as training data for one or more machine learning systems to facilitate interspecies communication between humans and/or one or more non-human animal species.

The marine life wearable device 138 further includes a power source, such as a rechargeable or replaceable battery. In some embodiments, the marine life wearable device 138 may be a disposable device with a one-time use sealed battery, such as a lithium-ion battery. In one or more embodiments, the marine life wearable device 138 may be affixed via a strap to the tail fin, or other appendage of the whale. In embodiments, the strap can be comprised of a biodegradable material that dissolves or decomposes over time, enabling the marine life wearable device 138 to fall off the whale after a period of time, such that the device does not cause any permanent discomfort for the whale. In some embodiments, the marine life wearable device 138 may be affixed via a biodegradable adhesive. The biodegradable adhesive can include a starch-based adhesive, and can be formulated to wear off after a period of time, enabling the marine life wearable device 138 to fall off the whale, such that the device does not cause any permanent discomfort for the whale.

The environment 100 may further include an autonomous underwater vehicle 140. The autonomous underwater vehicle 140 can be an electromechanical device that includes an onboard computer for receiving commands and/or data from ship 120, buoys (122, 124), marine life wearable device 138, and/or seafloor detection devices (132, 134). Embodiments can include receiving additional human communication data, and outputting the additional human communication data to one or more electromechanical devices, such as autonomous underwater vehicle 140. Embodiments can include receiving additional human communication data, and outputting the additional human communication data to one or more electronic devices, such as a remote computing device located on ship 120.

The types of tasks performed by the multimodal orchestration for human-animal-robot collaborative task execution can include search and rescue, exploration, surveillance, and/or other suitable tasks. Environment 100 can include a shipwreck 145. As an example, to determine the precise location of the shipwreck, size of the debris field of the shipwreck, and/or other information, a collaborative task involving humans (e.g., on ship 120), robots (e.g., autonomous underwater vehicle 140), and non-human animals (e.g., whale 108, octopus 114, and/or dolphins 110, 112) can be executed by using AI-enabled interspecies communication techniques, along with Simultaneous Localization and Mapping (SLAM) techniques enabled by sensors, satellite receivers, radar, lidar, RF-based triangulation, and/or other suitable techniques, as will be further described in the description for the FIGURES that follow.

In one exemplary embodiment, the SLAM subsystem is radically enhanced through the integration of a hybrid, multi-modal sensor fusion architecture that unifies deep-learning-based feature extraction with advanced geometric optimization and uncertainty-aware data association techniques. Building upon the core ideas of AirSLAM and SP-SLAM, the system employs a unified point-line network (PLNet) that concurrently detects both keypoints and structural line features under varying illumination conditions, thereby ensuring robust performance even in the presence of dramatic lighting changes. This deep network is augmented with a tri-plane encoding strategy that efficiently captures scene appearance data while preserving geometric fidelity, enabling dense 3D mapping with minimal memory overhead. The extracted features are then fused with inertial and other sensor inputs via lightweight matching algorithms—such as those inspired by LightGlue—to enable real-time visual-inertial odometry, which continuously refines camera pose estimates without relying on traditional keyframe selection.

Simultaneously, the system leverages a plane-based optimization framework reminiscent of the Eigen-Factors approach, where raw 3D point cloud data from LiDAR or RGB-D sensors is aggregated into a compact summation matrix that captures point-to-plane residuals at linear complexity. By decoupling plane estimation from trajectory optimization through a bilevel formulation, the SLAM subsystem achieves rapid convergence and enhanced accuracy even in complex, cluttered environments. Moreover, the incorporation of Bayesian inference techniques—integrating Random Finite Set (RFS) theory—allows the system to model feature uncertainty probabilistically, thereby eliminating the need for heuristic-based data association. This unified approach ensures that ambiguous or occluded features are handled in a statistically robust manner, significantly reducing localization drift and map inconsistency.

Further advancing these capabilities, the SLAM subsystem integrates uncertainty-aware sensor fusion mechanisms that explicitly model the noise characteristics of diverse sensor modalities. For instance, radar measurements are processed using a polar-coordinate uncertainty model that transforms measurement covariances into Cartesian coordinates, while visual sensors benefit from adaptive weighting schemes based on real-time confidence estimates derived from deep-learning predictions. These uncertainty-aware residuals are incorporated into a weighted least-squares optimization framework that dynamically adjusts the influence of each sensor input according to its reliability, ensuring robust performance even in adverse conditions such as low-light, high-dynamic-range, or noisy sensor environments.

In addition, the SLAM framework is further empowered by a multi-modal integration layer that synchronizes data streams from heterogeneous sources—including visible and infrared cameras, acoustic sensors, underwater LiDAR, and electromagnetic sensors—into a coherent spatial-temporal model. Advanced cross-attention mechanisms are employed to correlate features across modalities, yielding a unified representation that is then used to construct and continuously update a dense, real-time map of the environment. This layer also supports a predictive relocalization strategy, wherein a scene-dependent junction vocabulary and directed acyclic graph (DAG) representation of reasoning steps enable rapid recovery from localization failures. As new data is incorporated, the system dynamically refines both the map and the corresponding agent poses, ensuring seamless adaptation to changes in the operational environment.

Collectively, these enhancements—encompassing adaptive deep feature extraction, plane-based bilevel optimization, uncertainty-aware fusion, and multi-modal data integration—yield a SLAM subsystem that not only overcomes the limitations of conventional approaches but also surpasses state-of-the-art systems in terms of accuracy, robustness, and computational efficiency. By integrating these advanced techniques into the multispecies orchestration framework, the invention achieves unprecedented situational awareness and real-time mapping performance, thereby enabling robust, scalable, and resilient coordinated task execution across diverse domains such as terrestrial, maritime, aerial, and space environments.

In one exemplary embodiment, the SLAM subsystem is radically reengineered to integrate a hybrid, multimodal data fusion pipeline that not only overcomes the limitations of current visual SLAM systems in dynamic environments but also exceeds the capabilities of DVDS and advanced LiDAR—visual-inertial semantic mapping approaches. In this embodiment, the system first deploys a dual-phase dynamic object exclusion mechanism that simultaneously processes visual and LiDAR inputs using a multi-task deep neural network framework. This framework leverages state-of-the-art image classification, object detection, and semantic segmentation algorithms to filter out transient, moving objects from static scene elements prior to feature extraction. By doing so, the system isolates reliable features even in environments with heavy occlusions, low-texture regions, or rapidly changing illumination, thereby preventing dynamic interference from corrupting downstream optical flow estimation and point cloud registration.

Once dynamic objects are removed, the filtered data is fed into an enhanced transformer-based feature aggregation module—termed the Dispersive Transformer (DisFormer)—which builds on the concept of Top-K Sparse Attention (TKSA) and Mixed-Scale Feed-Forward Networks (MSFN). DisFormer is designed to extract robust, high-dimensional feature representations from both dense visual frames and sparse LiDAR scans by selectively focusing on the most informative signal components while discarding redundant information. This novel transformer module is seamlessly integrated with a gated recurrent unit (GRU) that iteratively refines pose estimates through dense bundle adjustment, effectively combining temporal information with deep semantic cues to continuously update camera and sensor trajectories in real time.

Further distinguishing this embodiment, an object-level semantic mapping layer is incorporated to handle complex, natural environments such as forests, urban scenes, and industrial settings where GNSS signals are unreliable. This layer employs innovative cluster-block data structures that perform object-level segmentation and tracking; for example, in forested environments, individual tree trunks are segmented from LiDAR point clouds and associated with semantic labels obtained from corresponding visual data. These object-level features are then incorporated into a global optimization framework that minimizes mapping drift by enforcing consistency constraints across multiple frames and sensor modalities. This robust semantic mapping capability not only enhances localization accuracy but also provides rich contextual information that can be used for subsequent interspecies coordination and task execution.

To ensure the system operates in real time on embedded platforms, advanced uncertainty-aware sensor fusion techniques are deployed. Each sensor input—whether visual, LiDAR, inertial, or radar—is assigned a dynamically computed confidence score based on its noise characteristics and environmental conditions. These confidence metrics modulate the weighting of individual sensor contributions within a weighted least-squares optimization framework, thereby enhancing robustness to sensor noise, illumination changes, and partial occlusions. By leveraging GPU-based acceleration and efficient inference engines, the entire SLAM pipeline is optimized for low latency, enabling continuous, real-time mapping and localization even under challenging dynamic conditions.

Collectively, these innovations yield a SLAM subsystem that not only filters dynamic elements and robustly extracts discriminative features using novel transformer-based methods but also integrates object-level semantic understanding and uncertainty-aware sensor fusion into a unified, adaptive mapping framework. This comprehensive approach significantly reduces pose estimation errors and mapping drift, while also providing the high-fidelity, context-rich spatial data necessary for coordinated task execution across heterogeneous domains-including terrestrial, maritime, aerial, and even space environments-thereby setting a new benchmark for real-world SLAM performance.

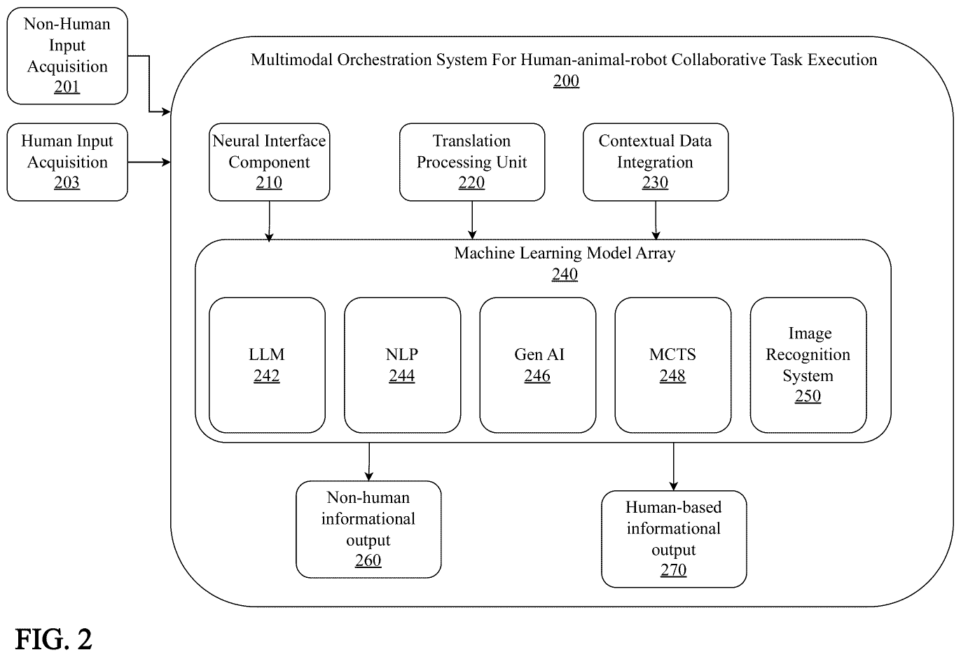

FIG. 2 is a block diagram illustrating components of a system for multimodal orchestration for human-animal-robot collaborative task execution, in accordance with one or more embodiments. System 200 may receive as input, non-human input acquisition 201, and human input acquisition 203. The non-human input acquisition 201 may include input from animals. The input may include audio input. The audio input may include vocalizations such as songs, clicks, chirps, groans, roars, and the like. The audio input may include phonemes and/or words, such as from certain species of birds that are capable of mimicking and producing phonemes from human languages. The audio input can include non-vocal sounds such as tapping or banging sounds from tapping limbs, appendages, or the like. The non-human input acquisition 201 can further include visual information such as sign language gestures, such as may be performed by various primates. The human input acquisition 203 may include spoken language, text input, sign language, and/or other suitable input. The non-human input acquisition 201 and human input acquisition 203 are input to the system for multimodal orchestration for human-animal-robot collaborative task execution 200, and the resulting output can include a non-human informational output 260, and a human-based informational output 270, thereby facilitating interspecies communication.

The system 200 may include a neural interface component 210. The neural interface component 210 can enable the detection of nuanced neural responses from animals that indicate social, emotional, and environmental interactions. The animals can include land animals, such as horses, cats, and dogs. The animals can include aquatic animals, such as whales, dolphins, fish, octopus, and squid. The animals can include birds and other flying animals. In embodiments, the neural interface component 210 may be coupled to the animals to obtain signals indicative of emotional states, and/or other communication patterns.

The system may include phylogenic trees, pangenome graphs, or other methods to incorporate evaluation of genomic or multiomics data whenever available. Below is an exemplary embodiment that builds upon and surpasses prior ideas by integrating multiomics and phylogenomic data into the communication orchestration system. In this embodiment, an Optimal Multiomics and Phylogenomic Communication Orchestration Module (OMPCOM) is introduced. This module is designed to ingest not only the heterogeneous environmental and behavioral sensor data described previously (e.g., acoustic, olfactory, visual, and haptic signals) but also genomic and multiomics information that can be derived from available databases, field-deployed genomic sensors, or even prior ex vivo sequencing of target species. By leveraging advanced data structures such as pangenome graphs and indexing methods like the Graph Burrows-Wheeler Transform (GBWT), the system can rapidly match haplotype segments and evaluate genetic markers that correlate with sensory modalities and communication preferences. In practice, OMPCOM first receives raw multiomics data—ranging from whole-genome sequencing reads to transcriptomic and proteomic profiles—from target animals or representative samples thereof. A dedicated Genomic Data Integration Engine (GDIE) constructs pangenome graphs that capture the full spectrum of genomic variation for the species under consideration. Using GBWT-based algorithms, the system performs efficient haplotype matching to identify key genetic variations, such as allelic variants of olfactory receptor families, auditory sensitivity genes (for example, genes modulating low-frequency hearing thresholds), or vision-related opsin proteins. In parallel, the system builds phylogenetic trees from these haplotype datasets to infer evolutionary relationships and kinship, which can serve as proxies for shared sensory preferences or communication behaviors among individuals and subspecies. By establishing these genomic “communication profiles,” the system can predict the modalities that are likely to be most effective for each target animal or group. Once the genomic profiles are established, OMPCOM fuses this data with real-time environmental and behavioral sensor inputs using a neurosymbolic fusion engine. For instance, if the genomic data reveal that a particular subpopulation of whales possesses genetic markers indicative of heightened low-frequency hearing sensitivity and an evolved propensity for acoustic crypsis (as demonstrated in flight species that call below 80 Hz), then the system will favor the use of low-intensity, low-frequency acoustic signals when communicating with those individuals. Conversely, if genomic markers suggest that certain terrestrial animals, such as domesticated cattle or elephants, have a predisposition for robust olfactory reception due to expansive receptor gene families, the system may select calibrated scent emissions as the primary communication channel in environments where auditory cues are compromised by urban noise. The decision algorithm employs reinforcement learning techniques in a multi-armed bandit framework to weigh the expected utility of each communication modality—considering factors such as environmental noise, predation risk, and even the potential for inadvertent aggregation of non-target species—and updates its modality-selection policy dynamically as additional multiomics and contextual data become available. Furthermore, OMPCOM may be operated in an open, partially open or within a closed-loop feedback system. After a communication event, behavioral responses (e.g., changes in movement patterns, physiological responses measured via wearable biosensors, or even genomic stress markers captured through rapid point-of-care assays) are analyzed to refine both the genomic profiles and the modality selection policy. This iterative process is supported by adaptive caching of frequently observed genomic subgraphs and phylogenetic motifs, which are stored using run-length-compressed indices (e.g., via GBWT) to ensure near-linear space complexity even when operating at biobank scale. The integration of these genomic data structures not only enhances the precision of interspecies communication but also enables the system to adjust for evolutionary pressures—for example, by detecting shifts in haplotype frequencies that may correlate with changes in communication efficacy due to environmental stressors like noise pollution or habitat fragmentation. By combining environmental sensor fusion, real-time SLAM-derived context, and the cutting-edge processing of multiomics data through pangenome graphs and phylogenetic analyses, this embodiment achieves a truly interdisciplinary approach. It leverages computational genomics methods to inform and optimize multispecies communication strategies, thereby surpassing traditional modality selection systems. This innovative integration enables the orchestration system to adaptively choose between acoustic, olfactory, visual, and haptic outputs with unprecedented precision, ensuring that messages are delivered in a form that maximizes reception by the intended species while minimizing unintended interactions—whether in a busy urban environment, a predator-dense ocean, or a field setting where evolutionary histories dictate distinct sensory preferences.

The system 200 can include a translation processing unit 220. The translation processing unit 220 can utilize machine learning models which are trained to correlate neural patterns of animals to known behaviors, vocalizations, and intentions. The system 200 can include a contextual data integration module 230. The contextual integration module 230 can combine modalities (such as neural signals, vocalizations, gestural data, and/or scent vectors) in a multimodal fusion layer. A sliding time window provides temporal alignment, associating changes in scent concentration with concurrent neural or behavioral shifts. The outputs of the neural interface component 210, translation processing unit 220, and/or contextual data integration model 230 are input to machine learning model array 240.

Machine learning model array 240 may include one or more machine learning models, neural networks, and/or other systems for processing and interpreting input data. The machine learning model array 240 can include a large language model 242. The large language model (LLM) 242 can be trained for specific animals (e.g., species-specific or even individual-specific) and can ingest continuous streams of neural population data recorded across multiple tasks and states. These models go beyond simple language: they become multimodal encoders of animal neural signals, motor outputs, observed behaviors, and contextual cues. By structuring training data to include “high-incentive” versus “neutral” tasks, the LLM can learn when the animal's neural signature deviates from its optimal preparatory patterns. In embodiments, the machine-learning system includes a large language model (LLM).

The machine learning model array 240 can include a natural language processing (NLP) module 244. The NLP module 244 can enable the conversion of human speech to animal-understandable patterns. The NLP module 244 can include NLP pipelines that parse human language into semantic tokens. These tokens can then be mapped onto a species-specific “neural command embedding space.” For whales, this might involve converting a request such as ‘swim to the surface’ into a neural stimulation pattern, along with an auditory output pattern such as a song or pattern of clicks. For canines, this might involve converting a request like “Fetch the red ball” into a neural stimulation pattern plus a subtle auditory or tactile cue that aligns with the dog's pre-trained internal representations of the action “fetch” and the visual concept “red ball.”

The machine learning model array 240 can include a generative artificial intelligence (Gen AI) module 246. The Gen AI module 246 can enable supplementing training data with synthesized data, such as vocal data (e.g., canine vocalizations or whale codas), where the vocal data is created with properties such as number and regularity of signal units (clicks, barks), spectral means, and/or amplitude envelopes. The Gen AI module 246 can include a generative adversarial network (GAN), such as WaveGAN, InfoGAN, fiwGAN, and/or other suitable GAN.

The machine learning model array 240 can include a Monte Carlo Tree Search (MCTS) module 248. The MCTS module 248 can enable adaptive, look-ahead scheduling decisions. Instead of applying fixed heuristics or static load-balancing, disclosed embodiments can simulate and/or evaluate multiple future states of the pipeline before choosing the next action. By repeatedly exploring and exploiting different pipeline routing decisions (e.g., which specialist model to send partial outputs to, or how to scale certain pipeline segments), MCTS can minimize the cumulative regret over time, converging toward near-optimal scheduling policies that are robust to changing conditions, input distributions, and latency constraints. In one or more embodiments, the MCTS module 248 can enable enhanced resource allocation, such as allocating more GPUs, selecting specialized hardware accelerators, and/or adjusting batch sizes downstream.

The machine learning model array 240 can include an image recognition system 250. Image recognition system 250 may utilize machine learning to identify objects and gestures in images and video clips. The training can include obtaining a large dataset of labeled images or video clips that include the objects and/or gestures that are to be identified. Using techniques such as convolutional neural networks (CNNs), relevant features from the images are automatically extracted. A machine learning model (e.g., a deep learning model) is trained on the extracted features. Once trained, the model can be used to predict the presence of objects or gestures in new, unseen images and/or video clips. The images and/or video clips can include images of non-human animals exhibiting facial expressions, performing gestures, and/or other interpretable behaviors. Image recognition system 250 may further utilize Haar cascades for object detection. One or more embodiments can include training the Haar cascade classifier using a combination of positive samples and negative samples. The training process can include selecting the most relevant features and creating a cascade of classifiers.

The machine learning model array 240 can include, as an output, non-human informational output 260. The non-human informational output 260 can include audio output. The audio output can include species-specific audio waveforms such as clicks and songs for cetaceans, growling and/or barking sounds for canines, and so on. In an aquatic environment such as depicted in FIG. 1, the audio output may be provided by underwater speakers or other suitable transducers. The non-human informational output can include visual output, such as flashing lights, and/or patterns rendered and presented on an electronic display that is visible to the animals that are participating in the system and/or method for multimodal orchestration for human-animal-robot collaborative task execution.

The machine learning model array 240 can include, as an output, human-based informational output 270. The human-based informational output 270 can include visual information such as text and/or symbology. The human-based informational output 270 can include audio information. The audio information can include synthesized speech, tones, and/or other sounds to convey information identified by the machine learning model array 240. Referring again to the example depicted in FIG. 1, for investigation of the shipwreck 145, the non-human informational output 260 can include audio waveforms that may be interpreted by a whale 108 to swim to a location proximal to the shipwreck 145. The whale 108 may then output audio vocalizations in response to viewing the shipwreck. The output audio vocalizations can be translated by the system 200 to human-based informational output 270 for interpretations by humans. In this way, the non-human informational output 260 and the human informational output 270 can work in tandem to enable human-animal-robot collaborative task execution.

To implement robust machine learning and pattern recognition, the system may include a neural network architecture that processes time-series EEG data using a hybrid model combining convolutional neural networks (CNNs) and recurrent neural networks (RNNs), such as long short-term memory networks (LSTM) or gated recurrent unit (GRU), to capture both spatial and temporal features of the neural signals. For example, a dataset could be assembled that includes annotated brainwave recordings from a variety of species—dogs, cats, horses, and even aquatic mammals like dolphins—collected under controlled conditions. This dataset would label neural patterns corresponding to known emotional states (e.g., excitement, stress, calm) and would be enriched with synthetic data generated by a generative adversarial network (GAN) to augment underrepresented classes. The training process would involve preprocessing steps such as noise filtering, normalization, and segmentation of the EEG signals into fixed-length time windows. Each species' data could be tagged with a unique species embedding vector, allowing the network to learn intrinsic differences across species while sharing common features for emotion recognition.

Hyperparameter tuning would be essential to optimize model performance. For example, techniques like grid search or Bayesian optimization can systematically explore the hyperparameter space to identify the best configuration. Early stopping based on validation loss, coupled with cross-validation across species-specific splits, would ensure that the model generalizes well. Additionally, incorporating a multi-head attention mechanism allows the model to focus on the most informative segments of the neural data, which is crucial when handling the inherent variability of signals from different species. This attention layer helps to dynamically weight features that are particularly indicative of certain emotional states. By jointly training the network on multiple tasks—such as classifying emotional states and reconstructing input signals—the model can further regularize its learning and improve robustness across diverse neural inputs. These combined strategies offer a concrete pathway for developing a machine-learning system capable of accurately interpreting complex and diverse brainwave data across multiple animal species.

The translation processing unit could be implemented using, for example, a sequence-to-sequence model that is specifically trained to map neural signal patterns to structured outputs in human language and vice versa. For example, once a machine learning model has extracted features from the raw neural data—such as temporal patterns indicative of excitement or stress—the translation processing unit takes these features and passes them through an encoder-decoder architecture. The encoder condenses the neural signal embeddings into a latent representation that captures the key elements of the animal's emotional state. The decoder then transforms this representation into a human-understandable output, such as a textual description (“The dog is excited”) or an actionable command (“Sit” or “Come here”). This process can be further enhanced with an attention mechanism, allowing the model to focus on the most informative parts of the neural signal when producing the final output.

In an example implementation, a training dataset can be assembled that pairs neural signal recordings with corresponding behavioral observations and expert annotations, effectively serving as a parallel corpus for training the translation model. For instance, neural recordings captured during a dog's response to a command could be aligned with the known action and emotional label assigned by a trainer. The model could be trained using standard techniques such as teacher forcing during the early stages, gradually transitioning to using its own predictions in a scheduled sampling framework. Additionally, fine-tuning on species-specific subsets of the data allows the translation unit to learn subtle differences between species while maintaining a generalizable mapping framework. This ensures that the system can not only translate between the neural signals and human language but also accurately reflect the intended meaning behind the signals, thereby facilitating more effective and intuitive interspecies communication.

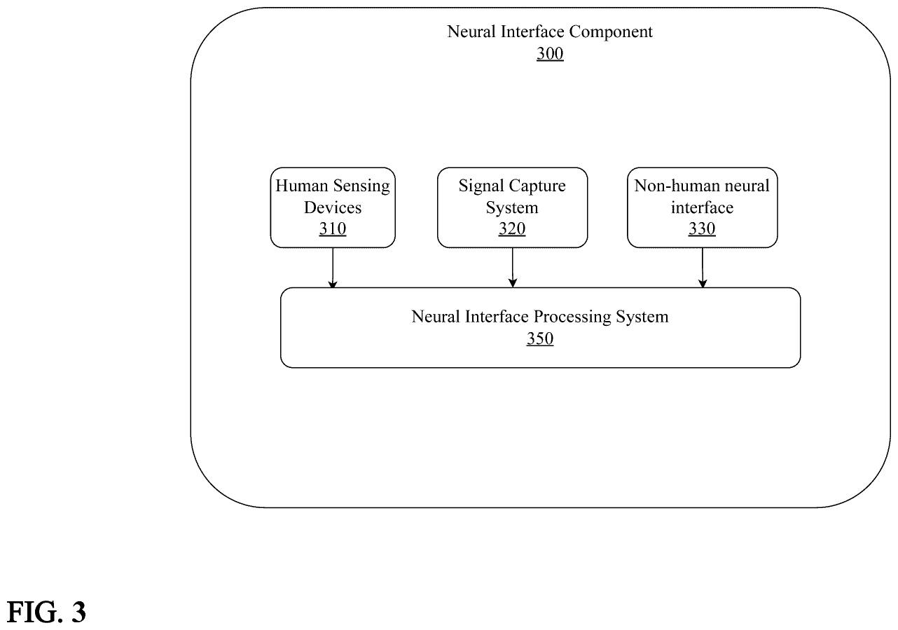

FIG. 3 is a block diagram illustrating details of a neural interface component, in accordance with one or more embodiments. Neural interface component 300 may be similar to neural interface component 210 of FIG. 2, and can include one or more human sensing devices 310. The human sensing devices 310 can include wearable sensors, such as pulse sensors, brainwave monitors, and the like. The human sensing devices 310 can further include cameras, microphones, and/or other sensors for obtaining cognitive state information from a human. The data received by the human sensing devices may be used with NLP module 244 to extract additional context and sentiment from humans participating in human-animal-robot collaborative task execution.

Neural interface component 300 can include a signal capture system 320. The signal capture system 320 can include one or more sensors for capture of neural and physiological signals without distress, adjusted for the physical characteristics of animals, such as cetaceans. In embodiments, neural sensors are embedded within wearable and/or attachable devices suited for underwater and open-ocean deployment. In embodiments, the neural interface includes components tailored to the species' specific anatomy, such as the head or dorsal regions in whales, and made from materials that ensure durability and comfort even in the deep-sea environment.

Neural interface component 300 can include a non-human neural interface 330. The non-human neural interface 330 can include non-invasive sensors that can detect and measure animal brain activity without causing discomfort. These sensors capture neural signals associated with emotions, intentions, and responses to stimuli. The non-human neural interface 330 can further include implanted sensors. Embodiments can include surgically implanting sensor probes inside an animal's brain. In embodiments, this technique can be used in place of a non-invasive sensor package, and can yield additional control and benefits that include the ability to record specific thoughts, evaluate mental state, and other aspects outside of the direct intent to communicate. This also enables capturing the animal's sensory data such as vision and scent. This allows human/animals to not only communicate freely, but opens additional options for working animals. For example, a dog must pass extensive training before it can sniff drugs. With disclosed embodiments, the training may be drastically shortened by reading the animal's brain patterns directly and identifying targeted substances via this data. As part of the training, the non-human informational output 260 (of FIG. 2) may produce a signal to cause happiness or the notion of correctness as a positive reward and drastically speed training times and animal willingness.

The output of the human sensing devices 310, signal capture system 320, and non-human neural interface 330 can be input to neural interface processing system 350. Neural interface processing system 350 can include an AI-based processing unit that analyzes and interprets vocalization data, behavioral cues, and environmental contexts to foster bidirectional communication between humans and non-human animals. Disclosed embodiments can be well-suited for applications ranging from enhancing human-animal interactions for conservation to advancing scientific understanding of animal languages, particularly in highly social and intelligent species such as sperm whales. Furthermore, disclosed embodiments can enable the use of environmental and behavioral metadata integration, as well as robust machine learning frameworks, allowing creation of an adaptable model for studying communication across various species, making disclosed embodiments adaptable to diverse animal communication needs beyond cetaceans, such as canines, primates, and other species.

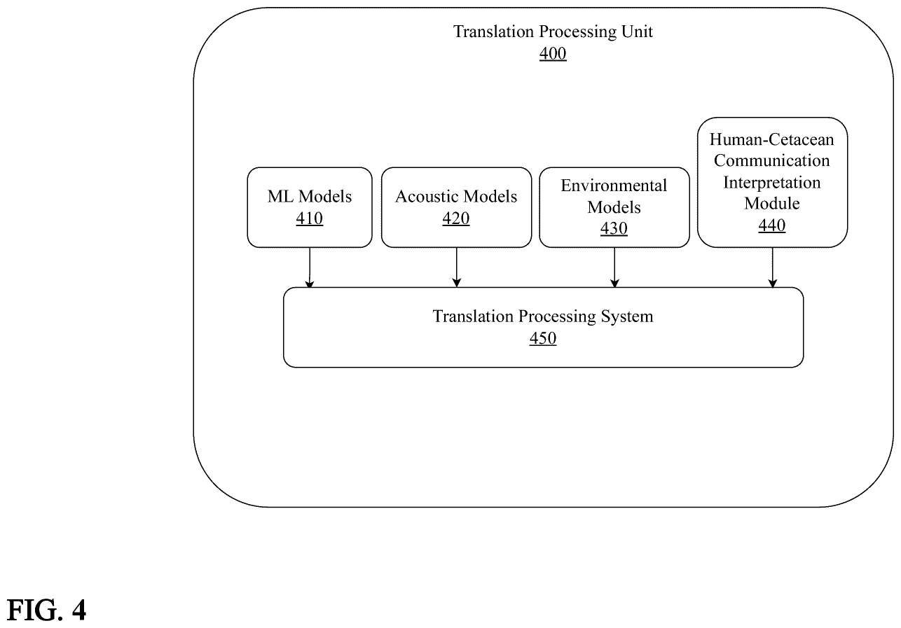

FIG. 4 is a block diagram illustrating details of a translation processing unit, in accordance with one or more embodiments. Translation processing unit 400 may be similar to translation processing unit 220 of FIG. 2, and can include one or more machine learning models 410. In embodiments, the machine learning models 410 can be trained to identify patterns in vocalization, such as codas, tempo, rhythm, ornamentation, and contextual variations like rubato. This training enables disclosed embodiments to decode structured and nuanced elements of cetacean communication, potentially revealing hierarchical or associative structures similar to human language. The translation processing unit 400 can include one or more acoustic models 420. The acoustic models 420 may enable replication of fricative production. This includes adjusting tongue position, airflow velocity, and constriction points. The translation processing unit 400 can further include one or more environmental models 430. The environmental models 430 can include probabilistic models to capture the uncertainty and variability inherent in fricative sound production and perception. The translation processing unit 400 can further include a human-cetacean communication interpretation module 440. In embodiments, the human-cetacean communication interpretation module 440 can enable mappings between humans and cetaceans. As an example, the clicks, songs, and codas of whales can be processed via machine learning, and mapped to human sentiments, such as danger, affection, joy, aggression, curiosity, and/or cooperation. In embodiments, the human sentiment can be derived from animal outputs, such as sounds made by animals, gestures made by animals, facial expressions made by animals, and so on. The danger may be represented by high-pitched whistles, rapid clicks, and/or abrupt calls. Affection may be represented by soft clicks, whistles, and/or low-pitched moans. Joy may be represented by rapid clicks, whistles, and/or varied, upbeat vocalizations. Aggression may be represented by loud, forceful vocalizations, grunts, or low-frequency rumbles. Curiosity may be represented by short bursts of clicks. Cooperation may be represented by repetitive clicking patterns. In general, cetacean sounds may be catalogued and correlated to a behavioral context.

The translation processing system 450 receives input from the ML models 410, acoustic models 420, environmental models 430, and human-cetacean communication interpretation module 440. The translation processing system 450 can be configured to convert animal neural patterns into human-comprehensible language, conveying the emotional state, intentions, and/or needs of the animal. The translation processing system 450 can further be configured to translate human speech into neural signals or cues that are meaningful and understandable to animals, allowing the animals to comprehend specific commands or sentiments directly. In embodiments, the translation processing system 450 may be configured to produce spoken translations of animal communications, thereby allowing humans to understand an animal's emotions or needs. For instance, the system might translate a dog's neural signals into phrases like “I am hungry” or “I'm feeling anxious.”

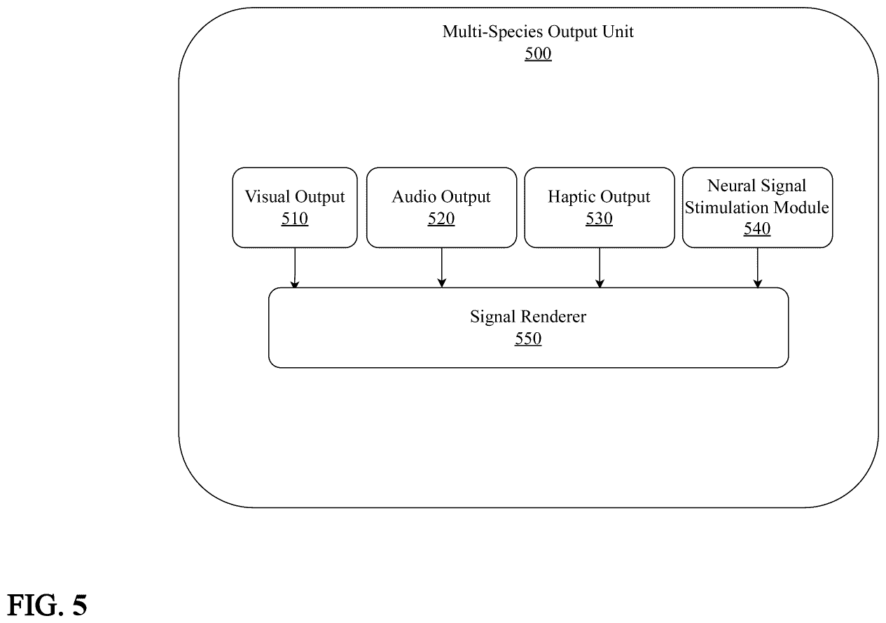

FIG. 5 is a block diagram illustrating details of a multi-species output unit 500, in accordance with one or more embodiments. The multi-species output unit is an innovative computerized system designed to facilitate communication between humans and animals by integrating multiple sensory modalities for output. The visual output subsystem 510 processes and assembles video and image data for output on an electronic display. The visual output is tailored to the perceptual capabilities of the target species, ensuring that animals or humans can interpret the visual signals effectively. The audio output subsystem 520 can be configured to generate audio waveforms that can be output through speakers or other audio devices. The audio output can include species-specific sounds, such as vocalizations, frequencies, or tones, enabling communication in a form recognizable by the intended animal. The haptic output subsystem 530 generates and modulates signals to drive vibratory devices, creating tactile sensations that can be detected via wearable sensors or directly on the animal's skin. The haptic feedback can convey information such as alerts, directions, or emotional cues. The neural signal stimulation module 540 can include electrodes capable of monitoring and interacting with brainwaves of an animal. It can record neural activity and deliver carefully modulated stimulation to influence or reinforce specific neural patterns. This capability offers potential for advanced applications, such as training, behavior modification, or facilitating direct neural communication. The signal renderer module 550 serves as the central decision-making unit, determining the most appropriate output device for each signal. It integrates the outputs from the visual, audio, haptic, and neural modules and ensures that the signals are delivered in a coherent and species-appropriate manner. In embodiments, the multi-species output unit 500 may be integrated into, or communicatively coupled with, non-human informational output 260 and/or human-based informational output 270.

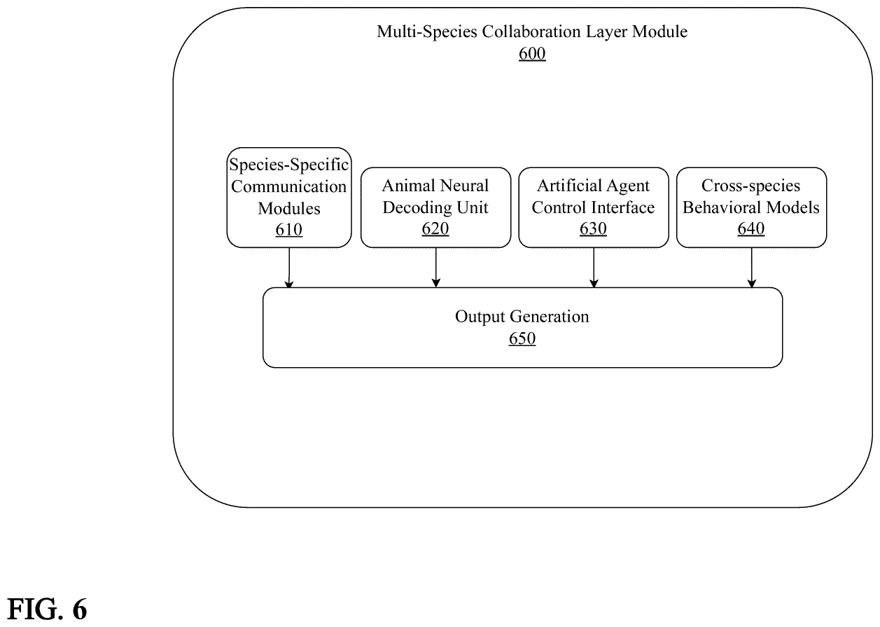

FIG. 6 is a block diagram illustrating details of a multi-species collaboration layer module 600, in accordance with one or more embodiments. The Multispecies Collaboration Layer (MCL) builds on the foundational capabilities of neural interfaces, multimodal sensory processing, and language modeling techniques, extending them to facilitate purposeful, synchronized interaction across species or between animals and machines. Its key functions are to understand interspecies “vocabularies,” align goals, and orchestrate collaborative tasks. The MCL module 600 can include one or more species-specific communication modules 610. In embodiments, each participating species (e.g., dogs, elephants) or artificial agent (e.g., a drone) has its own communication interface and representation layer.

The MCL module 600 can further include an animal neural decoding unit 620. The animal neural decoding unit 620 can be configured to extract interpretable “meaning vectors” from the animal's neural signals and observed behavior. As an example, for a dog, neural patterns plus posture/vocalization cues can produce a “conceptual state embedding” representing intentions and emotional states. The MCL module 600 can further include an artificial agent control interface 630. For a drone, sensor data (LIDAR, camera, GPS) and command frameworks are translated by the artificial agent control interface into abstract action representations (e.g., “search pattern initiated,” “altitude adjustment needed”). The MCL can further include one or more cross-species behavioral models 640. These models can utilize a library of known behavioral cues and tasks common to various species (e.g., “move towards scent,” “alert upon detection of target”) to produce standardized action and intention descriptors.

The MCL module 600 further includes an output generation module 650 that receives input from the species-specific communication modules 610, animal neural decoding unit 620, artificial agent control interface 630, and/or cross-species behavioral models 640. The output generation module 650 then generates an appropriate output signal, which can include a video signal, audio signal, haptic signal, and/or other bioelectrical signal for conveying sentiment and/or meaning among humans and non-human animals. The output generation module 650 can output data in a wide variety of digital and/or analog formats, including pulse code modulated (PCM) audio, raw video formats, compressed video formats, and/or other suitable formats.

In embodiments, the Multispecies Collaboration Layer can be configured to provide a unified, context-driven platform enabling animals of different species, as well as robots and/or drones, to collaborate effectively on shared tasks. By creating and refining interspecies dictionaries, using ML models to align intentions, and carefully timing and routing these concepts through a shared task representation space, the MCL module 600 can enable synchronized, purposeful action. This can profoundly enhance capabilities in wildlife conservation, service support, and environments where diverse species and agents work in concert to achieve common goals. In embodiments, the MCL module 600 can be integrated with, or communicatively coupled to, system 200 of FIG. 2.

In one practical implementation, the multi-species output and collaboration module can be architected as a unified system that dynamically translates processed neural data into species-specific output signals, while also synchronizing tasks among humans, animals, and robotic agents. For example, after a machine learning model interprets a dog's neural signals to indicate a specific emotional state—such as excitement—the system can trigger a haptic feedback module on a wearable collar that vibrates in a particular pattern the dog has been trained to recognize as a cue to perform a desired behavior, such as fetching an object. Simultaneously, the system can generate an audio signal customized for canine hearing frequencies, reinforcing the behavioral cue with sound. This dual-modality approach not only improves the clarity of the command for the dog but also provides redundant channels for communication, ensuring that the animal accurately receives the intended message.

To further illustrate, consider a scenario where humans, dogs, and a robotic drone collaborate on a search-and-rescue mission in a disaster zone. The system continuously processes neural and environmental data and utilizes a collaboration layer that integrates inputs from diverse sensors—ranging from the dog's wearable sensor to the drone's cameras and environmental detectors. When the neural interface detects that the dog has identified a potential victim based on its brainwave patterns, the multi-species output module concurrently dispatches a visual signal on the drone (such as a highlighted map marker) and a corresponding auditory cue through a portable speaker for the human responders. This synchronized output ensures that all parties—animal, human, and robot—receive the same situational information in a form they can understand, thereby optimizing coordinated responses in high-stakes environments.

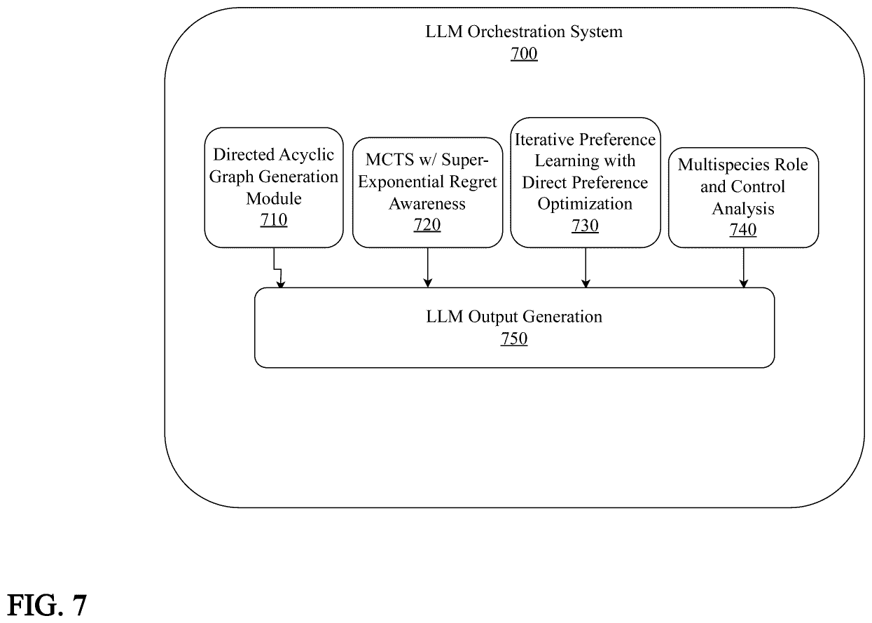

FIG. 7 is a block diagram illustrating details of a large language model (LLM) orchestration system 700, in accordance with one or more embodiments. In embodiments, LLM orchestration system 700 may be integrated with, or communicatively coupled to, LLM 242 of FIG. 2. LLM orchestration system 700 can include directed acyclic graph (DAG) generation module 710. The DAG generation module 710 can create a DAG representing complex workflows in which nodes are reasoning steps, and edges represent transitions from one partial solution to another. In some embodiments, each node encodes the current state of the environment, such as position and behavior of animals, humans' textual instructions, and/or robot sensor readings. The DAG's expansions can correspond to MCTS-like searches over possible reasoning paths, guided by previously described methods (e.g., embedding caches, semantic KGs, preference learning). Embodiments can include generating a directed acyclic graph to represent a plurality of reasoning steps corresponding to the multispecies coordinated task execution.

The LLM orchestration system 700 can include MCTS w/Super Exponential Regret Awareness module 720. In this context, “super-exponential regret” refers to the phenomenon where certain algorithms, specifically the Upper Confidence bounds applied to Trees (UCT) and its variants like AlphaGo's Monte Carlo Tree Search (MCTS), can experience regret that grows at a super-exponential rate under specific conditions. Regret, in this setting, measures the difference between the actual performance of the algorithm and the optimal performance it could have achieved. This module 720 may adjust model parameters to reduce or minimize regret, thereby improving performance. The adjustments made by module 720 can include modifying exploration-exploitation tradeoffs (e.g., fine-tuning of exploration constants in UCT).

The LLM orchestration system 700 can include iterative preference learning with direct preference optimization module 730. In embodiments, each node's expansions produce step-level preference data: which partial expansions yield better outcomes (improved translation quality, correct interpretation of animal signals). After collecting these preferences (through MCTS expansions and intermediate verification from debate steps), module 730 can apply Direct Preference Optimization (DPO) to refine the LLM's underlying policy. Over multiple cycles, on-policy sampled data enable the LLM's decision-making to improve at picking high-value expansions from the start. This reduces reliance on brute-force exploration and counters the conditions leading to super-exponential regret.

The LLM orchestration system 700 can include multispecies role and control analysis module 740. In embodiments, module 740 can model agents as having different influence roles, which can dynamically encourage certain agents to lead expansions in known-productive directions. Moreover, module 740 can be configured to let other agents anchor or block suspicious expansions (such as an octopus punching unhelpful fish), which are translated into immediate pruning of subgraphs in the reasoning DAG.

The LLM orchestration system 700 can include an LLM output generation module 750 which receives as input, outputs from the directed acyclic graph generation module 710, MCTS with Super Exponential Regret Awareness module 720, include iterative preference learning with direct preference optimization module 730, and/or multispecies role and control analysis module 740. The output from the LLM output generation module 750 can include information for human consumption, such as textual information, knowledge-based outputs, and/or structured data. The output from the LLM output generation module 750 can include information for robot consumption, such as commands, sensor data, and/or other command and control information. The output from the LLM output generation module 750 can include information for animal consumption, such as audio waveforms intended for interpretation by animals, such as tones and/or click patterns for cetaceans, tones and/or sounds for canines, and so on. Other signals for representation in visual and/or haptic domains may also be output by LLM output generation module 750 in some embodiments.

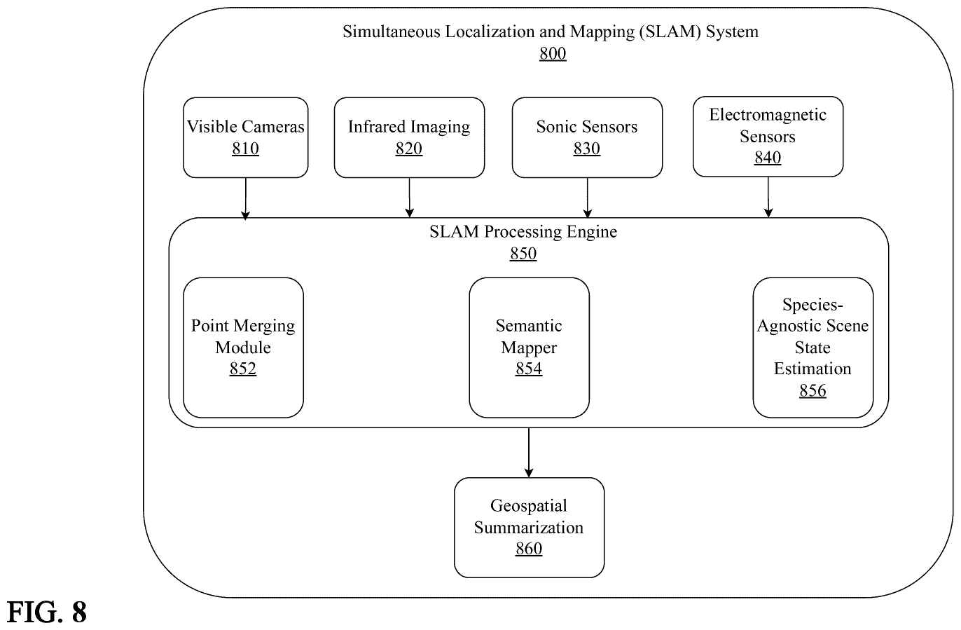

FIG. 8 is a block diagram illustrating details of a Simultaneous Localization and Mapping (SLAM) system 800, in accordance with one or more embodiments. In embodiments, SLAM system 800 may be integrated with, or communicatively coupled to, system for multimodal orchestration for human-animal-robot collaborative task execution 200 of FIG. 2. System 800 can include visible cameras 810, infrared imaging sensors 820, sonic sensors 830, and/or electromagnetic sensors 840. The visible cameras 810 may be configured to detect light in the visible spectrum (roughly 400-700 nanometers), which is the range of light perceptible to the human eye, and capture colors and details as humans see them, relying on external light sources (e.g., sunlight or artificial lighting) to illuminate a scene. The visible cameras can include wide-angle cameras, telephoto cameras, and so on. The infrared imaging sensors 820 can be configured to detect light in the infrared spectrum (beyond 700 nanometers), which is invisible to the human eye. In some embodiments, the infrared imaging sensors 820 can include thermal cameras that can capture emitted heat radiation from objects, even in complete darkness, without requiring external illumination. The sonic sensors 830 can include microphones and/or hydrophones. The microphones can include dynamic microphones, condenser microphones, electret microphones, and/or other suitable types of microphones. The hydrophones can include piezoelectric hydrophones that use piezoelectric materials to detect pressure changes in water caused by sound waves. The hydrophones can include vector sensors that measure both sound pressure and particle motion within water. The hydrophones can include a hydrophone array that includes multiple hydrophones arranged in a specific geometry to detect sound from multiple directions.

The electromagnetic sensors 840 can be configured to detect and measure electromagnetic fields or properties, such as electrical conductivity, magnetic fields, and electromagnetic radiation. The electromagnetic sensors 840 can include fluxgate magnetometers, suitable for detecting magnetic anomalies from seafloor rocks, or identifying metallic objects like shipwrecks or submarines. The electromagnetic sensors 840 can include proton precession magnetometers that can measure the magnetic field based on the precession of protons in water or a fluid. In one or more embodiments, the electromagnetic sensors can include optically pumped magnetometers, electric field detectors, capacitive sensors, electromagnetic induction sensors, and/or other suitable types of electromagnetic sensors.

The inputs from visible cameras 810, infrared imaging sensors 820, sonic sensors 830, and electromagnetic sensors 840 can be input to SLAM processing engine 850. SLAM processing engine 850 can include a point merging module 852. In embodiments, the point merging module 852 can include functions and instructions for combining multiple data points that correspond to the same real-world feature. This helps refine the map, reduce noise, and improve localization accuracy. SLAM processing engine 850 can include a semantic mapper 854. In embodiments, the semantic mapper 854 can include functions and instructions for enabling humans to interpret animal emotional states or intentions through augmented reality interfaces linked to embeddings and semantic mapping. The semantic mapper 854 may further include a Semantic Alignment Agent that can refine cross-domain mappings accordingly. Moreover, SLAM processing engine 850 can further include a species-agnostic scene state estimation module 856. In embodiments, the species-agnostic scene state estimation module 856 can include functions and instructions for utilizing data from visible light cameras to determine color and depth of a scene, enabling a 3D reconstruction of an environment. The species-agnostic scene state estimation module 856 can further include functions and instructions for utilizing data from ultraviolet (UV) and/or hyperspectral sensors, which can provide benefits as some animal signals might be visible only in UV or certain spectral bands, revealing hidden patterns (like UV-reflective markings on fish or subtle changes in an octopus's skin). The species-agnostic scene state estimation module 856 can further include functions and instructions for utilizing data from lidar scanners that produce high-resolution point clouds for both indoor and outdoor environments. In one or more embodiments, radar can complement lidar in poor visibility conditions. The species-agnostic scene state estimation module 856 can further include functions and instructions for utilizing data from sonic and/or acoustic sensors to capture vocalizations from a wide variety of animals. Embodiments can further utilize beamforming and/or signal processing in order to locate sound sources and/or identify distress calls, barks, or other meaningful vocal patterns in non-human animals.

The output of the SLAM processing engine 850 can include a geospatial summarization 860. The geospatial summarization 860 can include data that can be rendered and presented on an electronic display to show features such as a map panel that indicates animal locations, terrain features, and environmental conditions. One or more embodiments can further include icons representing animals that are updated in real-time, displaying status indicators such as color-coded stress levels, activity patterns, and the like. The data output of geospatial summarization 860 can include data in a variety of raster, vector, and/or other suitable formats.

An example of how the system can address environmental awareness by integrating a robust SLAM (Simultaneous Localization and Mapping) module that leverages multiple sensor modalities to construct and update a real-time map of the environment is an implementation that involves a network of underwater sensors-such as visible-light cameras, infrared sensors, hydrophones, and electromagnetic detectors-deployed on buoys, autonomous underwater vehicles, and seafloor detection devices. These sensors collect diverse data streams that are fed into a centralized SLAM processing engine. The engine employs sensor fusion algorithms to merge the disparate data points, calibrate them using techniques like point cloud merging and temporal alignment, and generate an accurate three-dimensional map of the surrounding environment. This map not only identifies static features like underwater rock formations or shipwreck debris but also dynamically tracks moving entities, such as marine life, which could be critical for coordinated search-and-rescue operations. The sensor fusion step is critical, as it involves aligning data with different noise profiles and update rates into a coherent representation. For example, one approach might use an Extended Kalman Filter (EKF) to merge the visual data from cameras with sonar measurements from hydrophones. The EKF can predict the system state by modeling the sensor dynamics and then correct the state estimates using incoming measurements. Alternatively, GraphSLAM techniques can be employed to optimize the global map by representing sensor observations as nodes in a graph and refining the map through iterative least-squares optimization, which can be particularly effective in complex underwater environments where sensor data is noisy or sparse.

In a real-world scenario, consider a rescue operation where a shipwreck is located in a complex underwater terrain. The SLAM module can continuously receive inputs from high-resolution cameras and acoustic sensors on a dolphin, and hydrophones mounted on buoys. The cameras capture detailed visual features, dolphin based acoustic sensors in combinations with buoy hydrophones detect acoustic signatures of marine life or subtle structural sounds from the wreck. The system processes these inputs through a semantic mapper that overlays additional information-such as depth, temperature gradients, and object classifications-onto the base map. An example implementation might use LIDAR and sonar fusion techniques to achieve a high-fidelity reconstruction of the wreck site. This fused map is then transmitted to both human operators via a tablet interface displaying a real-time 3D model and instructions sent to the dolphins that adjust their search patterns accordingly. The comprehensive integration of SLAM not only enhances environmental awareness but also supports synchronized decision-making across human, animal, and robotic agents in high-stakes, dynamic environments.

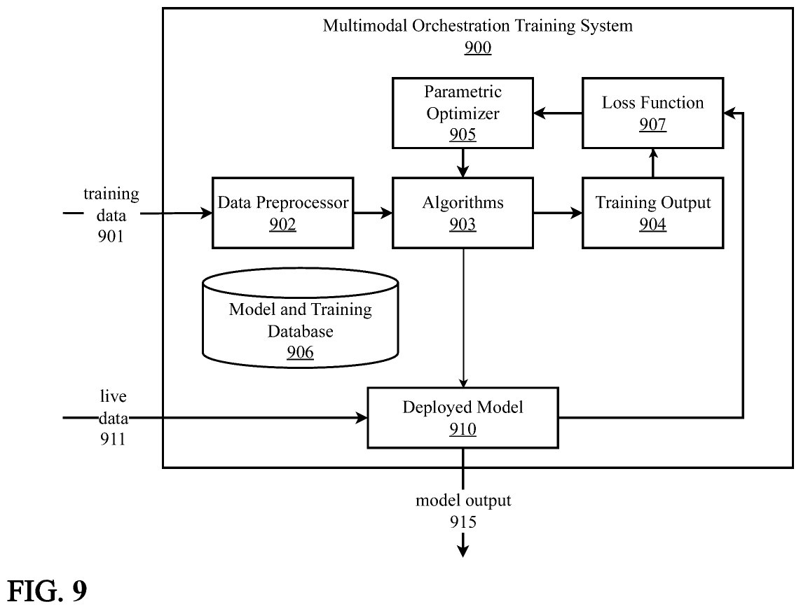

FIG. 9 is a block diagram illustrating an exemplary training system for tasks such as multimodal orchestration for human-animal-robot collaborative task execution and/or phylogenetic-based knowledge curation and transferring of knowledge across generations of animals, in accordance with one or more embodiments. In embodiments, system 900 may comprise a model training stage comprising a data preprocessor 902, one or more machine and/or deep learning algorithms 903, training output 904, a parametric optimizer 905, and a model deployment stage comprising a deployed and fully trained model 910 configured to perform tasks described herein such as enabling multimodal orchestration for human-animal-robot collaborative task execution. The system 900 may be used to train and deploy a plurality of AI subsystems in order to support the services provided by the system for multimodal orchestration for human-animal-robot collaborative task execution.

At the model training stage, a plurality of training data 901 may be received by the training system 900. Data preprocessor 902 may receive the input data (e.g., human feedback, human input data, animal input data, animal feedback, robot/sensor inputs, and the like) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 902 may also be configured to create a training dataset, a validation dataset, and/or a test set from the plurality of input data 901. For example, a training dataset may comprise 80% of the preprocessed input data, the validation set 10%, and the test dataset may comprise the remaining 10% of the data. The preprocessed training dataset may be fed as input into one or more machine and/or deep learning algorithms 903 to train a predictive model for tasks that can include interspecies communication, geospatial mapping, and/or object monitoring and detection.

During model training, training output 904 is produced and used to measure the accuracy and usefulness of the predictive outputs. During this process a parametric optimizer 905 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tanh, etc.), the choice of cost or loss function the model will use, number of hidden layers in a neural network, number of activation unites in each layer, the drop-out rate in a neural network, number of iterations (epochs) in training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the training system 900 to evaluate a model's performance. Metrics can include, but are not limited to, word error rate (WER), word information loss, cetacean response times, predicted animal response compared with actual animal response, and normalization error rate, to name a few. In one embodiment, the system may utilize a loss function 907 to measure the system's performance. The loss function 907 compares the training outputs with an expected output and determines how the algorithm needs to be changed in order to improve the quality of the model output. During the training stage, all outputs may be passed through the loss function 907 on a continuous loop until the algorithms 903 are in a position where they can effectively be incorporated into a deployed model 915.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 910 in a production environment making predictions based on live input data 911 (e.g., user preferences, user feedback, user inputs). Further, model correlations and restorations made by deployed model can be used as feedback and applied to model training in the training stage, wherein the model is continuously learning over time using both training data and live data and predictions. A model and training database 906 is present and configured to store training/test datasets and developed models. Database 906 may also store previous versions of models.

According to some embodiments, the one or more machine and/or deep learning models may comprise any suitable algorithm known to those with skill in the art including, but not limited to, LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 903 may comprise a deep learning algorithm such as neural networks (e.g., recurrent, convolutional, long short-term memory networks, etc.).

In some implementations, the training system 900 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 906.

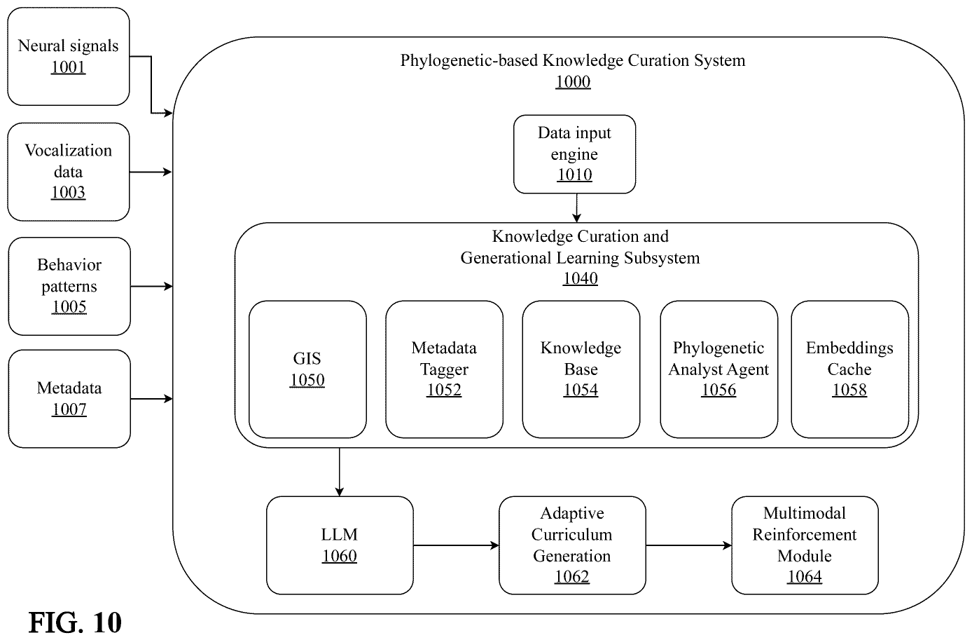

FIG. 10 is a block diagram illustrating components of a system for phylogenetic-based knowledge curation and transferring of knowledge across generations of animals, in accordance with one or more embodiments. System 1000 can receive as input, one or more neural signals 1001. The neural signals 1001 can include EEG (electroencephalography) signals. The neural signals 1001 can include EMG (electromyography) signals. The neural signals 1001 can include EOG (electrooculography) signals. The neural signals 1001 can include NIRS (Near-Infrared Spectroscopy) signals. Other types of neural signals may be included in one or more embodiments. System 1000 can receive as input, vocalization data 1003. The vocalization data 1003 can include barks, howls, growls, and whimpers. These sounds are commonly used by canines. However, disclosed embodiments are not limited to use with canines. Other vocalization data from other species may be input into system 1000. As an example, pant-hoots, screams, grunts, songs, and calls from primates such as gibbons, orangutans, chimpanzees, bonobos, and other primates, may be input to system 1000. Clicks, whistles, and burst-pulsed sounds from cetaceans such as dolphins and whales may be input to system 1000. Trumpets, rumbles, and roars from elephants may be input to system 1000. Purrs, meows, and hissing sounds from domestic cats may be input to system 1000. Sounds from other species may be received in one or more embodiments. These vocalizations are integral to the social structures and survival of these animals, and can be used to provide insight into their emotional states, social hierarchies, and environmental interactions.

The system 1000 can receive as input, one or more behavior patterns 1005. In one or more embodiments, behavior patterns can be represented as alphanumeric codes. In embodiments, a four-character alphanumeric code is used. The following table shows some codes that can be used in one or more embodiments.

| Code | Behavior |
|---|---|
| EATG | Eating |
| DRNK | Drinking |
| STND | Standing |
| WALK | Walking |
| RUNN | Running |
| JUMP | Jumping |
| LYNG | Lying down |
| BARK | Barking |
| HOWL | Howling |
| GRWL | Growling |
| WHMP | Whimpering |
| GRTH | Greeting (tail wagging, sniffing) |
| CGNT | Cognition (problem-solving, figuring out a puzzle toy) |
| SCRT | Scratching |
| SFLF | Self-grooming |
| SNFG | Sniffing |
| DIGG | Digging |
| CHSN | Chasing |
| SLPN | Sleeping |
| REST | Resting |
| STTG | Sitting |
| TLWG | Tail Wagging (happy) |
| TLCW | Tail Cowering (scared) |
| ERCT | Ears Erect (alert) |
| EFLD | Ears Folded (fearful) |

Other behavior encodings may be included in one or more embodiments. Moreover, while the encodings in the table above are directed to dog behavior. Other animals, such as primates, cetaceans, felines, and birds, may also make use of similar encodings. Furthermore, embodiments can support multiple encodings as a token to represent behavioral combinations. As an example, an encoding of STTG-SNFG can indicate sitting and sniffing, and an encoding of RUNN-BARK can indicate a behavior of running and barking. In embodiments, more than two encodings can be represented as a token, to enable the encoding of complex behaviors. The behaviors can be analyzed by the system 1000 to identify behaviors that are expected and positive in reference to assigned training tasks. The neural inputs associated with these behaviors can be stored in a knowledge base for future retrieval in training of a new generation of animals.

The system 1000 can receive as input, metadata 1007. The metadata 1007 can include subject data, such as age, gender, and breed of an animal. The metadata 1007 can include environmental information, such as temperature, noise, wind, and precipitation that was present at the time the neural signals 1001 were acquired. The metadata 1007 can include geographic location information, the duration of a training session, and/or other relevant information. The metadata can be used for further characterization of neural signals that can be used as training references.

The system 1000 can route the inputs (1001, 1003, 1005, and 1007) though a data input engine 1010. The data input engine can perform tasks such as timestamping data, organizing the input data in to data structures such as tuples, arrays, dictionaries, and/or other suitable data structures. The time-stamping of each data point can ensure that all data is synchronized and can be accurately analyzed in chronological order. The time-stamping is useful for time-series analysis and tracking changes over time. The data input engine 1010 may also perform data validation and cleaning tasks. In embodiments, the data input engine 1010 can perform validation checks to ensure data integrity. It can also clean the data by removing duplicates, correcting errors, and handling missing values. The data input engine 1010 can integrate data from multiple sources, such as neural signals, encoded behaviors, metadata, and vocalization data. This integration allows for comprehensive analysis and a holistic understanding of animal behavior as it relates to training, breeding, and/or other activities.

The data input engine 1010 can feed the processed input data to the knowledge curation and generational learning subsystem 1040. The knowledge curation and generational learning subsystem 1040 can include multiple modules and/or components for further analyzing, and/or categorizing the input data. The knowledge curation and generational learning subsystem 1040 can include a geospatial information system (GIS) 1050. The GIS 1050 can be used to enter and manage GPS coordinates, as well as create topographical maps, and temporal references (e.g., how long the animal had been trained at the time of recording). These features support the retrieval of data relevant to specific environments or seasonal conditions. GIS 1050 can provide numerous advantages, including precise location tracking, enabling of spatiotemporal tagging, environmental analysis, and temporal referencing. One or more embodiments may integrate third-party functionality such as from Esri's ArcGIS or open-source solutions like QGIS, allowing trainers to enter and manage GPS coordinates to monitor the movement and activities of animals over time. This allows for the creation of detailed topographical maps that highlight terrain features and landscape variations, aiding in the design of effective training programs tailored to specific environments. Additionally, the GIS system can include temporal references, such as the duration of training sessions, enabling trainers to analyze progress and adapt strategies based on how long an animal has been trained at the time of data recording. Additionally, disclosed embodiments can incorporate additional geospatial features to enhance animal training tasks. For example, disclosed embodiments can overlay seasonal conditions, such as vegetation changes, temperature variations, and weather patterns, providing context for training activities and helping trainers understand how environmental factors impact animal behavior. Geofencing capabilities can be integrated to set virtual boundaries and alert trainers if an animal ventures outside designated training areas. By combining spatial and temporal data, the GIS system enables the retrieval of comprehensive information relevant to specific environments, supporting data-driven decision-making and optimizing training outcomes. This multifaceted approach ensures that trainers have a robust toolset to manage and analyze animal behavior in diverse and dynamic settings, ultimately improving the effectiveness of training programs. Embodiments can include performing spatiotemporal tagging of the received non-human animal neural signal data.

The knowledge curation and generational learning subsystem 1040 can include a metadata tagger 1052. The metadata tagger 1052 can apply metadata to GIS data points, such as animal behaviors at a given geographical location. By tagging and associating specific behavioral observations with precise GPS coordinates, trainers and researchers can build a rich dataset that reveals patterns and insights about animal behavior in various environments. For instance, if a dog exhibits fear near bodies of water, the metadata tagger can annotate the corresponding GIS data points with relevant metadata, such as the behavior type (fear), the triggering environmental factor (body of water), and any additional context (e.g., time of day, weather conditions). This metadata enrichment allows for detailed analysis and helps to draw meaningful conclusions about the animal's behavior. The GIS 1050 and metadata tagger 1052 can assist in assessing the suitability of animals for specific roles or tasks. In the case of a dog exhibiting fear near water, the system can flag this behavior, indicating that the dog may not be suitable for roles such as water rescue operations, where confidence and comfort around water are essential. Thus, by using the GIS 1050 and metadata tagger 1052, disclosed embodiments can provide the ability to monitor, analyze, and adapt training programs based on detailed, location-specific behavioral data. Disclosed embodiments can enable trainers to have a comprehensive understanding of how different environments and conditions impact animal behavior, leading to more effective and tailored training outcomes.

The knowledge curation and generational learning subsystem 1040 can include a knowledge base 1054. The knowledge base 1054 can include a database, or other structured format for storing input data such as the neural signals 1001, vocalization data 1003, encoded behavior patterns 1005, and/or metadata 1007. Neural signals corresponding to successful training scenarios can then be retrieved from the knowledge base 1054 in order to train future generations of animals for similar tasks. Embodiments can include storing and retrieving knowledge representations derived from one or more animals in a knowledge base.

The knowledge curation and generational learning subsystem 1040 can include a phylogenetic analyst agent 1056. The phylogenetic analyst agent 1056 can be configured to build and/or update phylogenetic trees from incoming genomic or communication trait data. The phylogenetic trees generated and/or updated by the phylogenetic analyst agent 1056 can be used for filtering relevant, high-quality knowledge from large datasets of animal training data, brainwave data, and/or other relevant types of data. The knowledge curation and generational learning subsystem 1040 can include an embeddings cache 1058. In embodiments, one or more agents process information and produce embeddings. The embeddings can be represented as vectorized representations of traits, ancestral states, and/or other hidden factors. In embodiments, the agents exchange these embeddings to communicate. In embodiments, the embeddings cache 1058 can store these intermediate embeddings. This helps the agents keep track of the current state of communication and potentially retrieve past computations efficiently. These agents can include the phylogenetic analyst agent 1056, GIS 1050, and/or other agents, engines, and/or components. Thus, embodiments can include generating one or more trait distributions based on the received non-human animal vocalization data, and storing and retrieving intermediate embeddings corresponding to the one or more trait distributions in an embedding cache.

The output of the knowledge curation and generational learning subsystem 1040 can be input to large language model (LLM) 1060. In embodiments, the large language model (LLM) 1060 is trained to analyze animal behavior data. This training process can involve several key steps, including the collection, labeling, and preprocessing of diverse datasets. In embodiments, the LLM 1060 is trained on a rich corpus of data encompassing brainwaves, behavior encodings, geographical information, and metadata such as age, breed, and gender of the animal. Additionally, data from phylogenetic trees organizing animal communication traits, such as vocalizations, can be incorporated. The training data can be labeled, with each data point annotated to indicate specific behaviors, environmental contexts, temporal references, and physiological responses. For instance, brainwave patterns could be labeled with corresponding behaviors, while geographical data points could be tagged with environmental conditions and associated animal responses. The model can be trained to recognize patterns and correlations across these diverse data streams.

Once trained, the LLM 1060 can be configured to perform adaptive curriculum generation 1062 which can result in adaptive training curriculums customized for individual animals based on historical data from similar animals trained for specific tasks (e.g., scent detection). The LLM 1060 can analyze the collected data to identify effective training techniques, environmental factors that influence behavior, and optimal training schedules. By understanding the unique characteristics and responses of each animal, the LLM 1060 may then recommend tailored training plans as part of adaptive curriculum generation 1062 that enhance performance and address specific behavioral challenges. One or more embodiments may utilize continuous data collection and model fine-tuning to ensure the LLM remains accurate and effective in generating personalized training programs. This approach leverages the power of AI to revolutionize animal training, providing a data-driven framework for optimizing training outcomes and improving the welfare of animals.

The system 1000 can further include a multimodal reinforcement module 1064. The multimodal reinforcement module 1064 can be configured to enhance animal training by combining neural hints with complementary sensory stimuli. This module leverages audio patterns, such as recordings of calm, confident animals or reassuring handler voices, to guide younger animals towards desired responses. Over time, the animals can internalize these audio cues and learn to associate them with specific behaviors, eventually responding without the need for direct stimulation. In addition to audio patterns, the multimodal reinforcement module 1064 can generate haptic feedback via a collar worn by the animal, delivering gentle vibrations or taps to reinforce positive behaviors. Visual patterns, such as flashing lights or video displays, provide additional cues and stimuli, creating a comprehensive sensory experience that supports learning. By integrating these multimodal reinforcements, the system fosters a more effective and nuanced training environment, enabling animals to develop desired behaviors more quickly and reliably. The combination of auditory, haptic, and visual stimuli ensures that training is adaptable to the individual needs and preferences of each animal, leading to improved training outcomes and overall well-being. Embodiments can include using a multimodal reinforcement module to output one or more neural hints with audio patterns that correspond to the adaptive animal training curriculum. In embodiments, the multimodal reinforcement module 1064 can modify at least one of a pitch, tempo, and rhythm of the audio patterns. This feature can enable a range of stimuli that can be provided to animals.

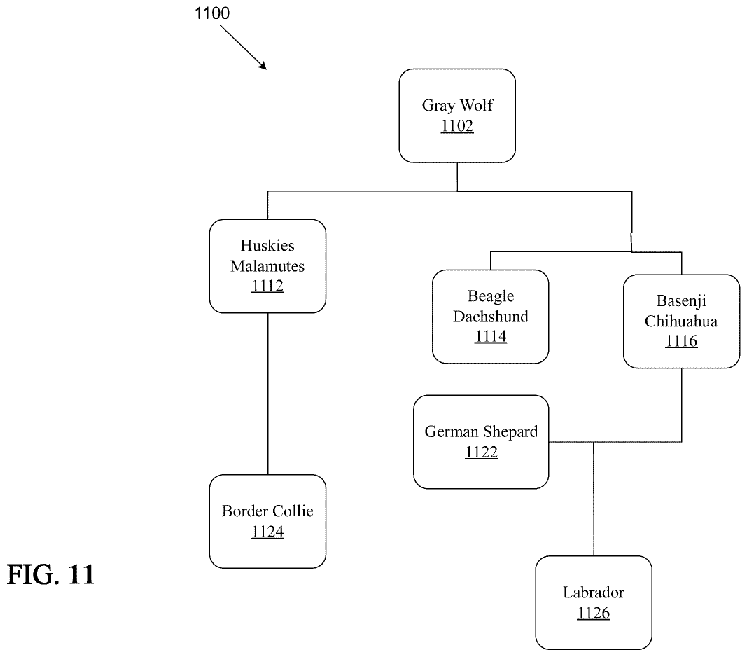

FIG. 11 shows an exemplary phylogenetic tree 1100 for studying animal communication, in accordance with one or more embodiments. The phylogenetic tree 1100 can be generated and or modified by they phylogenetic analyst agent 1056 (FIG. 10), based on provided input data, such as metadata 1007 (FIG. 10), which can indicate a variety of species, breeds, and the like, for analysis. In embodiments, phylogenetic tree can be used for studying animal communication. Various breeds and/or species of animal can be categorized based on their evolutionary lineage, function, and vocalization patterns. The phylogenetic tree 1100 illustrates a grouping that represents genetic relationships of different dog breeds with communication styles (howling, barking, and other vocal traits). The phylogenetic tree 1100 can include multiple groups. A first group 1102 can include the ancestral source of species, which in this example involving dogs, include the gray wolf. A second group 1112 includes huskies and malamutes. These breeds are known for howling, and communicate in a manner similar to wolves. A third group 1114 includes beagles and dachshunds. These species share a key communication trait of baying and howling as tracking signals, which are frequently used during hunting. A fourth group 1116 includes basenjis and chihuahuas. These species are unique and atypical vocalizers that have unique vocal patterns that are distinct from typical barking breeds. A fifth group 1122 includes German shepherds, which are dogs that have a wide range of vocalizations including barks, growls, and whines. A sixth group 1124 includes border collies, which are dogs that use sharp, controlled barks to assist with herding and working commands. A seventh group 1126 can include labradors, which communicate via moderate barking, with vocalizing for attention, excitement, and/or guarding.

The phylogenetic tree 1100 illustrates communication patterns that can be viewed by users, such as trainers and training curriculum designers to gain insights into communication patterns. Additionally, the tree can be encoded in Newick format, matrix representation, hierarchical embeddings, and/or other suitable format, for ingest by other aspects of the system 1000 for phylogenetic-based knowledge curation and transferring of knowledge across generations of animals (FIG. 10) in order to select additional neural patterns from previously trained animals for use in training and/or studying new generations of animals. As an example from phylogenetic tree 1100, the howling behavior is indicated as being retained in older lineages (wolves, sled dogs, and hounds). In contrast, with other breeds, the barking frequency and tone varies based on function. For example, herding dogs use barks strategically, while companion breeds bark more socially. Additionally, some breeds can be outliers with unique vocalization traits, such as the basenji with its unusual yodel-like communication, suggesting a distinct vocal evolution. By analyzing the phylogenetic relationships among species, disclosed embodiments can help determine which behaviors are likely inherited and which need to be taught from scratch. For example, herding dogs (e.g., Border Collies, Australian Shepherds) have an instinct for controlling movement, making them naturally suited for training in herding tasks. Another benefit the phylogenetic tree 1100 can provide is enabling the optimizing of training based on evolutionary similarities. Closely related species (or breeds) may respond similarly to training techniques, allowing trainers to apply proven methods more efficiently. For example, dolphins and orcas, both from the cetacean family, can be trained using similar reinforcement techniques because of their shared cognitive and social structures. Moreover, the phylogenetic approach of disclosed embodiments can help predict which species (or breeds) have higher cognitive flexibility and can adapt to more complex tasks. As an example, border collies and poodles (both intelligent breeds) may require more mental stimulation, while mastiffs and bulldogs may need more patience in training. Additionally, disclosed embodiments may help reduce training time through preconditioning. If certain neural responses and learned behaviors are passed down through generations, trainers can precondition younger animals using knowledge from trained ancestors. As an example, scent detection dogs (e.g., bloodhounds, German shepherds) may benefit from previous neural training data, such as sensory response mapping. Furthermore, the phylogenetic analysis of disclosed embodiments can help identify which breeds or species are naturally suited for specific jobs. As examples, retrievers (e.g., labrador, golden retriever) are better suited for search-and-rescue due to their strong tracking instincts, while sighthounds (e.g., greyhounds, salukis) are better suited for high-speed pursuit tasks. The phylogenetic approach to animal training of disclosed embodiments can enable more effective, species-specific, and efficient training methods, reducing trial and error while enhancing the ability to transfer knowledge across generations. Disclosed embodiments may also reduce training time, improve performance, and ensure long-term sustainability in specialized animal roles (e.g., search-and-rescue, military, and therapy animals). Thus, the disclosed embodiments can make use of a phylogenetic tree in the training of animals, providing multiple benefits, particularly in optimizing training methods, improving knowledge transfer, and understanding species-specific learning patterns. One or more embodiments can include generating a phylogenetic tree based on the received non-human animal vocalization data. Embodiments can further include generating a time-calibrated phylogenetic tree based on the generated phylogenetic tree, based on divergence times encoded into the received metadata. A time-calibrated phylogenetic tree can include a phylogenetic tree in which the branching points (nodes) are assigned actual time estimates, rather than just relative relationships. This results in a phylogenetic tree that is calibrated with time markers, such as known divergence times of species. In the context of disclosed embodiments involving animal communication, a time-calibrated tree can help researchers understand when specific communication traits evolved in different species. For example, if a particular vocalization pattern (such as complex howling in wolves) appeared at a certain time, researchers can investigate whether this emergence aligns with ecological shifts (e.g., changes in habitat, pack structures, or predation pressures).

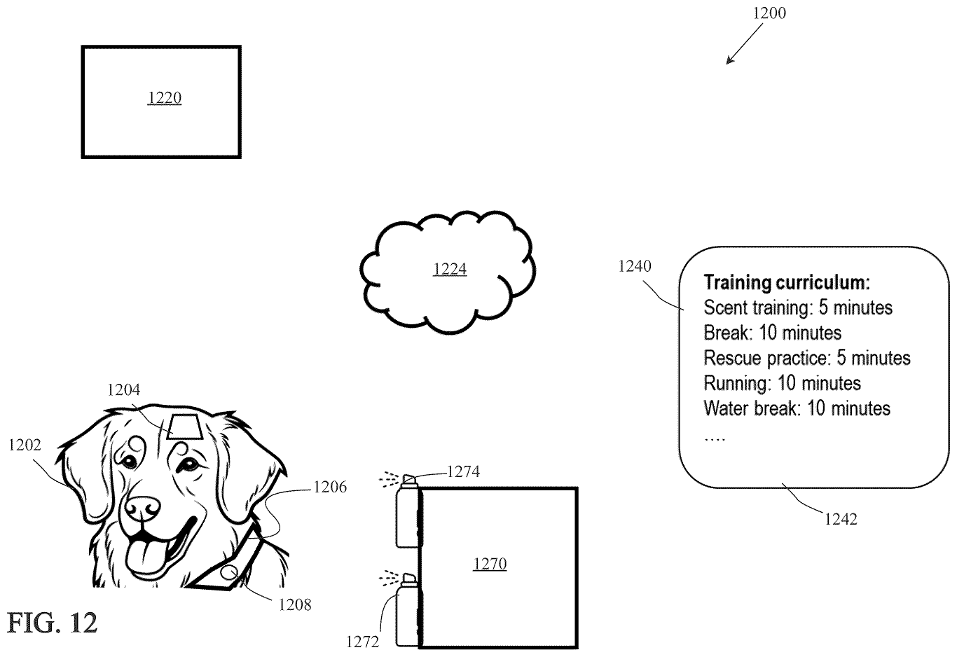

FIG. 12 shows an exemplary environment 1200 in which a system for phylogenetic-based knowledge curation and transferring of knowledge across generations of animals can be used, in accordance with one or more embodiments. Dog 1202 is shown, wearing a non-invasive brainwave sensor 1204. In embodiments, the non-invasive brainwave sensor 1204 may be comprised of a spray-on conductive polymer ink. In embodiments, the conductive polymer ink can include (Poly(3,4-ethylenedioxythiophene):poly(styrenesulfonate))(PEDOT:PSS). In embodiments, the conductive polymer ink can be applied directly to the scalp or skin using a microjet printing system. In some embodiments, a small area of the dog may be shaved to expose bare skin for applying the conductive polymer ink. The ink can include additives to optimize conductivity, reduce skin impedance, and ensure mechanical durability during prolonged wear. Once applied, the ink dries into a thin, flexible film that conforms seamlessly to the skin surface, even in the presence of hair or irregular contours. In some embodiments, instead of, or in addition to, a spray-on conductive polymer ink, pre-patterned tattoo electrodes can be transferred onto the skin for neural signal acquisition. These electrodes can be composed of biocompatible materials and provide low contact impedance. In some embodiments, the epidermal tattoo sensor can include carbon nanotubes (CNTs), gold nanomaterials, and/or other suitable materials. These sensors can detect brain or muscle activity through electrical signals with high signal-to-noise ratios (SNRs), rivaling traditional invasive systems. In embodiments, the non-invasive brainwave sensor comprises a sensor comprised of conductive polymer ink. In embodiments, the conductive polymer ink comprises (Poly(3,4-ethylenedioxythiophene):poly(styrenesulfonate))(PEDOT:PSS).

In one or more embodiments, the signals acquired by brainwave sensor 1204 are sent to a non-invasive brainwave sensor auxiliary module 1208 that may be attached to a collar 1206 worn by the dog 1202. In embodiments, the signals acquired by brainwave sensor 1204 can be sent to the brainwave sensor auxiliary module 1208 via near field communication (NFC) techniques, Bluetooth Low Energy (BLE), or other suitable techniques. One or more embodiments may utilize a custom UUID characteristic for EEG data to enable specifying the sample rate, data format, and/or other parameters for transmission of EEG data. The brainwave sensor auxiliary module 1208 can send the acquired signals to a system for phylogenetic-based knowledge curation and transferring of knowledge across generations of animals 1220, via network 1224. In embodiments, network 1224 can include a cellular network, WiFi network, local area network (LAN), wide area network (WAN), satellite communication network, and/or the Internet. The system for phylogenetic-based knowledge curation and transferring of knowledge across generations of animals 1220 can include functions and instructions to acquire brainwaves obtained by brainwave sensor 1204. The system for phylogenetic-based knowledge curation and transferring of knowledge across generations of animals 1220 can further include functions and instructions to perform metadata tagging, and geospatial association of the brainwaves, to enable additional analysis and adaptive curriculum generation via machine learning models. The results of the analysis and/or curriculum generation can be sent to a client device 1240 via network 1224. The client device can include a laptop computer, desktop computer, tablet computer, and/or other suitable computing device. The results produced from the system for phylogenetic-based knowledge curation and transferring of knowledge across generations of animals 1220 can be rendered and presented on electronic display 1242. In embodiments, the results can include a curriculum that is generated by the system for phylogenetic-based knowledge curation and transferring of knowledge across generations of animals 1220. In embodiments, the training curriculum that is generated can include a schedule of training activities, including a description of the activities, a suggested duration of the activities, breaks between activities, and so on. As an example, the training curriculum can include olfactory (scent) training. The client device 1240 can interact with a scent dispensing system 1270 via network 1224. The scent dispensing system 1270 can include a processor that is coupled to multiple electronically activated scent dispensers, indicated generally as 1272 and 1274. In embodiments the scent dispensing system can dispense scents associated with explosives, narcotics, and/or biological markers, based on commands received from the client device 1240. In embodiments, the system for phylogenetic-based knowledge curation and transferring of knowledge across generations of animals 1220 can implement clicker training, in which a sound and/or haptic output is generated by brainwave sensor auxiliary module 1208 when the animal correctly identifies a scent, followed by a reward for the animal, reinforcing the behavior. Accordingly, disclosed embodiments can accelerate training of animals by leveraging neural information and environmental information pertaining to animals that were previously trained with successful results.

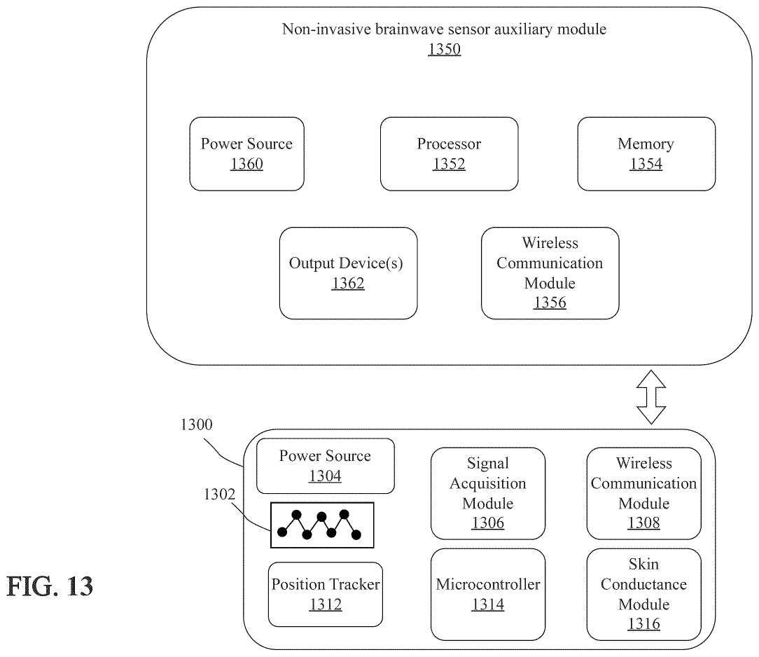

FIG. 13 shows a block diagram of an exemplary non-invasive sensor, in accordance with one or more embodiments. Sensor 1300 can include a substrate 1302 that can serve as electrodes. The substrate can include a spray-on conductive polymer ink (e.g., PEDOT:PSS) and/or ultra-flexible tattoo electrodes to map neural signals from the dog's head. In embodiments, the substrate 1302 can be applied to the skin of an animal via a biodegradable adhesive. In some embodiments, a small area of the dog's head may be shaved to expose a patch of skin for application of the substrate 1302. Thus, embodiments can include a flexible, biocompatible film that is applied to targeted regions of the dog's scalp, avoiding areas of thick fur by carefully shaving an area. Other embodiments may utilize an optimized spray formula that can penetrate sparse fur layers. In some embodiments, the conductive polymer ink is doped with additives such as sodium chloride (NaCl) for low contact impedance and enhanced signal acquisition.

In embodiments, captured signals are amplified by lightweight, on-body electronics integrated into the tattoo design or attached nearby on a collar-mounted processing unit. In embodiments, the tattoo is formulated for high adhesion and stretchability to withstand the dog's natural movements and environmental conditions, such as running, jumping, or exposure to moisture. In embodiments, the dog's fur may be trimmed in the area where the sensor 1300 is to be applied, prior to applying the sensor 1300. Sensor 1300 can be a scalp-mounted sensor, such as depicted at 1204 in FIG. 12. The sensor 1300 can further include a power source 1304. The power source 1304 can include a replaceable coin cell battery, rechargeable battery, and/or other suitable battery type. The battery can include a lithium-ion battery. The battery can provide power to signal acquisition module 1306, wireless communication module 1308, and other components within the sensor 1300. The signal acquisition module 1306 can include an ADC (analog-to-digital converter) that is fed a filtered input from a filter section that can include low-pass filters to remove high-frequency noise. The signal acquisition module 1306 can further include instrumentation amplifiers, programmable gain amplifiers, and/or other suitable amplifiers for boosting weak signals for further processing. The signal acquisition module 1306 may further include a clock generator to provide timing for the ADCs. The signal acquisition module may further include a microcontroller for control of the amplifiers and/or ADCs. In embodiments, the microcontroller can include an ARM Cortex processor, RISC-V processor, and/or other suitable processor type.

The wireless communication module 1308 can support protocols such as Near Field Communication (NFC), Bluetooth Low Energy (BLE), RFID (Radio Frequency Identification), and/or other suitable protocols. The wireless communication module 1308 can include one or more modulators that may provide FSK (Frequency Shift Keying), ASK (Amplitude Shift Keying), and/or PSK (Phase Shift Keying) modulations. The wireless communication module may further include a microcontroller for control of the modulators and/or amplifiers and other associated components. In some embodiments, the wireless communication module 1308 may include longer range communication capabilities such as WiFi, cellular, and/or satellite communication capabilities, which can enable the sensor 1300 to communicate with the system for phylogenetic-based knowledge curation and transferring of knowledge across generations of animals 1220 (FIG. 12) via the internet or other suitable techniques. In embodiments, the non-invasive brainwave sensor further comprises a wireless data transmission module. In embodiments, the wireless data transmission module includes a Bluetooth Low Energy (BLE) module. The sensor 1300 can further include a position tracker 1312. The position tracker 1312 can include a Global Positioning System (GPS) receiver, and/or other suitable position tracking system. The sensor 1300 can further include a skin conductance module 1316. The skin conductance module 1316 can include hardware and/or software for determining skin conductance as measured via substrate 1302. In embodiments, the skin conductance can be used to determine a rate and/or level of perspiration of an animal. The sensor 1300 can further include a microcontroller 1314. The microcontroller can be coupled to the signal acquisition module 1306, position tracker 1312, and/or wireless communication module 1308, for control of various operations. In embodiments, the microcontroller 1314 can include an ARM Cortex processor, RISC-V processor, and/or other suitable processor type.

The sensor 1300 can interoperate with the non-invasive brainwave sensor auxiliary module 1350. The non-invasive brainwave sensor auxiliary module 1350 can be a collar-mounted processing unit such as depicted at 1208 in FIG. 12. The non-invasive brainwave sensor auxiliary module 1350 can include a processor 1352. The processor 1352 can include an ARM Cortex processor, RISC-V processor, and/or other suitable processor type. The processor 1352 can be coupled to memory 1354. The memory 1354 can include a non-transitory computer-readable medium. The memory 1354 can include a combination of random-access memory (RAM), read-only memory (ROM), Flash memory, and/or other suitable memory type. The non-invasive brainwave sensor auxiliary module 1350 can include a power source 1360. The power source 1360 can include a replaceable battery, rechargeable battery, or other suitable battery type. The non-invasive brainwave sensor auxiliary module 1350 can include a wireless communication module 1356. The wireless communication module 1356 may include components to enable communication with wireless communication module 1308 of the sensor 1300. As stated previously, this can include antennas and modulators for as Near Field Communication (NFC), Bluetooth Low Energy (BLE), RFID (Radio Frequency Identification), and/or other suitable protocols. Additionally, the wireless communication module 1356 may include components to support longer distance communication, such as WiFi, cellular network communication, and/or satellite-based communication. This can enable relay of brainwave data to the system for phylogenetic-based knowledge curation and transferring of knowledge across generations of animals 1220 as shown in FIG. 12, where the brainwave data can be associated with other metadata via metadata tagging, geospatial information systems, and/or other techniques. The non-invasive brainwave sensor auxiliary module 1350 can include one or more output devices 1362. The output devices can include one or more LED (light-emitting diode) lights, a speaker, a haptic device (e.g. vibrator, buzzer, etc.), and/or other suitable output devices. The LED light can convey an operational status, such as being online, offline, low battery, etc. The speaker can be used to emit sounds and/or voice data that can be heard by the dog 1202 (FIG. 12) or other animal that is wearing brainwave sensor auxiliary module 1350. The haptic device can impart sensations of vibration or pulsing that can be felt by an animal as stimulus in response to commands that are verbally given or feedback to a correct response during a training exercise.

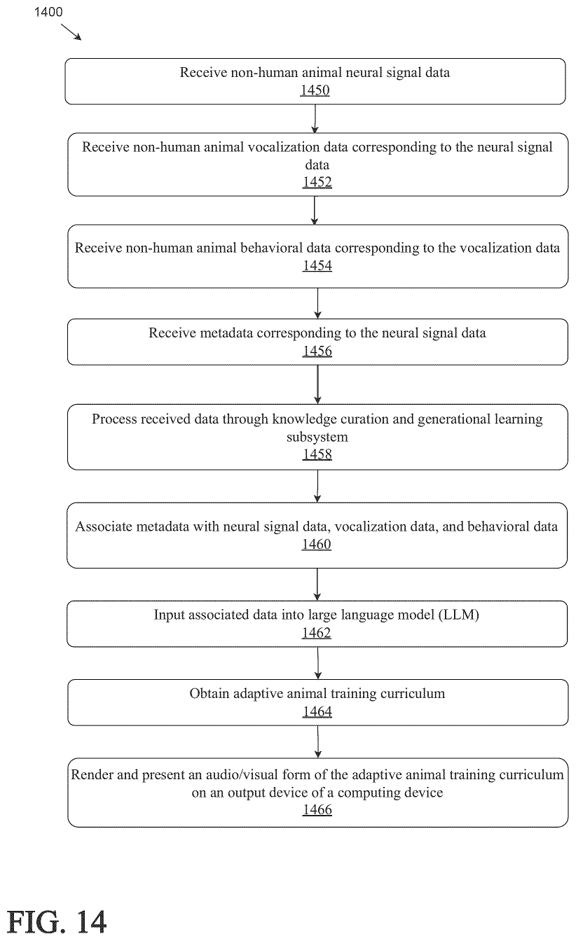

FIG. 14 is a flow diagram illustrating an exemplary method for phylogenetic-based knowledge curation and transferring of knowledge across generations of animals, in accordance with one or more embodiments. The method 1400 starts with receiving non-human animal neural signal data at block 1450. In embodiments, the neural signal data can include brainwaves, such as EEG (electroencephalography) data, EMG (electromyography) data, and/or other suitable neural signal data. The method 1400 continues with receiving non-human animal vocalization data corresponding to the neural signal data at block 1452. The vocalization data can include barks, howls, growls, and whimpers. These sounds are commonly used by canines. However, disclosed embodiments are not limited to use with canines, and other vocalizations from other types of animals may be received in one or more embodiments. The method 1400 continues with receiving non-human animal behavioral data corresponding to the vocalization data at block 1454. In one or more embodiments, the behavioral data can be represented as alphanumeric codes, as previously described. The method 1400 continues with receiving metadata corresponding to the neural signal at block 1456. The metadata that is received can include environmental information, such as temperature, noise, wind, and/or precipitation that was present at the time corresponding neural signals were acquired. The metadata that is received can include geographic location information, the duration of a training session, and/or other relevant information. The metadata can be used for further characterization of neural signals that can be used as training references. The method 1400 continues with processing the received data through the knowledge curation and generational learning subsystem (1040 of FIG. 10), at block 1458. The method 1400 includes associating the metadata with neural signal data, vocalization data, and behavioral data at block 1460. The method 1400 further includes taking the output of the knowledge curation and generational learning subsystem (1040 of FIG. 10), and inputting the associated data into a large language model (LLM) at block 1462. The method 1400 further includes obtaining an adaptive animal training curriculum at block 1464. The method 1400 further includes rendering and presenting an audio/visual form of the adaptive animal training curriculum on an output device of a computing device at block 1466. Thus, the disclosed methods can serve to leverage previous successful training outcomes to accelerate the training of new generations of animals.

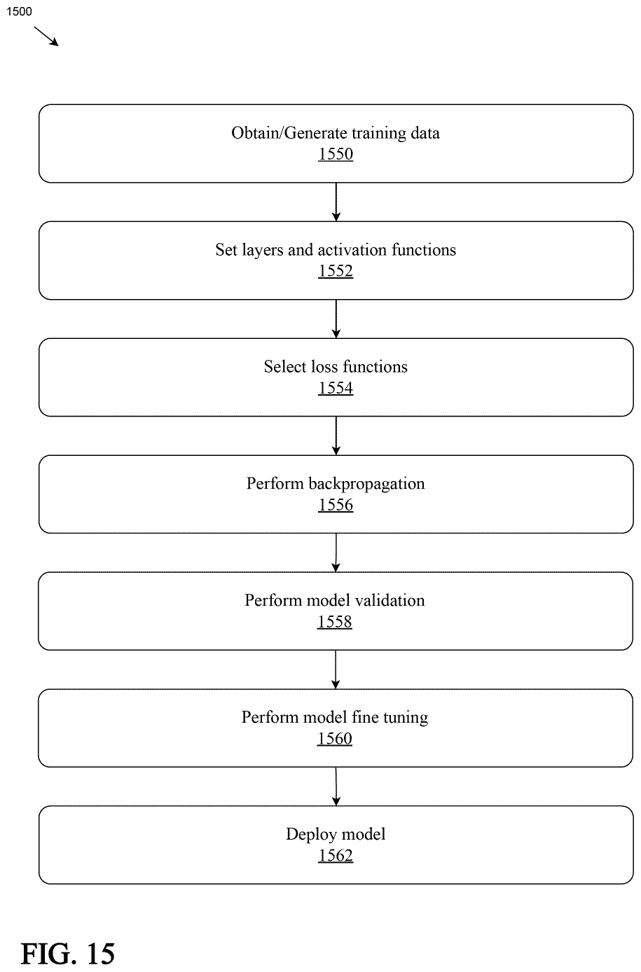

FIG. 15 is a flow diagram illustrating an exemplary method for training a system for real-time animal training and welfare management, according to one or more embodiments. The method 1500 starts with obtaining and/or generating training data at block 1550. The training data can include multiple sensor readings collected from animals in different situations. The data collected can include brainwave data. The brainwave data can be categorized based on frequency ranges and corresponding associations. In embodiments, delta brainwaves (0.5-4 Hz) can be associated with deep sleep, relaxation, or unconscious states, theta brainwaves (4-8 Hz) can be associated with relaxation, creativity, and drowsiness, alpha brainwaves (8-14 Hz) can be associated with calmness, focus, or light relaxation, beta brainwaves (14-30 Hz) can be associated with attention, alertness, and problem-solving, and gamma brainwaves (30-100 Hz) can be associated with high-level cognition, sensory perception, and learning. Additionally, the training data can include various physiological and/or biometric data. The data can include a heart rate (HR) and/or a heart rate variability (HRV). In embodiments, an elevated HR combined with a low HRV can indicate stress, excitement, or fear. In contrast, a normal HR along with an elevated high HRV can indicate a calm or relaxed state. The data can include a breathing rate. Rapid breathing can be indicative of stress, anxiety, or high alertness, while slow, rhythmic breathing can indicate a calm state. The data can further include perspiration levels. In embodiments, the perspiration levels can be associated with an emotional state. As examples, a high perspiration level can be associated with fear, stress, and/or excitement, while a low perspiration level can be associated with relaxation and/or drowsiness. The data may further include geospatial data. The geospatial data can include latitude and longitude associated with acquisition of the brainwave data. The geospatial data can include other location-relevant data, such as altitude, proximity to water, terrain characteristics, and/or other suitable geospatial data. In embodiments, the training data is preprocessed, such as via normalizing, filtering, and/or other techniques. Then, the data may be labeled via expert labeling, and/or other techniques. The training data can further include animal training curriculum data associated with successfully trained animals from current or previous generations of animals. This curriculum data can be used in generating of an adaptive animal training curriculum for new generations of animals.

The method 1500 continues with setting layers and activation functions at block 1552. In a neural network, layers are the building blocks that form the structure of the network. Each layer comprises a collection of neurons (also called nodes or units), and each neuron performs a specific computation on the input data. The output of one layer becomes the input to the next layer, creating a series of transformations from the input to the output. The layers can include input layers, output layers, and/or hidden layers. The activation functions introduce non-linearity into the model, allowing it to learn and represent complex patterns in the data. In embodiments, the activation functions can include a sigmoid function, a hyperbolic tangent function, a rectified linear unit (ReLU), a Leaky ReLU, softmax function, and/or other suitable activation function. The method 1500 continues to block 1554 for selecting loss functions. The loss functions are mathematical functions used in machine learning to measure the difference between the predicted values produced by the model and the actual target values from the training data. In one or more embodiments, the loss functions can include Mean Squared Error (MSE), Mean Absolute Error (MAE), Categorical Cross-Entropy, and/or other suitable loss functions. The loss functions can be used to determine if the model is sufficiently trained. The method 1500 continues to block 1556 for training the model using backpropagation. The backpropagation process can include computing gradients of the loss with respect to the weights and biases in the output layer. These gradients are propagated backward through the neural network to the hidden layer. The method 1500 continues to block 1558, where the model is validated. The validation can include using an additional set of non-human animal cognitive condition data that was not part of the original training dataset as a test dataset. In embodiments, this validation can be used to identify and correct overfitting. The method 1500 can include model fine-tuning at block 1560. The model fine-tuning can include adjusting weights and/or other hyperparameters as needed to improve model output. The method 1500 continues to block 1562, where the model is deployed for use in phylogenetic-based knowledge curation and transferring of knowledge across generations of animals.

As can now be appreciated, disclosed embodiments provide an advanced animal training system that leverages neural information, combined with associated metadata such as animal characteristics and geospatial data, using phylogenetic-based techniques. Accordingly, disclosed embodiments can provide significant advantages in accelerating the training process for critical tasks such as search-and-rescue and scent identification for law enforcement. By analyzing the neural patterns of animals that were successfully trained in previous generations, disclosed embodiments can identify optimal cognitive and behavioral responses that led to effective task performance. These patterns, along with environmental and physiological metadata, can be stored in a knowledge base and used to induce similar neural states in new generations of animals through targeted aural, haptic, and/or visual stimuli. This approach can minimize the time required for conventional training methods by aligning an animal's neural activity with pre-established success patterns, promoting faster learning and improved retention. Additionally, by factoring in geospatial data, disclosed embodiments can tailor training to specific environments where the animals will operate, further enhancing their efficiency. This not only maximizes training effectiveness, but also extends the working lifespan of trained animals by reducing time-intensive learning phases, ultimately benefiting fields that rely on highly skilled service animals.

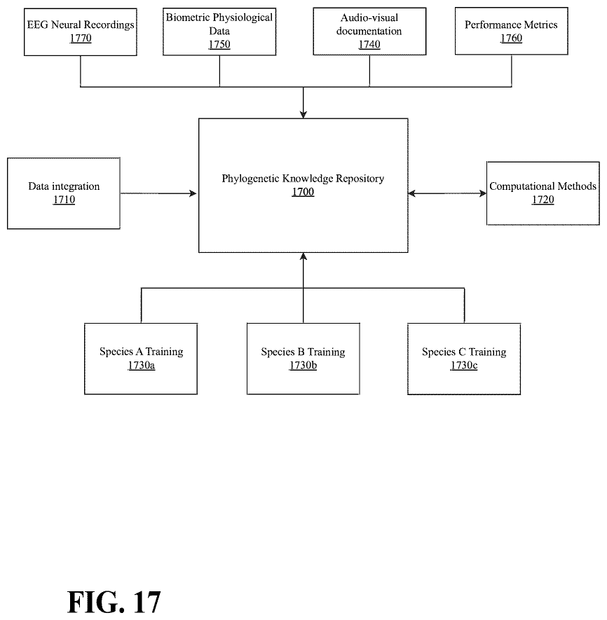

FIG. 17 is a block diagram of an exemplary architecture of a phylogenetic knowledge repository system, a sophisticated platform designed to systematically acquire, process, store, generalize, and deploy behavioral and cognitive knowledge across successive generations of diverse animal species.

The four primary data acquisition modules are: (1) EEG Neural Recordings 1770, which capture high-resolution electroencephalographic data reflecting neural activity patterns, network dynamics, and event-related potentials during various training and performance scenarios; (2) Biometric Physiological Data 1750, encompassing a comprehensive array of physiological indicators including heart rate variability, respiratory patterns, cortisol concentrations, pupillary responses, and other stress-related biomarkers; (3) Audio-Visual Documentation 1740, comprising high-definition video recordings, acoustic analyses, and multimodal sensory documentation of behavioral responses, physical movements, and environmental interactions; and (4) Performance Metrics 1760, consisting of quantitative measurements of task completion rates, error frequencies, response latencies, decision accuracy, and other objective performance indicators.

The phylogenetic knowledge repository 1700 functions as both a sophisticated database and an intelligent processing hub that systematically organizes, analyzes, and evolves the accumulated behavioral and cognitive knowledge. A data integration module 1710 implements three critical data processing methodologies: information theory analysis, which applies principles from Shannon entropy and Kolmogorov complexity to identify and prioritize the most informative behavioral patterns; neural encoding optimization, which translates behavioral sequences into efficient neural representation formats; and data compression techniques, which ensure maximal informational density while minimizing storage requirements and cognitive load during training sessions.

The computational methods module 1720 houses three advanced computational approaches: deep learning frameworks that identify complex patterns and correlations within multimodal behavioral data; transfer learning paradigms that facilitate cross-domain and cross-species knowledge generalization; and neurosymbolic AI architectures that integrate neural network capabilities with symbolic reasoning to create abstract behavioral templates applicable across diverse animal taxa. This module and the repository indicate the continuous exchange of information, with raw data being processed by these computational methods and the resulting insights being reintegrated into the knowledge base.

The three distinct training application scenarios: species A training 1730a (specifically optimized for Canine Search & Rescue operations), species B training 1730b (tailored for Dolphin Aid Tasks), and species C training 1730c (designed for Avian Detection Work). This represents the deployment of species-specific behavioral protocols, neural activation blueprints, and optimized training stimuli derived from the repository's knowledge base. A distinctive feature of the architecture is the feedback mechanism. Real-time adaptive learning capability of the system, through which performance outcomes, behavioral responses, and neural activation patterns observed during ongoing training sessions are continuously fed back into the repository. This design enables the progressive refinement of training methodologies, the optimization of stimulus parameters, and the continuous evolution of the knowledge base with each successive generation of animal trainees. This comprehensive architectural representation effectively captures the system's capacity for multispecies knowledge transfer, continuous adaptive learning, and progressive enhancement of training efficiency across diverse animal taxa and successive generational cohorts.

In an embodiment disclosed herein, a phylogenetic knowledge repository is presented, designed to systematically curate, transfer, and expand behavioral and cognitive knowledge across successive generations of animals. This repository integrates advanced multispecies generalization capabilities, functioning as a dynamically evolving and meticulously structured database. It encompasses comprehensive data regarding animal behaviors, neural response patterns, cognitive performance indices, and communication strategies that have been empirically validated in previously trained animals. Contrasting sharply with conventional animal training methodologies—which typically necessitate extensive individualized instruction for each animal from the onset—this innovative repository proactively aggregates, archives, classifies, and disseminates intricate behavioral datasets, associated neural correlates, and optimized stimulus paradigms. As a result, the repository substantially streamlines subsequent training processes, reducing resource allocation requirements and diminishing the overall duration of training regimens.

The operational architecture of the Phylogenetic Knowledge Repository involves a robust continuous data integration pipeline capable of assimilating heterogeneous multimodal datasets derived from an array of sensory and physiological sources. These datasets include, but are not limited to, electroencephalographic (EEG) neural recordings, detailed biometric physiological indicators such as heart rate variability, cortisol concentrations, respiratory patterns, as well as comprehensive audio-visual documentation of animal behaviors and task-oriented performance metrics. Employing advanced computational methods founded on principles from information theory, neural encoding optimization, and high-efficiency data compression techniques, the repository rigorously analyzes and distills these expansive datasets. Through selective retention of the most informationally dense content, it ensures the maximal relevance and efficacy of behavioral signals while simultaneously mitigating cognitive overload, sensory overstimulation, and potential confusion during training sessions for subsequent generations. Operationally, when new animals are introduced into training protocols, the repository algorithmically retrieves, synthesizes, and dynamically deploys optimized behavioral frameworks and neural activation blueprints. These detailed neural-behavioral schemata directly guide and meticulously calibrate the sensory stimuli—such as specifically structured auditory signals, controlled haptic interfaces, or precisely customized visual cues—presented to new trainees. Integration of this pre-validated, knowledge-intensive approach significantly enhances the rate and accuracy at which animals acquire complex behavioral repertoires, substantially reducing reliance on traditional trial-and-error approaches and their inherent inefficiencies. A core innovative aspect of this Phylogenetic Knowledge Repository is its intrinsic capability for multispecies behavioral knowledge transfer. Insights obtained from the successful behavioral and neural training of one species can be systematically generalized, adapted, and efficiently deployed for training diverse animal taxa. For instance, sophisticated behaviors and associated neural signatures documented through the training of canines for search-and-rescue tasks are subject to advanced computational abstraction within the repository, enabling their effective translation and application to other aid animals such as dolphins, equines, or avian species involved in analogous rescue, detection, or assistance roles. This pioneering multispecies functionality is enabled through integration of advanced computational methodologies, including deep learning frameworks, transfer learning paradigms, meta-learning algorithms, and neurosymbolic reasoning architectures. These methodologies collectively facilitate the identification, abstraction, and generalization of fundamental cognitive and behavioral constructs, significantly transcending species-specific limitations. Additionally, the repository integrates advanced reinforcement learning-based feedback mechanisms wherein real-time data acquired during ongoing animal training episodes continuously informs, updates, and refines stored knowledge representations and strategic behavioral guidelines. This adaptive feedback infrastructure ensures sustained responsiveness and iterative refinement, progressively enhancing the precision, efficiency, and effectiveness of training interventions with each successive generation of trainees.

Thus, the repository substantially transcends traditional passive data archiving or retrospective analysis methods, instead proactively modulating and optimizing training stimuli dynamically in response to observed behavioral outcomes and performance metrics. In summary, through its sophisticated, adaptive, and integrative design, the disclosed embodiment represents a significant advancement in contemporary animal training methodologies. It delivers unparalleled efficiency, effectiveness, and scalability, reducing training durations, outcome variability, and resource consumption. Simultaneously, it promotes continuous knowledge evolution, adaptive behavioral generalization, and substantial progression in training methodologies across diverse animal taxa and successive generational cohorts, signifying a transformative development in animal behavioral training and interspecies collaboration.

In an aspect, the disclosed invention further comprises an advanced cross-species transfer learning mechanism within artificial intelligence (AI) and machine learning (ML) models, strategically integrated into the Phylogenetic Knowledge Repository framework. This transfer learning mechanism is meticulously designed to facilitate intermediate token- or byte-level interactions between specialized species-specific knowledge modules, enabling nuanced and adaptive interspecies translation.

Specifically, the invention incorporates a structured architecture of distinct neural network modules, each dedicated to the unique behavioral patterns, neural response paradigms, and communicative signaling of individual animal species. These modules are interconnected through intermediate representation layers, which utilize tokens or byte sequences as abstracted semantic intermediaries. The intermediate token-based representations act as universal communication substrates, allowing seamless translation and interoperability between modules optimized for different species. This design effectively bridges previously isolated cognitive and communicative data streams, dramatically enhancing the models' ability to generalize learned behaviors and interpretative insights across species boundaries.

In operation, data originating from a particular species' neural and behavioral module is first encoded into intermediate tokenized representations. This intermediate representation leverages vector embedding methods and context-aware transformers to distill critical semantic and cognitive features from complex multimodal signals-such as auditory vocalizations, neural EEG patterns, or visual gestures-into structured tokens that encapsulate the core informational essence. Subsequently, these intermediate representations undergo translation through cross-species neural translation modules specifically trained via deep meta-learning paradigms. The translation modules utilize reinforcement learning strategies to continually refine and validate their interpretations, ensuring high fidelity and functional accuracy when converting between intermediate representations and species-specific communication or cognitive frameworks.

Moreover, the invention includes bidirectional translation capabilities, ensuring that knowledge and behavioral cues flow fluidly between multiple species-specific modules, with each intermediate translation step dynamically informed by the real-time feedback and efficacy assessments drawn from ongoing training sessions. This iterative learning loop enhances cross-species comprehension, minimizes translation errors, and progressively optimizes communication precision and behavioral modeling accuracy.

Consequently, this innovative AI/ML structure not only significantly expands the functional scope and practical utility of the Phylogenetic Knowledge Repository but also introduces robust interspecies communication capabilities. Such capability provides profound advantages for complex coordinated tasks, such as multi-species search-and-rescue missions, veterinary diagnostics, or service animal interactions, effectively harnessing diverse cognitive capabilities across multiple animal species within an integrated, coherent, and highly adaptive computational framework.

In an embodiment, the Phylogenetic Knowledge Repository is further advanced by introducing a sophisticated graph-based specification framework designed explicitly for systematic representation, dynamic interaction, computational optimization, and efficient propagation of phylogenetic knowledge. This enhanced framework integrates both explicitly declared and implicitly inferred code elements, facilitating comprehensive and versatile management of intricate behavioral, neural, communicative, and physiological datasets across diverse species, environmental contexts, and evolutionary trajectories.

At the foundational level, this embodiment leverages directed acyclic graphs (DAGs) or directed graphs to encapsulate behavioral workflows, neural information flows, and evolutionary state transitions across and within species-specific knowledge domains. Each vertex within the DAG is meticulously defined to represent discrete behavioral states, neural activation profiles, physiological conditions, or environmental contexts, while directed edges signify logical, temporal, or causal transitions informed by neural-encoded experiential data and ecological interactions. Explicit code elements associated with vertices and edges provide detailed structured schema for predefined behavioral sequences, neural event patterns, environmental interactions, and physiological benchmarks, thereby enabling rigorous analytical validation, transparent knowledge representation, and precise reproduction of experimental scenarios.

Implicit code elements are manifested through advanced machine-learning-driven inference engines, employing real-time adaptive computational methods to dynamically construct, modify, or optimize graph edges based on ongoing analyses of multimodal data streams—including electroencephalographic (EEG) signals, physiological biomarkers such as cortisol levels and heart rate variability, detailed audio-visual behavioral recordings, and ecological context variables. Such engines utilize probabilistic graphical models, Bayesian networks, and neural symbolic learning methodologies to systematically uncover and represent previously undetected interdependencies, contextually adaptive behavioral transitions, and emergent relational structures, thereby continuously enriching and refining the graph topology.

To achieve optimal computational efficacy, interpretative clarity, and representational robustness, the graph-based architecture employs an advanced tensor representation system deeply rooted in quaternionic algebraic formulations and topological data analysis techniques. Behavioral states, neural activations, physiological metrics, and phylogenetic relational structures are systematically encoded into quaternionic tensors, allowing simultaneous multidimensional representation of magnitude, spatial orientation, phase relationships, and temporal progression. Intermediate interactions between individual species-specific modules and multimodal data streams are managed through tokenized byte-stream representations, abstracting intricate biological signals into structured, computationally efficient symbolic sequences. These intermediate representations are processed through specialized deep transformer-based translation layers, proficient in contextual semantic embeddings, attention mechanisms, and real-time interpretative refinements, thus streamlining and enhancing cross-species translation accuracy.

Moreover, the described graph-based framework incorporates neurosymbolic reasoning modules to significantly enhance transparency, interpretability, and explainability of knowledge propagation processes. This integration is achieved through the sophisticated synthesis of neural-derived tensor representations and formal symbolic logical constructs, leveraging differential logic networks to rigorously validate inferential consistency across species-specific cognitive, physiological, and behavioral domains. Through continuous Bayesian confidence assessments and predictive analytics, symbolic logic predicates and behavioral hypotheses are dynamically updated, integrated, or deprecated based on rigorous evidence-driven performance metrics, ensuring adaptive yet methodologically consistent propagation and representation of validated knowledge.

Furthermore, the comprehensive framework implements hypergraph methodologies to accurately capture and represent multidimensional, complex interdependencies and dynamic interactions across multiple species, simultaneously preserving critical topological invariants and enabling efficient, scalable restructuring operations. Adaptive hyperedge weighting dynamics, governed by phylogenetically calibrated Kullback-Leibler divergence metrics, dynamically quantify interspecies behavioral, cognitive, and ecological similarities, thereby facilitating precise, targeted knowledge transfer, robust evolutionary adaptations, and contextually optimized learning processes within the graph structure.

Finally, this embodiment includes a state-of-the-art quantum-resistant security architecture, employing robust lattice-based cryptographic primitives, such as CRYSTALS-Kyber and CRYSTALS-Dilithium, alongside distributed ledger technologies enhanced with zero-knowledge proofs. This multifaceted security approach ensures the long-term integrity, confidentiality, resilience against advanced quantum computing threats, and verifiable provenance of sensitive phylogenetic knowledge assets within the repository. This sophisticated security infrastructure also guarantees trustworthy, granular access control mechanisms and auditability throughout the system's operational lifespan, reinforcing its reliability and applicability in critical scientific and applied contexts.

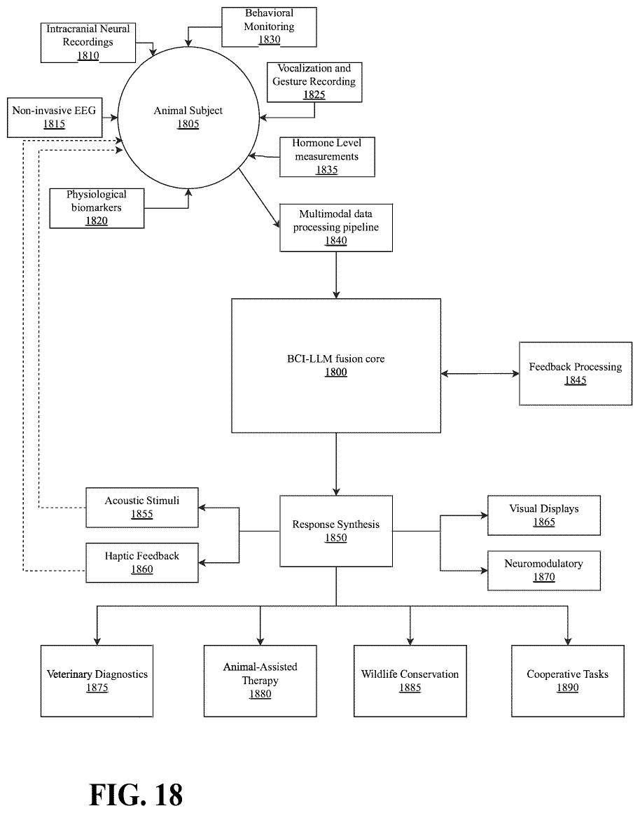

FIG. 18 is a block diagram illustrating an exemplary architecture of a comprehensive framework for an advanced bidirectional BCI-LLM fusion system, representing a sophisticated technological platform engineered to facilitate nuanced, contextually-aware communication between humans and diverse species. The diagram depicts a complete closed-loop system with bidirectional information flow that significantly advances beyond conventional unidirectional decoding approaches previously employed in animal-computer interaction research.

The animal subject 1805 serves as both the origin of neural and behavioral signals and the recipient of species appropriate stimuli. Surrounding this node are six specialized data acquisition modules arranged to capture the full spectrum of biological and behavioral signals: (1) Intracranial Neural Recordings 1810, which collect high-resolution electrophysiological data directly from implanted electrodes or microarrays targeting specific neural circuits; (2) Non-invasive EEG 1815, which captures electrical brain activity through surface electrodes without necessitating invasive procedures; (3) Physiological biomarkers 1820, encompassing vital measurements including heart rate variability, respiratory patterns, and stress-related indicators; (4) Vocalization & gesture recording 1825, which documents species-specific communication attempts through acoustic and physical expressions; (5) Behavioral monitoring 1830, which tracks movement patterns, spatial positioning, and task engagement; and (6) Hormone level measurements 1835, which assess fluctuations in cortisol, oxytocin, and other neuroendocrine markers correlated with emotional and cognitive states. Thin directional arrows connect each acquisition module to the animal subject, visually representing the continuous sampling of these multimodal signals. The collected multimodal data streams flow into the Multimodal Data Processing Pipeline 1840. This processing pipeline implements sophisticated dimensionality reduction techniques including Tensor Decomposition methods (specifically, Canonical Polyadic Decomposition and Tucker Decomposition) and Non-negative Tensor Factorization, which collectively distill the high-dimensional multimodal data into computationally efficient representations while preserving essential semantic, cognitive, and physiological dimensions. This critical preprocessing stage ensures that subsequent analytical components receive optimally structured information streams that balance informativeness with computational efficiency.

The BCI-LLM fusion core module 1800 is the central processing hub which houses the Transformer-based LLM, specifically engineered through transfer learning and fine-tuning procedures to interpret neural and behavioral signals and generate contextually appropriate responses. The LLM employs advanced self-attention and contextual Embedding mechanisms to dynamically weight and interpret the incoming multimodal data streams, enabling accurate modeling of complex cognitive states, emotional contexts, and communicative intentions. Supporting this central LLM are two specialized algorithmic frameworks: the Reinforcement Learning module, which iteratively refines interpretive accuracy based on interaction outcomes, and the Neurosymbolic Reasoning module, which integrates neural network capabilities with symbolic logic to enhance interpretive depth and generalizability across species.

The feedback processing 1845 implements a sophisticated adaptive learning system comprising multiple interrelated mechanisms: a Bayesian Updating Framework that systematically refines probabilistic models of animal communication patterns; Response Monitoring routines that track the effectiveness of system-generated stimuli; Adaptive Learning Algorithms that continuously optimize interpretive strategies; and Interaction Optimization processes that enhance the overall communicative efficacy of the system. Bidirectional arrows between this feedback module and the central BCI-LLM Fusion Core 1800 visualize the constant exchange of information, enabling real-time adaptation and longitudinal enhancement of communicative effectiveness.

The response synthesis 1850 translates the LLM-generated semantic content into species-appropriate stimuli through three key functional elements: Species-specific Stimuli Generation, which tailors outputs to match the perceptual capabilities of the target species; Inverse-Modeling Algorithms, which determine optimal stimulus parameters based on desired cognitive or behavioral outcomes; and Adaptive Stimulus Refinement, which continuously improves stimulus design based on observed effectiveness. This the flows to four distinct stimulus delivery systems: acoustic stimuli 1855 (optimized for species-specific auditory ranges including ultrasonic or infrasonic frequencies); Haptic Feedback 1860 (calibrated to species-specific tactile sensitivities), Visual Displays 1865 (tailored to the visual perception capabilities of the target species), and Neuromodulatory interventions 1870 (precisely targeted to relevant neural circuits).

The four primary application domains enabled by this advanced interspecies communication system: veterinary diagnostics 1875, facilitating enhanced medical assessment through improved understanding of animal symptoms and discomfort; animal-assisted therapy 1880, enabling precision therapeutic interventions through clearer communication between therapy animals and patients or clinicians; wildlife conservation 1885, supporting ecosystem management through non-invasive communication with endangered or threatened species; and cooperative tasks 1890, facilitating complex coordinated operations involving humans, animals, and robotic systems in diverse operational environments. This comprehensive architectural representation effectively captures the system's innovative fusion of advanced BCI technology with state-of-the-art LLM capabilities, establishing a groundbreaking platform for sophisticated bidirectional interspecies dialogue that transcends the limitations of conventional unidirectional decoding approaches.

In a further embodiment of the disclosed invention, a sophisticated integration of Brain-Computer Interface (BCI) technology and advanced Large Language Model (LLM)-driven communication modules is presented to facilitate groundbreaking advancements in bidirectional interspecies dialogue. Previous approaches in animal-centric BCI research predominantly utilized simplistic neural decoding paradigms, primarily involving elementary electroencephalography (EEG) pattern-matching methodologies limited to generating basic and predetermined linguistic outputs. These conventional systems notably lacked comprehensive computational intelligence, advanced contextual analytics, and the dynamic interaction capabilities requisite for effective dialogue. Contrasting markedly with these limitations, the current embodiment substantially progresses the state-of-the-art through the deployment of intricate neural signal interpretation processes coupled with sophisticated transformer-based LLM architectures, thereby enabling rich, contextually nuanced, and adaptive interspecies communication.

This innovative embodiment features an expansive multimodal neural and physiological data acquisition framework, meticulously engineered to collect a comprehensive array of biological and behavioral signals. These include invasive intracranial neural recordings, non-invasive EEG signals, physiological biomarkers such as heart rate variability, respiratory rates, and hormone fluctuations (e.g., cortisol variations correlated with stress or excitement), alongside intricate recordings of expressive vocalizations and gestural behaviors exhibited by animal subjects within ecologically relevant environments. The resulting diverse multimodal datasets undergo sophisticated integration and reduction through advanced tensor decomposition techniques, notably canonical polyadic decomposition (CPD), Tucker decomposition, and non-negative tensor factorization, providing highly informative and computationally efficient representations. This approach distills salient semantic, cognitive, and physiological dimensions, essential for nuanced and high-resolution dialogue generation.

Upon preprocessing and dimensional reduction, the synthesized multimodal representations are subsequently provided as input to a transformer-based LLM explicitly tailored through rigorous transfer learning and fine-tuning procedures utilizing extensive multimodal interspecies datasets. This LLM architecture employs advanced self-attention mechanisms and contextual embedding techniques, capable of dynamically weighting and interpreting neural, physiological, and behavioral data streams. Such sophisticated interpretative capability enables the accurate modeling of complex cognitive states, emotional contexts, and communicative intentions intrinsic to diverse animal species. Iterative reinforcement learning cycles further refine and enhance the predictive capacities of the LLM, continuously adapting its inferential strategies and interpretive accuracy based on real-time interaction outcomes.

A distinctive innovation within this embodiment lies in its robust bidirectional communication framework, significantly distinguishing itself from previously documented unidirectional decoding approaches. The integrated LLM is designed to generate contextually relevant and semantically precise responses tailored explicitly to the specific communicative modalities and perceptual capabilities of different species. These LLM-generated responses are translated into species-specific stimuli via specialized synthesis modules capable of producing biologically tailored outputs. Stimuli may include acoustically precise signals optimized for specific auditory frequency ranges (including ultrasonic or infrasonic spectra), meticulously patterned haptic feedback suitable for species-specific tactile sensitivities, or precise neuromodulatory stimuli targeting relevant neural circuits. Advanced inverse-modeling algorithms, trained iteratively through reinforcement learning paradigms, systematically refine stimulus generation, enhancing communicative efficacy, response clarity, and interpretative accuracy.

Furthermore, the disclosed embodiment incorporates a sophisticated continuous feedback mechanism, wherein real-time animal responses to stimuli are rigorously monitored and analytically processed. Bayesian updating frameworks and neurosymbolic reasoning methods are employed to integrate observed behaviors and neural responses into evolving symbolic knowledge representations, thereby enabling real-time adaptation and longitudinal enhancement of communicative effectiveness. Such adaptive learning capability ensures the system maintains responsiveness and optimizes interspecies interactions dynamically, evolving in accordance with emerging behavioral insights and interaction outcomes.

Consequently, this advanced embodiment represents a substantial progression beyond conventional unidirectional decoding methodologies typified by efforts such as Project CETI and standard animal vocalization analysis studies. Through the seamless fusion of multimodal neural, physiological, and behavioral inputs with sophisticated transformer-based LLM structures, this invention occupies a novel position at the frontier of interspecies communication technology. The presented integration opens transformative avenues for applications in critical sectors including veterinary diagnostics, precision animal-assisted therapeutic interventions, wildlife management and conservation strategies, and intricate cooperative tasks requiring coordinated interactions between animals, autonomous robotic systems, and human personnel in diverse operational environments.

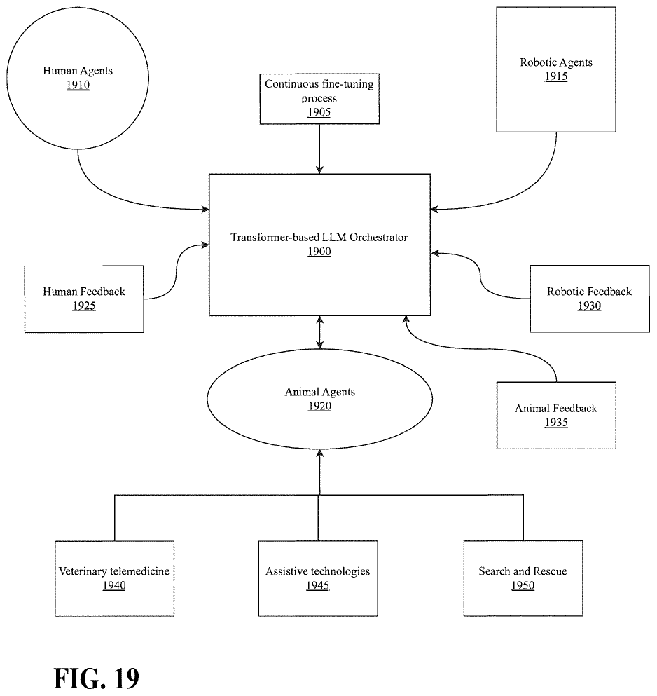

FIG. 19 is a block diagram illustrating an exemplary architecture of a multi-agent LLM orchestration system, a sophisticated technological framework designed to enable seamless coordination and nuanced interaction among heterogeneous physical agents including humans, animals, and robotic entities. The diagram illustrates a complete integrated system that fundamentally expands beyond traditional multi-agent frameworks confined to purely computational interactions, instead encompassing physically instantiated agents with distinct cognitive architectures, sensory modalities, and communication protocols.

The transformer-based LLM orchestrator 1900 incorporates two functional modules: multimodal integration that that performs sophisticated data fusion and analysis across heterogeneous input streams, and a reinforcement learning module that implements adaptive optimization strategies to continuously enhance system performance through iterative feedback loops. Above the orchestrator is the continuous fine-tuning process 1905, which employs comprehensive multimodal datasets and adaptive learning methodologies to progressively refine the orchestrator's interpretive accuracy, translation precision, and coordination capabilities.

Surrounding the central orchestrator are three distinct agent categories positioned strategically to illustrate their interrelationships within the system. The human agents node 1910 indicating human participants who engage with the system through natural language interactions and provide expert guidance. The robotic agents 1915 signifies artificial autonomous systems equipped with specialized sensors, actuators, and computational capabilities. The animal agents 1920 represent various animal species integrated into the operational framework. Critically, each agent category interfaces with the central orchestrator through a specialized adaptive translation module tailored to the specific communication modalities and cognitive capacities of that agent type. A human-specific translation module converts complex multimodal system data into contextually appropriate, nuanced natural language instructions that align with human cognitive processes and domain expertise. A robot-specific translation module generates succinct symbolic command sequences or structured motion directives optimized for robotic sensor capabilities, actuator specifications, and operational constraints. An animal-specific translation module produces biologically-tuned stimuli including acoustic signals, visual cues, or haptic feedback meticulously calibrated to species-specific sensory channels and cognitive capacities.

The human feedback system 1925 captures verbal instructions, performance assessments, and expert guidance provided by human operators. The robotic feedback system 1930 processes execution status reports, sensor data streams, and environmental mapping information generated by robotic units. The animal feedback system 1935 monitors physiological metrics, behavioral responses, and neural signal patterns exhibited by animal participants. These diverse feedback streams flow back to the central orchestrator, enabling continuous refinement of translation accuracy, stimulus design, and coordination strategies.

The veterinary telemedicine 1940 facilitates remote veterinary consultation through smart harness data integration. The assistive technologies 1945 enhance therapeutic animal integration and provide real-time insights to healthcare providers. The search and rescue 1950 operations coordinate multiple agent types in time-critical scenarios. This comprehensive architectural representation effectively captures the system's innovative integration of heterogeneous physical agents within a unified LLM-mediated collaborative ecosystem, illustrating how the orchestration framework enables unprecedented coordination capabilities across human, animal, and robotic agents in complex operational environments.

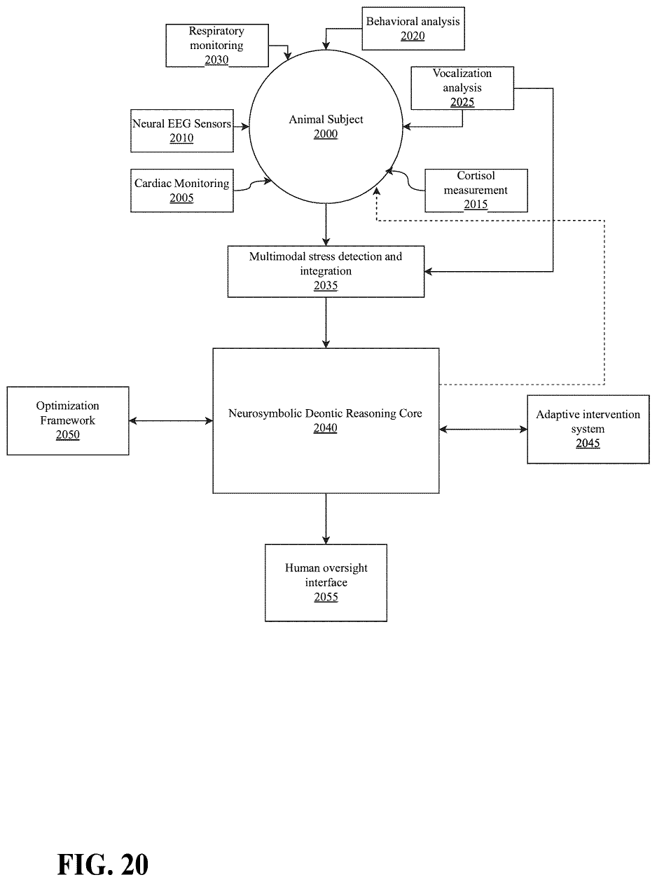

FIG. 20 is a block diagram illustrating an exemplary architecture of an advanced ethical AI integration and neurosymbolic deontic reasoning system specifically designed to ensure and enhance animal welfare in training, communication, and interaction contexts. This innovative system transcends conventional animal monitoring approaches by embedding explicit ethical constraints directly into artificial intelligence frameworks that govern animal interactions.

The animal subject 2000 is the point for the system's monitoring and ethical protection mechanisms. The Multimodal Monitoring Suite comprising six specialized sensor systems: cardiac monitoring 2005 tracks heart rate variability and other cardiovascular indicators; neural EEG sensors 2010 detect brain activity patterns associated with stress or distress; cortisol measurement 2015 assesses stress hormone levels; behavioral analysis 2020 evaluates posture, movement patterns, and other physical indicators; respiratory monitoring 2030 tracks breathing rate and irregularities; and vocalization analysis 2025 identifies acoustic patterns indicative of distress. The collected multimodal data streams flow downward into the multimodal stress detection & integration module 2035 which performs real-time physiological and behavioral analysis to identify potential welfare concerns. This integration module synthesizes diverse data inputs into comprehensive stress assessments that capture both acute and subtle indicators of distress across multiple physiological and behavioral dimensions.

The neurosymbolic deontic reasoning core 2040 encompass an ethical constraint modules that establish and enforce specific welfare thresholds based on species-appropriate standards, and a Logic Programming Framework that implements sophisticated reasoning through Vadalog, Datalog, and fuzzy logic variants. This reasoning core employs advanced deontic logic constructs to formalize and evaluate moral and ethical considerations, ensuring that animal welfare remains paramount throughout all system operations.

The adaptive intervention system 2045 receives directives from the reasoning core and implements appropriate welfare-preserving actions. This system encompasses multiple intervention strategies: Training Intensity Modulation, which adjusts the difficulty or duration of training sessions; Task Complexity Adjustment, which simplifies activities when stress indicators emerge; Restorative Interval Insertion, which introduces recovery periods; and Environmental Modification, which alters contextual factors to enhance comfort and reduce stressors.

The optimization framework 2050 continuously refines the system's ethical decision-making and intervention strategies. This framework incorporates Bayesian Inference Algorithms that update probabilistic models based on observed outcomes, Reinforcement Learning techniques that progressively enhance intervention selection, Intervention Effectiveness assessment that evaluates the impact of each adaptive action, and Welfare-Performance Balance mechanisms that ensure operational goals are achieved without compromising ethical standards. The human oversight interface 2055, which ensures explainability, transparency, and regulatory compliance in all ethical decisions. This interface provides human stakeholders with clear documentation of the system's reasoning processes, intervention decisions, and welfare outcomes, facilitating trust and enabling appropriate human supervision of AI-mediated animal interactions.

The key domains this ethical AI system can be deployed: Therapeutic Interventions, Veterinary Contexts, Animal-Assisted Therapy, and Sensitive Operational Environments where animal welfare considerations are paramount. This comprehensive architectural representation effectively captures how the system systematically incorporates ethical constraints into AI-mediated animal interactions, ensuring that welfare considerations remain paramount while still achieving operational objectives across diverse application domains.

In another embodiment, the disclosed invention provides a sophisticated and comprehensive ethical framework designed explicitly to promote and ensure animal welfare through innovative integration of Ethical Artificial Intelligence (AI) systems within its orchestration, training, and communication platforms. Unlike conventional animal training and monitoring systems, which primarily emphasize task-specific performance and behavioral outputs, this novel embodiment introduces a holistic approach that systematically incorporates explicit ethical constraints directly into the reinforcement learning objectives of the orchestrating.

Large Language Model (LLM). These constraints prioritize humane treatment, minimize physiological and psychological stress, and optimize the overall well-being of animal subjects, significantly extending and surpassing current methodologies in animal training, handling, and communication.

At the core of this embodiment is an advanced neurosymbolic reasoning infrastructure, specifically employing Deontic reasoning constructs as described in U.S. patent application Ser. No. 19/041,999, and all applications and patents claiming priority therefrom or related thereto, are hereby incorporated by reference in its entirety. These constructs enable the rigorous formalization and evaluation of moral, ethical, and safety-related actions through sophisticated logical and computational frameworks. By leveraging cutting-edge logic programming methods such as vadalog or datalog, fuzzy logic variants, and dyadic existential rules, the system achieves reasoning capabilities that exceed traditional fixed-point semantics. This hierarchical and logically rigorous approach allows the AI to dynamically evaluate and enforce complex ethical considerations, continuously validating interactions against predefined moral and ethical standards in a real-time context.

The embodiment includes an intricate multimodal monitoring suite that integrates sensors capable of detecting a wide array of real-time physiological, neural, and behavioral stress indicators. This suite encompasses advanced detection mechanisms for cardiac variability, cortisol level fluctuations, respiratory irregularities, EEG-derived neural stress signatures, and subtle behavioral indicators such as postural changes or vocalizations indicative of distress. These multimodal inputs provide continuous, precise stress assessments directly integrated into specialized ethical constraint modules. Upon detecting stress levels that surpass established ethical thresholds, these modules immediately activate adaptive intervention mechanisms within the orchestrating LLM-mediated training protocols. Interventions may include dynamic modulation of training intensity, simplification of tasks, modification of training pacing, or the introduction of restorative intervals specifically designed to reduce stress and restore baseline physiological and psychological conditions.

Furthermore, this embodiment incorporates state-of-the-art Bayesian inference algorithms and advanced reinforcement learning techniques to iteratively optimize these ethical interventions. This optimization process ensures a dynamic balance between achieving operational objectives and adhering strictly to ethical mandates and welfare standards. The continuous iterative refinement facilitated by reinforcement learning allows the system to enhance stress detection sensitivity, intervention appropriateness, and overall adaptive effectiveness. This ensures consistent compliance with rigorous animal welfare criteria across diverse scenarios and operational contexts.

Additionally, the neurosymbolic reasoning modules integrated within the AI architecture contribute substantially to explainability and transparency in ethical decision-making. By providing structured and logically interpretable justifications for each adaptive action or intervention, the system ensures clear communication of ethical reasoning processes to human stakeholders. Such transparency not only reinforces trust but also provides valuable insights for ongoing refinement and regulatory compliance, further supporting the integration of ethical AI into broader operational and regulatory frameworks.

In summary, this embodiment represents a significant advancement in the state-of-the-art by embedding comprehensive ethical decision-making processes, welfare prioritization, and rigorous neurosymbolic reasoning directly into AI-driven animal interaction, training, and welfare management systems. By harnessing multimodal stress monitoring technologies, sophisticated Bayesian and reinforcement learning optimization strategies, and advanced logic-based ethical reasoning capabilities, the disclosed invention ensures robust and adaptive animal welfare protection. This ethically driven approach markedly differentiates the present invention from existing methods and situates it uniquely to address applications that require stringent ethical compliance, including therapeutic and clinical interventions, precision training in veterinary contexts, animal-assisted therapies, and sensitive operational environments where the preservation and promotion of animal welfare is paramount.

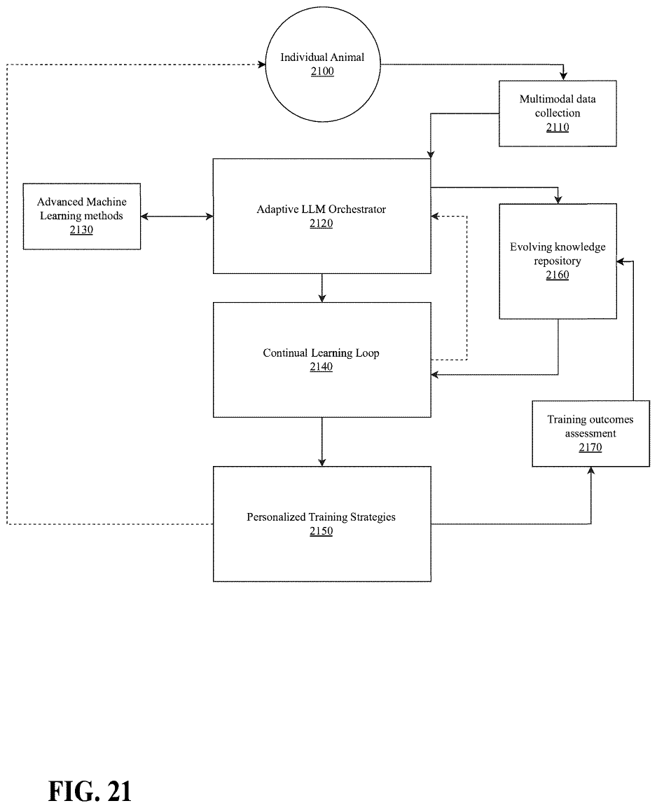

FIG. 21 is a block diagram illustrating an exemplary architecture of an advanced personalization and continual learning framework designed to dynamically optimize animal training methodologies through sophisticated machine learning techniques and adaptive feedback mechanisms. This system fundamentally transforms traditional static training approaches into a scientifically rigorous, continuously evolving discipline characterized by cumulative improvements and individualized adaptations.

The individual animal 2100 serves as both the source of behavioral and physiological data and the recipient of personalized training interventions. The multimodal data collection 2110 module continuously captures three critical data streams: neural activity patterns that reflect cognitive processes and learning states; physiological biomarkers that indicate emotional responses, stress levels, and physical conditions; and behavioral responses that document task performance, engagement levels, and interaction patterns.

The architectural core of the system is an adaptive LLM orchestrator 2120. This orchestrator incorporates two specialized tuning modules: species-specific Tuning, which implements taxonomic adaptations to accommodate the unique cognitive architectures and behavioral repertoires of different animal species; and individual-specific tuning, which maintains personalized profiles that capture the distinctive learning styles, preferences, and capabilities of each animal subject. This dual-level personalization approach ensures that training protocols are optimally aligned with both species-level constraints and individual-level variations.

The advanced machine learning 2130 implements four sophisticated computational approaches: reinforcement learning algorithms that optimize action selection based on observed outcomes; transfer learning techniques that efficiently apply insights gained from one individual to benefit others; federated learning methods that aggregate knowledge across distributed training instances while preserving privacy; and meta-learning capabilities that enable rapid adaptation to novel scenarios and individual-specific learning trajectories.

The continual learning loop 2140 is a critical component that distinguishes this system from traditional static training approaches. This loop incorporates two key mechanisms: incremental gradient updates that progressively refine the system's predictive models based on observed outcomes without catastrophic forgetting of previously learned patterns; and a Bayesian inference engine that rigorously evaluates the uncertainty and confidence associated with different training strategies, enabling optimal decision-making under conditions of partial information.

The personalized training strategies 2150 translates the system's accumulated knowledge and real-time insights into highly individualized training protocols. These strategies encompass multiple personalization dimensions: optimized learning pathways that sequence training elements to maximize retention and skill development; tailored interventions that address specific learning challenges or behavioral patterns; adaptive pacing that adjusts training intensity and progression rates to match individual capabilities; cognitive profile matching that aligns training approaches with cognitive strengths and preferences; emotional response calibration that modulates training parameters based on affective states; and progressive complexity adjustments that ensure optimal challenge levels.

The evolving knowledge repository 2160 systematically accumulates, organizes, and makes accessible the system's growing understanding of animal learning and behavior. This repository contains cumulative behavioral insights derived from multiple training interactions; individual learning histories that document each animal's progression and response patterns; optimal intervention patterns identified through statistical analysis of training outcomes; cross-individual generalizations that capture broadly applicable principles; and adaptive training templates that provide starting points for new training scenarios.

The training outcomes assessment 2170 continuously measures efficiency and efficacy metrics, evaluating the impact of personalized training strategies and feeding these assessments back into the knowledge repository to further refine future training approaches. This comprehensive architectural representation effectively captures how the system implements a dynamic, continuously improving approach to animal training that builds cumulative knowledge while precisely adapting to individual learning characteristics and needs.

In another embodiment, the invention introduces a sophisticated personalization and continual learning system specifically engineered to dynamically refine and optimize animal training methodologies through ongoing, real-time data integration and adaptive knowledge updates. Conventional training approaches, which rely heavily on static manuals or rigidly predefined protocols, fundamentally limit adaptability, often necessitating training processes to start anew with each individual animal or generation. Contrasting significantly with these traditional methodologies, the disclosed embodiment uniquely implements continuous feedback loops and advanced machine learning frameworks that systematically enhance the efficiency, accuracy, and efficacy of animal training practices over successive training sessions and across different animal subjects.

Central to this innovative embodiment is the deployment of an advanced Large Language Model (LLM) that incorporates explicit mechanisms for species-specific and individual-specific tuning. This highly adaptable LLM architecture leverages reinforcement learning (RL) algorithms, transfer learning techniques, and neurosymbolic reasoning methods, enabling it to rapidly assimilate and generalize behavioral and physiological data unique to each animal participant. Data obtained during individual training interactions-including multimodal inputs such as neural activity patterns, physiological biomarker profiles, behavioral responses, and environmental interactions—are continuously fed back into the LLM model. These data streams are systematically analyzed and integrated into the LLM's continually evolving knowledge repository, facilitating real-time and ongoing enhancements to training efficacy and precision.

Moreover, this continual learning loop employs advanced machine learning methods, such as federated learning and incremental gradient updates, designed explicitly to minimize negative transfer effects and optimize the accumulation of positive behavioral insights. Through rigorous Bayesian inference techniques, the system dynamically evaluates training outcomes, identifying optimal learning pathways and interventions tailored to individual animals' evolving responses. This iterative process progressively refines training strategies, thereby consistently improving behavioral outcomes and ensuring increasingly precise and personalized animal interactions.

To further reinforce the robustness and precision of the personalization capabilities, the embodiment utilizes adaptive deep learning architectures with meta-learning capacities, enabling rapid adaptation to individual-specific learning trajectories and behavior patterns. This approach systematically captures subtle variations in animal responses, tailoring subsequent training interactions to match individual cognitive and emotional profiles with unprecedented accuracy.

Thus, by embedding a continual learning and personalization loop directly into the training and communication system, this embodiment significantly transforms animal training practices. It transitions training from a static, generationally reset art form into a dynamic, scientifically rigorous discipline characterized by cumulative improvements and sustained adaptive learning. This inventive approach positions the disclosed system uniquely at the intersection of advanced computational methods, individualized animal cognition, and effective training methodologies, offering substantial enhancements over existing static training paradigms.

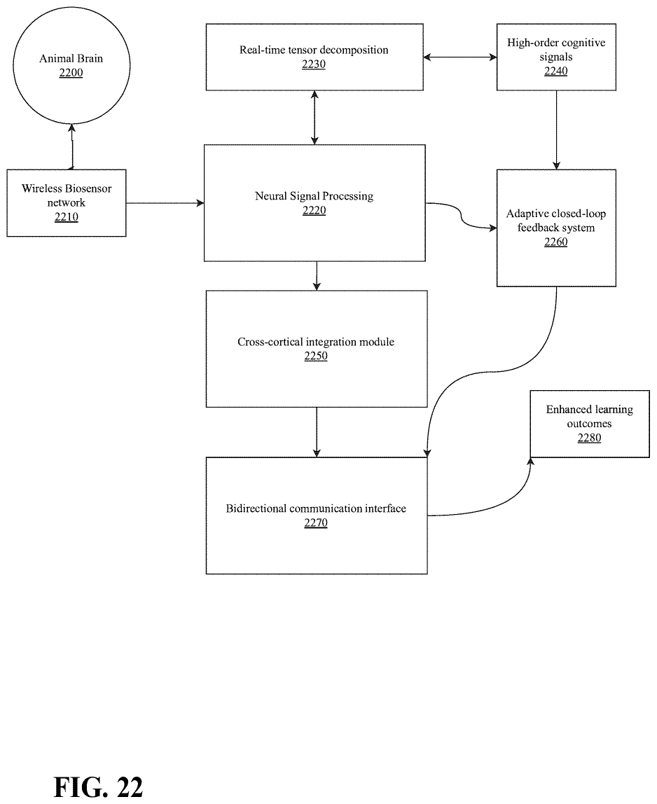

FIG. 22 is a block diagram illustrating an exemplary embodiment of a distributed neural synchronization framework, an advanced system designed to establish more effective cross-species communication channels by leveraging latent knowledge emergence patterns identified in sensory cortices. This innovative framework transcends conventional stimulus-response training methodologies by directly engaging with an animal's internal cognitive representations, enabling unprecedented levels of interspecies understanding and communication efficiency.

The animal brain 2200 contains four distinct sensory cortical regions: the auditory cortex, which processes acoustic information and contains rapidly emerging learning signals; the visual cortex which processes visual stimuli and contains analogous higher-order representations; the somatosensory Cortex, which integrates tactile information and bodily sensations; and the motor cortex, which coordinates movement execution and inhibition. These four interconnected neural regions collectively form the biological substrate with which the system interacts.

The wireless biosensor network 2210 implements minimally invasive, multi-cortical recording through an advanced neuromorphic computing architecture. This sensor array captures neural activity across multiple sensory cortices simultaneously. Unlike conventional neural interfaces that focus on a single brain region, this network captures the coordinated activity across multiple cortical areas, enabling a more comprehensive understanding of distributed cognitive processes.

The neural signal processing module 2220 implements three critical analytical functions: spatiotemporal clustering to identify coherent patterns of neural activity across time and space; neural ensemble detection to recognize functionally related groups of neurons that process similar information; and higher-order signal isolation to distinguish between mere sensory representations and the more valuable cognitive signals that reflect internal knowledge states.

The real-time tensor decomposition 2230 performs dimensionality reduction on the high-dimensional neural datasets. This computational approach systematically identifies low-dimensional components that represent meaningful cognitive patterns while filtering out noise and non-specific neural activity. Bidirectional flow between this component and the signal processing module illustrate the continuous exchange of information that enables adaptive refinement of the decomposition parameters based on detected signal characteristics.

The higher-order cognitive signals 2240 panel contains two key signal types: reward prediction signals which emerge rapidly during learning and precede explicit behavioral responses; and action suppression signals which reflect internally generated inhibitory processes that may not be externally observable.

The cross-cortical integration module 2250 implements three advanced analytical approaches: functional network mapping to identify how information flows between different brain regions; distributed representation analysis to understand how cognitive concepts are encoded across multiple neural ensembles; and multi-region correlation to detect synchronized activity patterns that indicate coordinated processing. This module recognizes that higher-order cognitive processes involve coordinated activity across multiple cortical areas rather than being confined to isolated regions.

The adaptive closed-loop feedback system 2260 dynamically responds to the detected neural signals with precisely calibrated interventions. This system implements four key strategies: precisely timed reinforcement that aligns with internal reward prediction signals rather than observable behaviors; neural-state aligned stimuli that synchronize with the animal's cognitive processing rhythms; internal cognitive state detection that identifies optimal moments for intervention; and interaction pattern adaptation that modifies training approaches based on detected neural responses.

The bidirectional communication interface 2270 serves as the system's primary interaction platform for both humans and animals. This interface is divided into two functional domains: Neural Representation-Based Training & Interaction, which aligns external stimuli with internal cognitive states; and Cognitive Alignment Technology, which facilitates deeper understanding between species through technology-mediated neural synchronization.

The enhanced learning outcomes panel 2280, which highlights the system's primary benefits: Accelerated Training Timeframes achieved through direct engagement with rapidly emerging internal knowledge representations; and improved retention & generalization capabilities resulting from alignment with the animal's natural cognitive processes. This comprehensive architectural representation effectively captures how the system fundamentally transforms animal training and communication by directly engaging with distributed neural representations rather than relying solely on observable behaviors, establishing a revolutionary approach to cross-species cognitive alignment through advanced technology.

In another embodiment, the invention implements a distributed neural synchronization framework that leverages the latent knowledge emergence patterns identified in sensory cortices to establish more effective cross-species communication channels. This sophisticated approach recognizes that, similar to the auditory cortex's role in rapid learning as demonstrated by Drieu et al., other sensory cortices across species may contain analogous higher-order signals that can be harnessed for enhanced interspecies understanding.

The system employs a network of minimally invasive, wireless biosensors placed across multiple sensory cortices (e.g. auditory, visual, somatosensory) to detect and monitor the rapid emergence of reward-prediction and action-suppression signals. These sensors utilize advanced neuromorphic computing architectures to identify the spatiotemporal clustering patterns of neural ensembles that encode higher-order cognitive processes rather than merely sensory representations. This approach is particularly innovative as it focuses on the functional segregation within sensory cortices rather than relying on conventional stimulus-response mappings that represent only a fraction of the cortical processing capabilities.

Central to this embodiment is the implementation of tensor decomposition algorithms that operate in real-time, continuously identifying low-dimensional components from high-dimensional neural datasets. This computational approach enables the system to distinguish between non-selective habituation signals and the more meaningful contingency-specific signals across species. The distributed processing framework strategically focuses computational resources on these latter signals, which emerge rapidly during initial learning phases but may be masked by conventional behavioral measurements.

The system incorporates adaptive closed-loop feedback mechanisms that synchronize with the timing of these higher-order neural signals. For instance, when reward-prediction signals are detected, the system delivers precisely timed reinforcement that aligns with the internal cognitive state of the animal rather than merely with observable behaviors. Similarly, when action-suppression signals are identified (similar to cell ensemble 6), the system adapts its interaction patterns to support rather than counteract these internally generated cognitive processes.

Additionally, this embodiment features a cross-cortical integration module that identifies functional correlations between spatially distributed neural ensembles across different sensory regions. This approach recognizes that higher-order cognitive processes likely involve coordinated activity across multiple cortical areas rather than being confined to isolated regions. By mapping these functional networks dynamically, the system builds a comprehensive model of how knowledge emerges and is represented across the animal's neural architecture.

The distributed neural synchronization framework uniquely transforms animal training and communication by engaging with the animal's internal cognitive representations directly, rather than relying solely on observable behavioral outputs. This approach fundamentally accelerates learning processes by aligning external stimuli and reinforcement with the animal's rapidly emerging internal knowledge representations, potentially reducing training times by orders of magnitude while simultaneously enhancing retention and generalization capabilities.

This innovative embodiment thus extends beyond conventional training paradigms by establishing a bidirectional communication channel that operates at the level of distributed neural representations, fundamentally reimagining the possibilities for human-animal interaction through technology-mediated cognitive alignment.

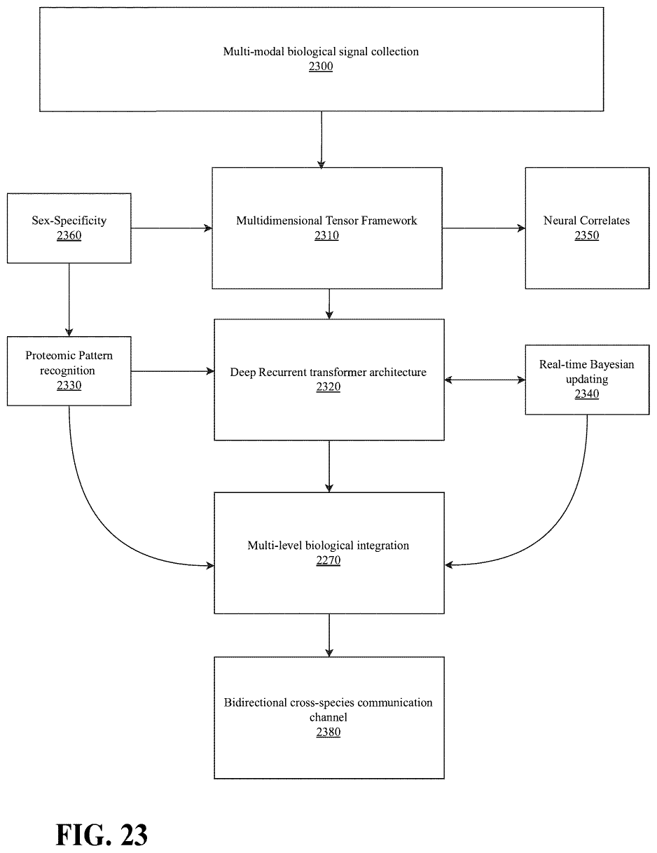

FIG. 23 is a block diagram illustrating an exemplary embodiment of an advanced neuromorphic cross-modal biological signal integration framework, an innovative system that builds upon the previously described distributed neural synchronization framework to enable unprecedented fidelity in cross-species communication through the simultaneous processing of multiple biological signal modalities.

The multi-modal biological signal collection 2300 contains five specialized signal acquisition subsystems: neural oscillatory patterns, which capture brain wave activities across different frequency bands; autonomic physiological responses, which monitor heart rate variability, respiratory patterns, and other indicators of the autonomic nervous system; kinematic markers, which track subtle body movements and postures; vocalization micro-Patterns, which analyze fine-grained acoustic features beyond conventional vocalization analysis; and chemosignal Fluctuations, which detect changes in pheromones and other chemical signals.

The multidimensional tensor framework 2310 implements temporally-precise polymodal integration through sophisticated computational methods. This framework employs a novel retrograde temporal processing algorithm that not only identifies coincident signals across different modalities but crucially predicts imminent state transitions by detecting higher-order temporal correlations that precede behavioral manifestations. The system's ability to process temporally aligned streams from multiple biological sensors enables a comprehensive understanding of the target species' internal states and intentions before they become behaviorally apparent.

The deep recurrent transformer architecture 2320 contains two key functional modules: modality-specific attention heads, which implement specialized signal processing for each input channel, applying optimized computational approaches for different signal types; and the cross-attention mechanism, which unifies these diverse signals through species-specific relevance maps, dynamically weighting each modality based on its contextual importance. This advanced neural network architecture overcomes fundamental limitations of previous approaches by properly integrating the critical temporal dynamics of multisensory processing exhibited in key brain regions.

The proteomic pattern recognition module 2330 analyzes K48-polyubiquitination signatures to gain unprecedented insight into protein degradation profiles that fundamentally differ between directly and indirectly acquired memories. This sophisticated biochemical analysis examines degradation profiles, sex-specific molecular signatures, memory formation mechanisms, and tissue-specific patterns in the amygdala and anterior cingulate cortex.

The real-time Bayesian updating 2340 implements dynamic parameter adjustment, species-specific calibration, individual optimization, causal graph estimation, and experiential recommendation. Bidirectional flow between this module and the transformer architecture illustrate the continuous refinement process that optimizes the system's performance based on ongoing interactions and outcomes. This Bayesian framework ensures that the system continuously improves its interpretive accuracy and communication effectiveness through probabilistic modeling of cause-effect relationships.

The neural correlates panel 2350 highlight the specific brain regions and cellular markers associated with cross-species communication processes. This panel identifies the retrosplenial cortex and anterior cingulate cortex as key brain regions involved in multisensory integration, with Egr2 and c-fos expression patterns serving as cellular markers of neural activity during observational learning and communication.

The sex-specificity module 2360 accounts for documented differences in fear acquisition mechanisms, memory formation variance, and PTSD prevalence factors between males and females. The multi-level biological integration 2370 represents the system's ability to operate simultaneously across multiple biological scales. This integration encompasses three critical levels: molecular signaling, which addresses biochemical processes underlying neural activity; neural ensemble synchronization, which coordinates activity patterns across distributed brain networks; and cognitive alignment, which establishes meaningful cross-species understanding at the psychological level.

The bidirectional cross-species 2380 communication channel enables unprecedented information exchange between species by operating simultaneously at multiple biological levels, from molecular signaling to cognitive alignment. A feedback arrow loops from this communication channel back to the Bayesian updating component, representing how communication outcomes continuously inform and refine the system's parameters and operational strategies. This comprehensive architectural representation effectively captures how the system integrates multiple biological signal modalities with advanced computational methods to establish a truly bidirectional communication channel that operates simultaneously across molecular, neural, and cognitive levels, fundamentally reimagining the possibilities for cross-species understanding and interaction.

In another embodiment the system implementation leverages multidimensional biological signal processing through temporally-precise polymodal integration. This enhanced framework establishes a hierarchical signal transformation architecture that dynamically adapts to species-specific neural encoding patterns while providing unprecedented fidelity in cross-species communication.

At its core, this embodiment introduces a multidimensional tensor-based computational framework that simultaneously processes temporally aligned streams from non-invasive biological sensors capturing five distinct signal modalities: neural oscillatory patterns, autonomic physiological responses, subtle kinematic markers, vocalization micro-patterns, and chemosignal fluctuations. The system employs a novel retrograde temporal processing algorithm that identifies not only coincident signals across modalities, but crucially, predicts imminent state transitions by detecting higher-order temporal correlations preceding behavioral manifestations in the target species.

The technical innovation lies in the implementation of a deep recurrent transformer architecture with specialized attention heads for each sensory modality, unified through a novel cross-attention mechanism that weights each modality based on species-specific relevance maps derived from real-time Bayesian updating. This overcomes the fundamental limitation of previous approaches that relied primarily on neuroimaging data without integrating the critical temporal dynamics of multisensory integration exhibited in the retrosplenial cortex and anterior cingulate cortex, as evidenced by elevated Egr2 and c-fos expression patterns documented in the retrosplenial cortex of observer animals.

Importantly, this embodiment incorporates proteomic pattern recognition technology to analyze K48-polyubiquitination signatures in batch or in real-time, enabling unprecedented insight into protein degradation profiles that fundamentally differ between directly and indirectly acquired fear memories. This allows the system to dynamically adjust its computational parameters based on sex-specific molecular signatures, a critical advancement considering the documented sex differences in fear acquisition mechanisms, memory formation and PTSD prevalence. The system utilizes a specialized machine learning model trained on degradation-specific K48-polyubiquitination profiles to precisely calibrate neural synchronization parameters, accounting for the unique protein-level differences between male and female subjects identified in amygdala and anterior cingulate cortex tissues during memory formation and providing additional recommendations associated with linked experiences based on approximated causal graph estimates to improve future training or operational processes or activities.

This enhanced framework provides a truly bidirectional communication channel that operates simultaneously at multiple biological levels—from molecular signaling to neural ensemble synchronization—fundamentally reimagining cross-species communication through technology-mediated cognitive alignment with sensitivity to both biological sex and individualized learning mechanisms.

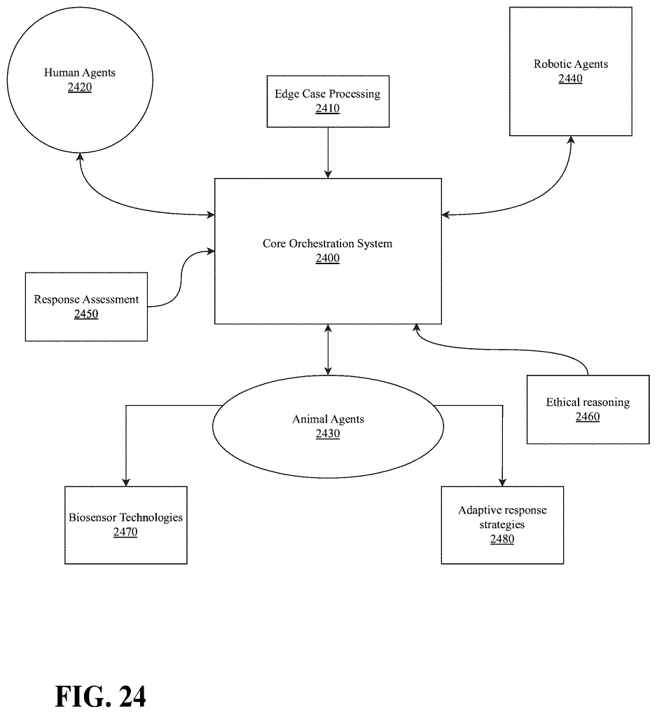

FIG. 24 is a block diagram illustrating an exemplary architecture of an advanced orchestration system specifically designed to manage edge cases and ensure enhanced robustness in complex interactions between humans, animals, and robotic agents. This sophisticated system transcends traditional AI-driven frameworks by implementing advanced contingency-handling mechanisms that address the inherent unpredictability of real-world operations.

The core orchestration system 2400 contains two key functional modules: the out-of-distribution detection, which implements state-of-the-art anomaly detection methodologies including variational autoencoders (VAEs), generative adversarial networks (GANs), and gaussian mixture models (GMMs) to identify behaviors that significantly diverge from expected patterns; and the agent guardrails module, which provides self-awareness capabilities and safety controls that establish protective boundaries around system operations. This central orchestration system serves as the cognitive nexus that coordinates interactions between diverse agent types while continuously monitoring for potential edge cases.

The edge case processing module 2410 performs anomalous interaction detection and behavioral deviation classification. This systematically identifies patterns that fall outside normal operational parameters and categorizes them according to their characteristics and potential impact. Three distinct agent categories participate in the orchestrated interactions: Human Agents 2420, Animal Agents 2430, and Robotic Agents 2440. Bidirectional flows connect each agent type with the orchestration system, illustrating the continuous exchange of information and commands that enables coordinated multi-agent operations. A human supervisor override provides a critical safety mechanism allowing human operators to intervene when necessary. An alert extends from the orchestration system to this override module, representing the system's ability to notify human supervisors when it detects anomalies requiring human judgment.

A response assessment module 2450 implements sophisticated analytical capabilities through two key components: Reinforcement Learning, which utilizes Monte Carlo Tree Search (MCTS) and Direct Preference Optimization (DPO) to strategically evaluate potential actions; and Bayesian Inference which performs severity assessment of detected anomalies by calculating probabilistic impact estimates. Bidirectional flow connects this assessment module with the core orchestration system, illustrating the continuous exchange of information that enables nuanced decision-making in response to edge cases.

An ethical reasoning module 2460 ensures that all system responses adhere to established moral and operational guidelines. This module contains two complementary components: neurosymbolic logic, which applies formal frameworks to systematically evaluate ethical considerations and safety implications; and LLM Agents, which provide advanced interpretative functions to bridge communication gaps between different agent types. Ethical considerations continuously inform and constrain orchestration decisions.

The biosensor technologies module 2470 utilizes e-tattoo and wearable sensors to collect precise physiological data from animal subjects, while the adaptive response strategies 2480 implement mode switching and predefined protocols in response to detected anomalies. The application domains highlight specific contexts where this orchestration system provides particular value: Veterinary Interventions, where animal health monitoring requires robust edge case handling; Therapeutic Settings, where emotional and behavioral anomalies must be promptly addressed; and Field Operations, where unpredictable environments demand adaptive response capabilities. This comprehensive architectural representation effectively captures how the system proactively addresses edge cases through advanced AI safety methodologies, fundamentally enhancing the reliability and practical applicability of multi-agent orchestration across diverse operational contexts.

In another embodiment, the disclosed invention presents a sophisticated orchestration system explicitly designed to manage edge cases, thereby ensuring enhanced robustness and resilience in complex, dynamic scenarios involving humans, animals, and robotic agents. Traditionally, AI-driven interaction frameworks predominantly concentrate on idealized, predictable scenarios—commonly referred to as “happy-path” scenarios—often overlooking the inherent complexity and unpredictability presented by real-world operations. This embodiment significantly progresses beyond established methodologies by integrating advanced contingency-handling mechanisms, including sophisticated self-awareness algorithms, rigorous outlier detection procedures, and dynamic adaptive response strategies. These comprehensive capabilities collectively establish robust safeguards, commonly known within AI safety discourse as “agent guardrails,” enhancing overall system stability and reliability.

At the core of this robust orchestration architecture are advanced machine learning techniques specifically tailored for rapid detection and interpretation of anomalous interactions and unexpected behavioral deviations across the full spectrum of participating agents. The invention implements state-of-the-art out-of-distribution detection methodologies—such as Variational Autoencoders (VAEs), Generative Adversarial Networks (GANs), and Gaussian Mixture Models (GMMs)—to identify and classify behaviors or events significantly diverging from learned interaction patterns or anticipated operational states. Upon detection of these anomalies, the system initiates contextually informed and precise responses, which may include real-time switching of operational modes, automated implementation of predefined risk mitigation protocols, or immediate alerts triggering human supervisor engagement.

Further enhancing its robustness, the orchestration system integrates sophisticated reinforcement learning (RL) and Bayesian inference frameworks to dynamically assess the severity, potential impact, and urgency associated with detected anomalies. This nuanced analytical capability empowers the system to strategically prioritize interventions, deploying autonomous adaptive adjustments in interaction complexity or invoking more immediate, direct interventions that mandate human oversight. Additionally, the embodiment encompasses neurosymbolic reasoning modules, utilizing formal logic-based frameworks to systematically evaluate ethical considerations, safety implications, and operational constraints associated with unexpected events. This ensures rigorous, transparent decision-making processes that support accountability and traceability within the AI's operational reasoning.

The explicit integration of contingency-handling capabilities significantly augments system resilience, underscoring advanced self-awareness and adaptive versatility in unpredictable operational environments. Practical applications include veterinary medical interventions, where unforeseen stress indicators or anomalous animal behaviors immediately prompt recalibration of treatment protocols; therapeutic settings, wherein sudden emotional shifts in human patients trigger timely notifications to therapeutic staff; and complex, variable field operations where robotic or animal agents encounter unexpected environmental challenges necessitating swift orchestration adjustments or direct human intervention.

In summary, this inventive embodiment reinforces the comprehensive robustness and practical applicability of the disclosed orchestration framework by proactively addressing edge cases through advanced AI safety methodologies. Leveraging exemplary state-of-the-art technologies—such as Monte Carlo Tree Search (MCTS), Direct Preference Optimization (DPO), e-tattoo biosensors, and sophisticated Large Language Model (LLM) agents—this invention fundamentally advances interaction reliability. Specifically, MCTS delivers rigorous, strategic planning and decision-making capabilities by methodically exploring potential interaction sequences to optimize outcomes amidst uncertainty. DPO contributes sophisticated RL methodologies guided directly by human and animal behavioral preferences, thus aligning operations with ethical and safety-oriented objectives. The integration of e-tattoo technologies ensures precise, real-time physiological data acquisition through minimally invasive sensors, thereby significantly enhancing the system's sensitivity and responsiveness to nuanced stress and health indicators. Lastly, LLM agents provide advanced interpretative and generative communicative functionalities, adeptly bridging perceptual and linguistic divides between human, animal, and robotic participants. By effectively synthesizing these advanced components into an integrated orchestration framework, the invention delivers exceptional functionalities for comprehensive animal-human-robot interactions, substantially addressing critical operational requirements across domains such as animal training, veterinary diagnostics, care management, and advanced interspecies communication scenarios. The analytical validation confirms the scientific grounding and methodological rigor of employed techniques, including information-theoretic optimization for efficient data utilization and RL loops for adaptive refinement, solidifying the inventive novelty and technical robustness of the approach.

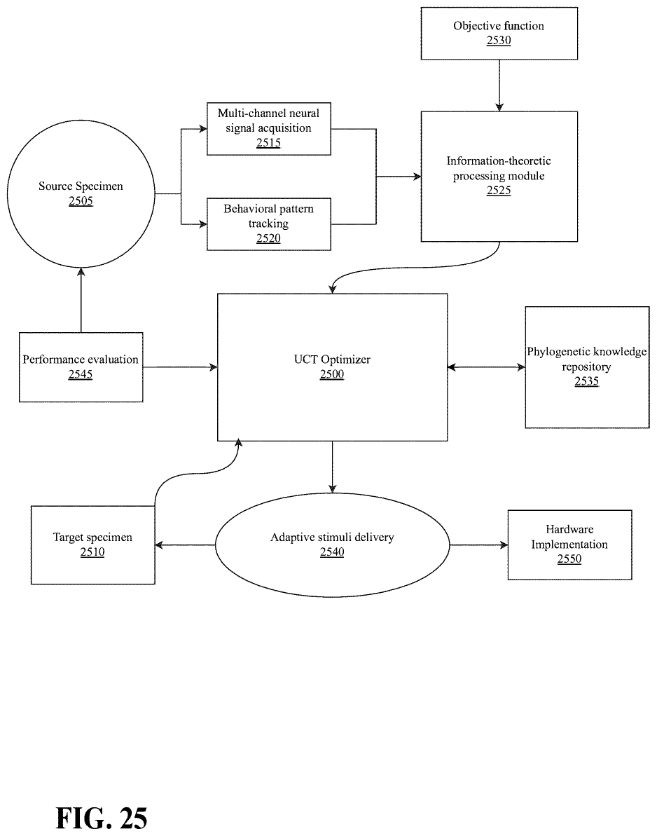

FIG. 25 is a block diagram illustrating an exemplary architecture of an information-theoretic optimization system designed for cross-generational knowledge transfer in animal populations. This sophisticated framework implements a dual-optimization paradigm within a reinforcement learning structure to efficiently transfer behavioral knowledge between individuals across different generations or species.

The Source Specimen 2505 is the individual from which knowledge is being extracted, while the Target Specimen 2510 is the recipient of the optimized training protocol. These biological subjects form the endpoints of the knowledge transfer pathway that the system facilitates. Connected to the Source Specimen 2505 are two data acquisition modules: the multi-channel neural signal acquisition system 2515, which collects high-resolution neural activity data through a 128-channel front-end; and the behavioral pattern tracking 2520, which monitors and documents observable behaviors exhibited by the source animal. Flow from the Source Specimen to these acquisition modules represent the continuous flow of biological and behavioral data into the system.

The Information-Theoretic Processing Module 2525 is a core component containing two complementary computational approaches: Shannon Entropy Maximization, which employs wavelet-based decomposition to maximize the information content of the transfer protocol (H(τ)); and Kolmogorov Complexity Minimization, which implements minimum description length encoding to reduce the representational complexity of the knowledge being transferred (K(κ)). This dual-optimization approach ensures that knowledge transfer is both informationally rich and cognitively efficient.

The objective function 2530 mathematically formulates the system's optimization goal: ƒ(τ,κ)=α·H(τ)−β·K(κ)+γΦ(τ,κ). This function simultaneously maximizes Shannon entropy while minimizing Kolmogorov complexity, with weighting coefficients (α, β) that are dynamically adjusted based on species-specific learning characteristics and a phylogenetic relatedness function Φ(τ,κ) that accounts for evolutionary distance between specimens.

The UCT optimizer 2500 with super exponential regret minimization a sophisticated reinforcement learning component that implements a modified Upper Confidence Tree algorithm. This optimizer balances exploration and exploitation during the knowledge transfer process, with mathematical formulations that incorporate phylogenetic scaling factors: UCT_score(s,a)=Q(s,a)+c·√(ln(N(s))/N(s,a))·exp(δ·D(s)) and a regret bound constrained by R(T)≤O(√(T·ln(T)·exp(−λ·I(τ; κ)))). These advanced formulations ensure efficient optimization that respects biological learning constraints.

The phylogenetic knowledge repository 2535 stores and organizes optimized protocols, knowledge encodings, phylogenetic mappings, species-specific learning parameters, and transfer performance metrics. This comprehensive database enables the system to build upon previous successful knowledge transfers and refine its approaches over time. Bidirectional flow between this repository and the UCT Optimizer illustrate the continuous exchange of information that enhances the system's effectiveness through accumulated experience.

The adaptive stimuli delivery 2540 implements the optimized knowledge transfer protocol through precisely calibrated stimuli presented to the Target Specimen 2510. This module operates with ultra-low-latency feedback (4.7 microseconds), enabling real-time adjustments based on the target's responses. This handles both the Transfer Protocol (t) and the Knowledge Representation (K), ensuring their coordinated presentation to maximize learning effectiveness.

The Performance Evaluation module 2545 implements transfer efficacy metrics, information-theoretic advantage analysis, and convergence verification to quantitatively assess the success of knowledge transfer operations. This evaluation component completes a reinforcement learning feedback loop by providing performance data that informs subsequent optimization iterations. Two parameter-related components are included in the central region: the Learning Parameter Update module, which dynamically adjusts the system's operational parameters (α, β, γ, δ, λ, η) based on ongoing performance; and the Convergence Criteria component, which establishes formal conditions for successful knowledge transfer, including thresholds for mutual information I(τ; κ)>ξ_p and entropy-complexity ratio H(τ)/K(κ)>ρ_c.

The hardware implementation panel 2550 details the specialized circuit architecture supporting the system's operations, including a 128-channel neural front-end, wavelet transform co-processor, pattern-matching ASIC, and dedicated UCT controller. This hardware infrastructure enables the real-time processing and ultra-low-latency feedback essential for effective knowledge transfer. This comprehensive architectural representation effectively captures how the system implements information-theoretic principles to optimize knowledge transfer between animals, balancing information richness and cognitive efficiency through advanced computational methods and specialized hardware.

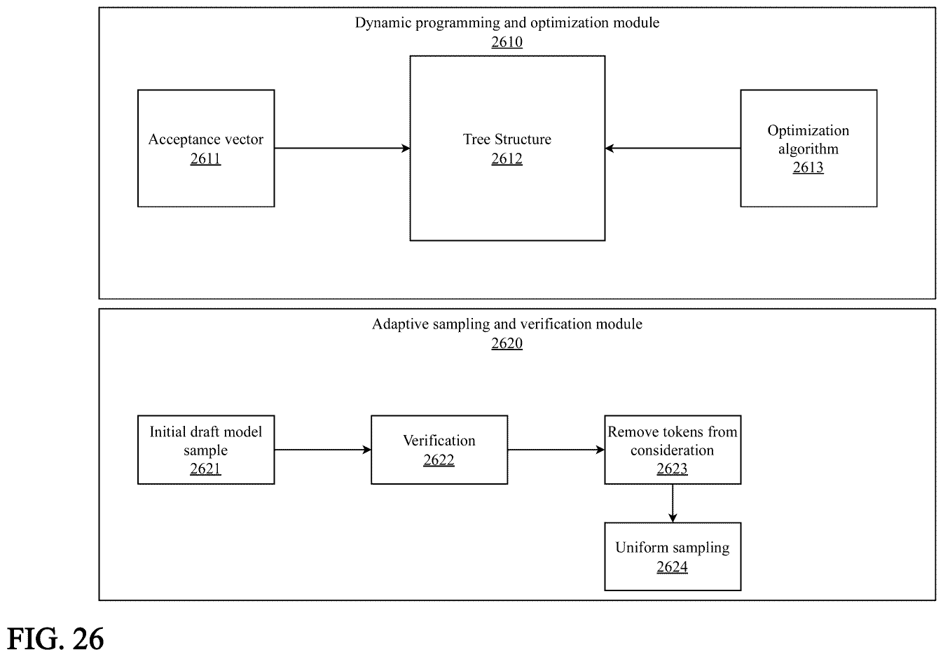

FIG. 26 is a block diagram illustrating an exemplary architecture of a speculative decoding system for natural language processing applications that incorporates a dynamically optimized tree structure and employs an advanced token sampling and verification methodology to enhance decoding efficiency and accuracy.

This system is particularly suitable for deployment on computationally constrained consumer devices such as smartphones, tablets, and low-power computers. The invention addresses key limitations in conventional speculative decoding approaches by implementing a dynamic programming optimization technique and an adaptive sampling algorithm that work in concert to maximize throughput while maintaining output quality.

The speculative decoding comprises two primary modules: a dynamic programming optimization module 2610 and an adaptive sampling and verification module 2620. The dynamic programming optimization module implements a novel approach to constructing the speculative token tree, eschewing pre-defined fixed sequences or rigid tree architectures in favor of an iteratively optimized structure. At the core of this module is the tree structure consisting of a root node representing the current state of text generation, from which extend multiple possible continuation paths organized in a hierarchical structure.

The optimization of this tree structure 2612 is guided by an Acceptance Vector 2611 which contains probability values (P1, P2, P3) representing the likelihood of token acceptance at each hierarchical position in the tree. These probabilities are derived from historical performance data and model characteristics, enabling the system to predict which speculative paths are most likely to be verified by the target model.

The optimization algorithm 2613 applies a recursive evaluation process to determine potential sub-tree configurations, identifies optimal node placements by maximizing the probability of acceptance across the entire tree structure, and finalizes the configuration to achieve the highest overall acceptance likelihood given the constraints of the computational environment. This dynamic adjustment capability allows the speculative tree structure to adapt based on both the capabilities of the drafting model and the specific performance characteristics of the underlying hardware platform, thereby achieving superior scalability as speculative budgets increase.

The adaptive sampling and verification module 2620 implements a novel approach to token selection and verification that substantially improves upon conventional methods. This module begins with an initial draft sampling 2621 which generates candidate tokens according to probabilities determined by a lightweight drafting model. Generated tokens are passed to verification 2622 which validates each token against the distribution produced by the target language model. If a token is accepted it becomes part of the final output sequence; if rejected the token is processed by the Token Removal 2623 which eliminates its probability mass from consideration in subsequent sampling iterations. The Decision then determines whether all tokens with non-zero draft probabilities have been exhausted. If not the system returns to the sampling process with the modified probability distribution; if all tokens have been exhausted the system transitions to the Uniform Sampling 2624 which implements sampling from previously unconsidered tokens in the vocabulary with equal probability.

The dynamic programming optimization technique employs a quantitative scoring mechanism that maximizes expected token acceptance. For each potential tree configuration T, an expected utility U(T) is computed as the sum of the products of the probability of reaching each node and the expected computational savings if that node is accepted by the target model. The acceptance vector is continually refined during system operation through a feedback mechanism that updates acceptance probabilities based on observed verification outcomes, enabling the system to adapt to changing text domains, user patterns, and model behaviors over time. The adaptive sampling algorithm implements sampling without replacement, initializing a set of candidate tokens with their respective probabilities, sampling tokens according to this distribution, accepting or rejecting them based on verification against the target model, and removing rejected tokens from the candidate set with probability renormalization. When the candidate set is depleted, the system switches to uniform sampling from vocabulary tokens not yet considered, ensuring robust performance across varying inference hyperparameters and operating environments.

This adaptive approach delivers several performance benefits, including reduced redundancy in token proposals, higher overall acceptance rates, improved distributional fidelity to the target model, and faster decoding speed. The system is particularly effective at low inference temperatures, where conventional methods often struggle with repeatedly proposing high-probability yet incorrect draft tokens. The described speculative decoding system offers significant advantages over conventional methods, achieving speed improvements of up to 3× compared to standard autoregressive decoding while maintaining output quality indistinguishable from non-speculative approaches. Applications of this technology include on-device conversational assistants with reduced latency, mobile text generation applications with enhanced responsiveness, edge computing implementations of large language models, Internet-of-Things devices with natural language interfaces, and accessibility tools for real-time text prediction and completion. By combining the dynamically optimized tree structure with adaptive sampling methodology, the system achieves a balance of efficiency and accuracy that makes advanced language model capabilities feasible on a wider range of consumer hardware than previously possible.

In another embodiment, the speculative decoding process incorporates a dynamically optimized tree structure and employs an advanced token sampling and verification methodology to enhance decoding efficiency and accuracy, particularly suitable for deployment on computationally constrained consumer devices. The system first implements a dynamic programming optimization technique to iteratively construct an optimal speculative token tree. Rather than relying on pre-defined fixed sequences or rigid tree architectures, the dynamic algorithm selects the branching patterns based on a quantitative scoring mechanism that maximizes expected token acceptance. This scoring mechanism employs an acceptance vector wherein each element represents the probability of acceptance for tokens at specific hierarchical positions. The dynamic programming method recursively evaluates sub-tree configurations, identifies optimal node placements, and maximizes the cumulative acceptance likelihood across the token tree. Consequently, the optimized speculative tree structure dynamically adjusts itself based on both the capabilities of the drafting model and the specific performance characteristics of the underlying hardware platform, achieving superior scalability as speculative budgets increase.

The sampling and verification process is further refined by a novel adaptive sampling algorithm designed to ensure robust speculative decoding across varying inference hyperparameters and operating environments. Instead of traditional methods that repeatedly sample tokens independently from draft models, this embodiment implements sampling without replacement. The adaptive algorithm initially samples tokens according to probabilities generated by the draft model. If a token is rejected during verification against the target model's distribution, its probability is removed from consideration in subsequent sampling steps. Should all tokens with non-zero draft probabilities be exhausted, the system transitions to uniform sampling from previously unconsidered tokens. This adaptive approach avoids the inefficiency associated with repeatedly proposing high-probability yet incorrect draft tokens, especially at low inference temperatures. As a result, the system significantly reduces redundant sampling operations and enhances overall acceptance rates, maintaining distributional fidelity to the target model while improving decoding speed and robustness.

In another embodiment focused on enhancing scalability, the speculative decoding system leverages hardware-aware optimization that accounts for the computational characteristics of the inference platform, such as GPU memory bandwidth, computation capacity, and latency requirements. This optimization strategy integrates directly into the speculative token tree construction algorithm, determining the optimal tree size and depth based on measured hardware parameters. It calculates the expected decoding latency and computational overhead for varying speculative tree configurations, dynamically adjusting the token speculation budget accordingly. This hardware-informed approach enables the system to efficiently manage larger speculative trees, particularly beneficial when operating in memory-bound regimes, such as offloading scenarios or lower-powered GPU environments. By proactively balancing token generation efficiency with hardware constraints, the system can achieve significantly higher throughput and reduced latency, making it especially effective for real-time interactive LLM inference applications.

Furthermore, in this embodiment, an additional interdisciplinary enhancement integrates neurosymbolic reasoning methodologies into the speculative decoding framework. Specifically, the speculative decoding is augmented with symbolic logic reasoning components that analyze intermediate speculative outcomes against domain-specific constraints or knowledge graphs. When speculative decoding proposes tokens that lead to potential semantic or factual inconsistencies, the neurosymbolic reasoning layer intervenes to either correct the speculative outcomes directly or adjust the probabilities of subsequent tokens, guiding the sampling and verification process towards more accurate and contextually coherent token generation. This interdisciplinary integration not only enhances the quality and reliability of generated outputs but also expands the applicability of speculative decoding into areas requiring rigorous logical consistency and adherence to structured domain knowledge, such as scientific reasoning, complex problem-solving tasks, and interactive digital assistants operating in knowledge-intensive environments.

In another embodiment, the speculative decoding framework is further enhanced through an advanced, dynamically evolving computational graph structure, enriched by strategically introduced contextual noise elements inspired by cognitive attention mechanisms observed in advanced neurosymbolic reasoning systems. This enriched computational graph architecture systematically introduces sophisticated, semantically coherent yet computationally extraneous nodes and edges designed to simulate realistic cognitive distractors. These distractors significantly elevate the complexity of speculative decoding tasks, demanding highly precise selective attention and robust adaptive inference strategies from the decoding engines. The deliberate integration of these semantically plausible but computationally unnecessary elements, or “noise nodes,” represents a significant departure from conventional speculative decoding methods that typically focus solely on efficiency within structurally clean and noise-free computational graphs.

To effectively navigate this enriched and more complex decoding landscape, this embodiment introduces a novel adaptive inference routing algorithm, termed Contextually Attentive Dynamic Routing (CADR). CADR operates by dynamically assessing each computational node's semantic relevance to the ongoing speculative decoding objective, guided by a dual-layer semantic filtering mechanism. The first layer utilizes deep learned embeddings generated by transformer-based encoders to produce high-dimensional vector representations capturing intricate contextual relationships between nodes and the target decoding context. Concurrently, the second layer employs heuristic-driven semantic similarity metrics, such as cosine similarity and graph-theoretic node proximity scores, providing an efficient computational means to rapidly assess relevance at scale. Through iterative interplay between deep semantic embeddings and lightweight heuristic evaluations, the CADR algorithm achieves an optimal balance between accuracy and computational overhead, rapidly isolating the most semantically pertinent nodes and efficiently circumventing noise nodes without disrupting computational integrity or coherence.

Further refining speculative decoding accuracy, the embodiment incorporates iterative, multi-stage refinement cycles explicitly informed by preliminary inference results. Each iterative refinement cycle employs a feedback loop based on reinforcement learning strategies, wherein the speculative decoding paths generated at earlier inference stages are critically evaluated against ground-truth or high-confidence model outputs. This feedback is operationalized through a reinforcement-based probability adjustment mechanism termed Path-Confidence Reinforcement Optimization (PCRO). PCRO dynamically modifies speculative path selection probabilities, reinforcing pathways historically correlated with successful decoding outcomes and diminishing emphasis on less reliable speculative trajectories. This iterative reinforcement and optimization process not only expedites convergence toward optimal decoding results but also continuously refines the speculative model's predictive accuracy through real-time adaptive learning, enabling the system to robustly and swiftly adapt to evolving input complexities and contexts.

An additional critical innovation introduced in this embodiment is a neurosymbolic meta-reasoning controller (NS-MRC), strategically embedded within the speculative decoding pipeline. The NS-MRC leverages advanced symbolic reasoning algorithms combined with deep neural pattern recognition to monitor, interpret, and dynamically adjust the speculative decoding paths in real-time. At each speculative inference iteration, the NS-MRC employs symbolic logic queries against domain-specific knowledge bases, constraint satisfaction networks, or logical inference rule repositories to validate intermediate decoding outputs. When potential logical inconsistencies or semantic contradictions are detected, the NS-MRC initiates corrective inference steps, employing neurosymbolic back-propagation techniques to update speculative decoding states accordingly. This integration of symbolic logic-based reasoning with neural inference mechanisms significantly strengthens the speculative decoding architecture's ability to manage and resolve complex multi-step inference tasks, particularly under conditions of semantic uncertainty and noisy contextual environments.

In terms of scalability and integrative capability, this advanced speculative decoding architecture is explicitly designed for seamless incorporation into broader hierarchical computational frameworks. Each instantiation of the speculative decoding graph architecture can operate autonomously or in coordination with other similar modules, configured either in parallel or in cascade. This modular design facilitates effortless scaling of decoding tasks, enabling distributed deployment across cloud infrastructures or high-performance computing clusters to efficiently manage computationally intensive decoding demands. Moreover, the architecture inherently supports federated inference and distributed learning mechanisms, allowing speculative decoding modules distributed across edge devices or decentralized computing nodes to collaboratively refine their speculative prediction models in real-time. Thus, the system attains exceptional flexibility and scalability, robustly handling speculative decoding tasks of arbitrary scale, complexity, and contextual intricacy, making it particularly suitable for advanced interactive and autonomous cognitive systems requiring sophisticated speculative reasoning capabilities.

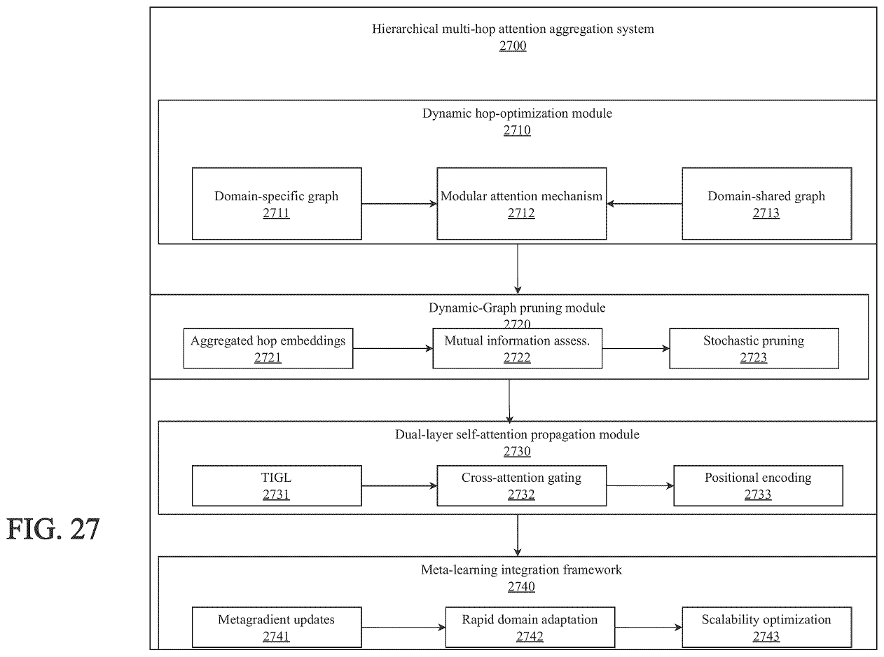

FIG. 27 is a block diagram illustrating a hierarchical multi-hop attention aggregation system 2700 comprising a comprehensive architecture designed to enhance recommendation performance through advanced graph-based techniques. The system begins with a Dynamic Hop-Optimization Module 2710 that forms the foundation of the architecture by implementing adaptive neighborhood hop determination based on real-time data metrics. Within this module, the Domain-Specific Graph 2711 and Domain-Shared Graph 2713 represent distinct graph structures tailored to capture both unique domain characteristics and cross-domain patterns respectively. These graph structures feed into the Modular Attention Mechanism 2712, which employs entropy-driven weighting schemes to assign different relevance scores to neighbors at varying hop distances. This mechanism independently aggregates neighbor information from both domain-specific and domain-shared graphs, enabling the system to capture salient high-order relationships while filtering out noise from distant connections. The adaptive approach implemented in this module dynamically determines the optimal neighborhood hop configurations based on user interaction density and embedding entropy metrics, ensuring that the most relevant connections are prioritized during the aggregation process.

The aggregated embeddings from the Dynamic Hop-Optimization Module 2710 flow into the Dynamic Graph Pruning Module 2720 applies sophisticated techniques to enhance precision and computational efficiency. This module processes the Aggregated Hop Embeddings 2721 through a Mutual Information Assessment 2722 that evaluates each node's contribution to predictive performance. The assessment is conducted via iterative graph embedding perturbation analysis, yielding marginal embedding contribution scores that quantify information relevance. These scores then inform the Stochastic Pruning 2723 which systematically removes nodes contributing significantly less mutual information to the recommendation task. This pruning process follows mutual information maximization principles, selectively retaining only the most informative connections. By eliminating redundant or less informative nodes, the module substantially reduces computational overhead while enhancing the efficiency of the embedding process, thereby improving scalability for large-scale multi-domain implementations.

The refined embeddings then progress to the dual-layer self-attention propagation module 2730 leverages transformer architecture concepts to further enhance information flow across the graph structure. This module implements transformer-inspired gated layers 2731 positioned after the initial multi-hop aggregation stage to manage embedding propagation across various hop distances. The cross-attention gating 2732 computes attention distributions that selectively control information flow, allowing each attention head to independently focus on distinct embedding patterns from different hop distances. Working in conjunction with this, the positional encoding 2733 provides learnable encoding schemes specifically tailored for high-order neighborhood relations. Together, these components enable the module to selectively gate the propagation of embeddings based on their predictive contributions, ensuring optimized information flow throughout the network and preserving the most valuable predictive signals while minimizing noise propagation.

The system culminates in the meta-learning integration framework 2740 which enables continuous adaptation and evolution of the recommendation model. This framework processes the enriched embeddings-now enhanced by dynamic hop optimization, selective neighbor pruning, and gated cross-hop attention—to enable rapid adaptation to new or evolving domains. The meta-gradient updates 2741 calculates gradients over multiple domain-graph configurations, establishing the foundation for transferable knowledge across domains. These updates feed into the rapid domain adaptation 2742 which facilitates efficient fine-tuning of recommendation models for novel scenarios without extensive retraining. The framework concludes with the scalability optimization 2743 which ensures the system can seamlessly scale across increasingly complex recommendation environments. By applying meta-gradient updates across diverse domain configurations, this framework provides the system with exceptional adaptability, continuously optimizing embedding quality and recommendation accuracy while maintaining computational efficiency. This comprehensive approach enables the system to evolve with changing user preferences and domain characteristics, delivering consistently accurate recommendations across varied and complex scenarios.

In another embodiment, the present invention further enhances the system's recommendation performance by integrating a hierarchical multi-hop attention aggregation method. Specifically, domain-shared and domain-specific graphs are augmented by implementing a dynamic hop-optimization strategy, wherein the model adaptively determines the optimal neighborhood hops based on real-time data-driven metrics such as user interaction density and embedding entropy. In this adaptive approach, each domain-specific or shared graph utilizes a modular attention-guided mechanism to independently aggregate neighbor information at varying hop distances. These modular attention blocks employ an entropy-driven weighting scheme, assigning different relevance scores dynamically to neighbors at multiple hops, allowing the network to capture the most salient high-order relationships without introducing redundant noise from overly distant connections.

To further improve precision, each aggregated hop embedding passes through a specialized dynamic graph pruning module, which applies stochastic neighbor selection based on mutual information maximization principles. Nodes contributing significantly less mutual information to predictive performance-assessed through marginal embedding contribution scores computed via iterative graph embedding perturbation analysis—are systematically pruned. This reduces computational overhead and enhances the efficiency of the embedding process, thereby increasing the overall scalability of the model for large-scale implementations across multiple domains.

Furthermore, this embodiment leverages a dual-layer self-attention propagation technique that utilizes transformer-inspired gated propagation layers positioned after the initial multi-hop aggregation stage. Here, embedding propagation across hops is managed by a cross-attention gating mechanism that computes attention distributions using learnable positional encoding schemes tailored specifically for high-order neighborhood relations. Each attention head independently focuses on capturing distinct embedding patterns from different hop distances and selectively gates the propagation of these embeddings based on their predictive contributions, thus ensuring balanced and optimized information flow.

Finally, to maintain the model's ability to evolve and integrate into larger systems, the resulting embeddings—enriched by dynamic hop optimization, selective neighbor pruning, and gated cross-hop attention—are integrated into a meta-learning framework capable of rapidly fine-tuning recommendation models for novel or evolving domains. By applying meta-gradient updates calculated over multiple domain-graph configurations, this meta-learning capability provides the system with rapid adaptability, enabling seamless scalability across increasingly complex recommendation scenarios while continually optimizing embedding quality and recommendation accuracy.

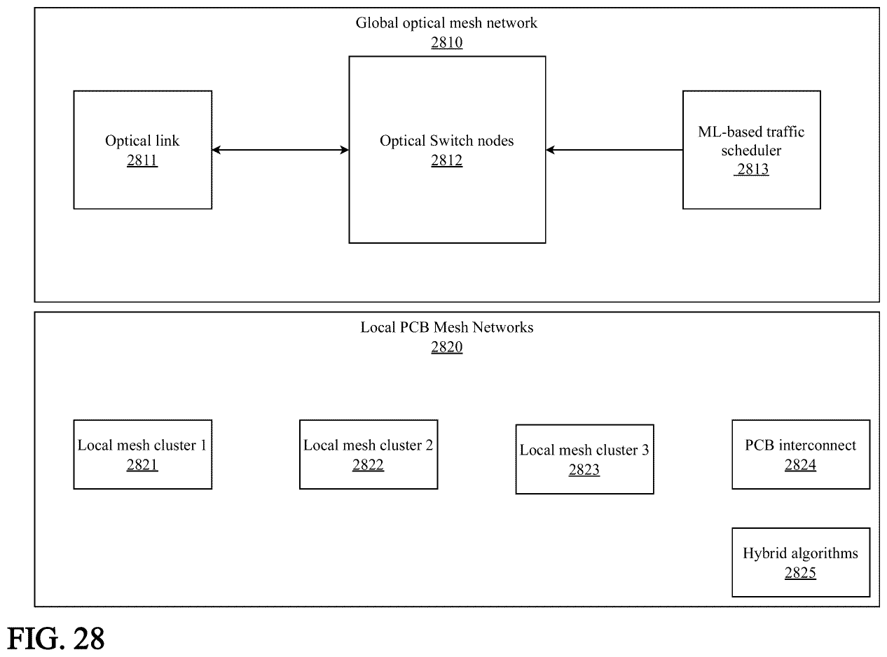

FIG. 28 is a block diagram illustrating a hierarchical multi-dimensional mesh network architecture representing an advanced interconnect system designed to enhance computational performance through intelligent workload-specific routing optimizations and adaptive link utilization.

The system employs a dual-layered hierarchical topology that significantly extends beyond conventional mesh and toroidal configurations. At the upper hierarchical level, the Global Optical Mesh Network 2810 provides extensive connectivity across distributed computational resources through high-performance optical links. This global mesh comprises multiple Optical Switch Nodes 2812 interconnected via bidirectional, multi-plane Optical Links 2811 that form a comprehensive network fabric capable of dynamic reconfiguration based on workload demands. The optical switching elements enable adaptive bandwidth allocation and path optimization, dynamically adjusting global connectivity patterns to minimize communication latency and maximize throughput. This adaptive capability is driven by the ML-Based Traffic Scheduler 2813 which implements machine-learning-based predictive algorithms directly embedded into each mesh node's control logic. These intelligent controllers continuously analyze communication patterns, proactively identify potential bottlenecks, and dynamically reallocate virtual channel resources based on both real-time traffic conditions and historical workload patterns observed during training epochs. By predicting emerging communication requirements before congestion occurs, the system can preemptively reconfigure routing paths and virtual topology embeddings, significantly reducing contention, minimizing packet retransmissions, and ensuring sustained high bandwidth across the entire distributed training infrastructure.

At the lower hierarchical level, the system incorporates multiple Local PCB Mesh Networks 2820 that provide high-density, ultra-low latency connectivity within localized computational domains. Each local mesh 2821, 2822, 2823 consists of a two-dimensional grid of accelerator nodes interconnected via high-bandwidth PCB Interconnects 2824. These direct electrical connections implemented through printed circuit board traces enable extremely low-latency, high-throughput communication between adjacent accelerator components, maximizing data transfer efficiency within each localized computational cluster. The two-dimensional arrangement allows for multiple redundant paths between any pair of nodes within the local mesh, providing robust fault tolerance and enabling sophisticated local routing strategies. The accelerator nodes themselves contain integrated routing logic that coordinates with the global ML-based traffic schedulers to optimize data movement at both local and global scales. This hierarchical approach creates a clear separation of concerns, allowing local communication to proceed with minimal overhead while still enabling efficient global coordination when needed for distributed training operations.

The two hierarchical layers are connected through dedicated Hierarchical Connections that bridge between the Local PCB Mesh Networks and the Global Optical Mesh Network. These connections represent critical junctures where the system transitions between electrical PCB-based communication and optical network-based communication, implementing sophisticated protocol translation and buffer management to ensure seamless data flow across the hierarchy boundary. The system implements specialized interface controllers at these transition points, which manage varying transmission protocols, reconcile different clock domains, and implement quality-of-service policies that prioritize traffic based on application-level requirements. This hierarchical interconnection strategy allows the system to leverage the complementary strengths of both interconnect technologies—the ultra-low latency and high density of PCB traces for local communication, and the reconfigurable, high-bandwidth capabilities of optical networks for global connectivity—resulting in a communication infrastructure optimized for the diverse requirements of large-scale distributed training workloads.

Further enhancing performance, the system implements Hybrid Algorithms 2825 specifically designed to optimize communication patterns across the hierarchical topology. Within local meshes, the system utilizes optimized Ring-based Algorithms for efficient gradient accumulation, parameter synchronization, and intermediate activation transport. These algorithms exploit the regular two-dimensional structure of the local meshes to implement pipelined parallel or bi-directional ring-based communication patterns that maximize throughput for operations requiring frequent exchange of large data volumes between neighboring accelerators. Simultaneously, across the global mesh, the system employs adaptive Bucket-style Algorithms optimized for sparse communication patterns such as activations or weight gradients requiring long-distance propagation. These algorithms dynamically partition and schedule communication to minimize congestion on global links while ensuring timely delivery of critical data. By strategically coupling these specialized communication methods—ring-based locally and bucket-style globally—the system achieves remarkable efficiency at both hierarchical levels, significantly reducing overall communication overhead, enhancing effective throughput, and minimizing end-to-end latency across the entire distributed training process. This sophisticated approach to communication optimization, combined with the dual-layered hierarchical mesh topology and predictive traffic management, enables unprecedented scaling efficiency for increasingly complex artificial intelligence workloads.

In another embodiment, additional novel elements may be integrated into the network architecture to further enhance performance through the introduction of hierarchical multi-dimensional mesh structures that intelligently leverage workload-specific routing optimizations and adaptive link utilization. This embodiment extends the concept of existing mesh and toroidal configurations by embedding a dual-layered hierarchical mesh network topology. At a lower hierarchy level, localized two-dimensional mesh sub-networks employ high-bandwidth, ultra-low latency direct electrical connectivity through printed circuit board (PCB) interconnects, facilitating maximal throughput within localized computational domains. At an upper hierarchical layer, these local meshes connect via intelligent adaptive optical switching elements to form a global interconnect mesh, dynamically optimizing global bandwidth and latency according to predictive workload characterization algorithms.

Specifically, the network interconnects each accelerator through a set of bidirectional, multi-plane connections, allowing sophisticated, adaptive routing that optimally balances traffic across multiple mesh planes based on real-time traffic demands and historical workload patterns. Novelty arises from embedding machine-learning-based predictive traffic schedulers directly into each mesh node's control logic, which proactively reallocates and manages virtual channel resources. These AI-enhanced controllers dynamically identify emerging communication bottlenecks, predict communication patterns from observed training epochs, and adaptively optimize the packet-switching paths and virtual topology embeddings in near real-time. This predictive mesh networking strategy significantly reduces contention and packet retransmissions while maximizing sustained effective bandwidth.

Further performance enhancement is realized through the implementation of hybrid reduction and dissemination algorithms operating concurrently across hierarchical levels. Local meshes exploit optimized pipeline-parallel or bi-directional ring-based algorithms for gradient accumulation, parameter synchronization, and intermediate activation transport, whereas the global mesh utilizes an adaptive bucket-style dissemination method for sparse communications such as activations or weight gradients requiring long-distance propagation. By strategically coupling these methods, communication overhead is minimized at both local and global scales, significantly enhancing throughput and reducing end-to-end latency across the distributed training process.

In another embodiment, interdisciplinary innovations from neuromorphic computing and optical networking technologies are integrated to form an advanced optoelectronic communication infrastructure. Each accelerator includes neuromorphic photonic modulators interfaced with electronic tensor cores, which dynamically encode neural-network-derived workload patterns directly into optical signals. These optically modulated data packets traverse reconfigurable silicon photonic waveguides that constitute the global interconnect fabric, enabling rapid, contention-free, and energy-efficient data transmission between accelerators positioned across disparate mesh subnets. This neuromorphic-photonic network further utilizes wavelength-division multiplexing (WDM) to encode multiple parallel data streams into individual optical fibers, maximizing bandwidth utilization and significantly lowering network latency and power consumption compared to conventional electrical and electro-optical hybrid solutions.

To ensure scalability and seamless integration into broader computational frameworks, this embodiment incorporates dynamic fault tolerance through predictive board and link failure anticipation algorithms based on anomaly detection techniques. Predictive analytics leverage historical and real-time telemetry from embedded diagnostic sensors distributed across the network fabric, allowing preemptive topology reconfiguration, workload redistribution, and adaptive link reassignment before component failures impact system performance. Consequently, this embodiment provides superior scalability, robustness, and cost-performance effectiveness, positioning it as an enabling technology for next-generation large-scale distributed AI systems.

In yet another embodiment, a novel in-situ data transformation layer is introduced within the hierarchical multi-dimensional mesh to further boost system efficiency and flexibility. This data transformation layer is physically distributed across both local electrical sub-networks and global optical interconnects, embedding specialized logic blocks within each accelerator node's network interface. These logic blocks perform on-the-fly data compression, precision reduction, and adaptive quantization of intermediate tensors or gradients based on real-time workload characteristics and user-defined quality-of-service metrics. By locally reducing message size at each hop, the system significantly decreases overall communication traffic, yielding improved effective bandwidth and latency. In addition, configurable decompression hardware in downstream nodes ensures near-lossless data integrity, while providing tunable fidelity for use cases tolerant of reduced precision (e.g., certain deep learning workflows).

A complementary enhancement involves dynamic photonic channel bonding and waveband reconfiguration techniques integrated into the upper, optically driven hierarchy of the network. Each optical link is equipped with reconfigurable ring modulators and wavelength-selective couplers, allowing multiple channels within a fiber to be merged (bonded) on demand for high-priority, large-burst transmissions such as all-reduce operations or large model parameter broadcasts. Conversely, in periods with diffuse traffic patterns, these same photonic channels can be subdivided to accommodate multiple smaller, parallel data streams. Through continuous machine-learning-based link monitoring and forecasting, the system autonomously optimizes channel allocations in near real-time, balancing throughput demands, latency sensitivity, and energy consumption. This approach not only accelerates collective operations but also accommodates emerging heterogeneous workloads that may require simultaneous high-throughput bulk data transfer and numerous smaller, latency-critical messages.

Additionally, to address the complexity of orchestrating diverse traffic patterns across multiple mesh planes and hierarchical layers, this embodiment deploys a neurosymbolic orchestration engine that integrates seamlessly with existing scheduling components. Building on neuromorphic-inspired control techniques, the engine ingests network telemetry (e.g., congestion metrics, node utilization, error rates) alongside system-level signals (e.g., job priority, resource availability) to continuously update routing decisions and in-situ data transformation policies. Symbolic logic rules govern higher-level constraints such as fault tolerance, fairness, and service-level objectives, while embedded neural networks dynamically refine routing heuristics and compression settings based on learned historical patterns. By unifying these strategies, the system achieves a highly adaptive, self-optimizing communication framework able to handle the evolving demands of large-scale AI training, data analytics, and mixed HPC workloads with minimal developer intervention.

Finally, this embodiment incorporates advanced resilience features through predictive distributed checkpointing and partial reconfiguration in the event of projected node or link failures. Utilizing fine-grained anomaly detection data from embedded sensors, the system preemptively checkpoints critical model states in a distributed fashion across the most reliable sub-meshes. Should an impending failure be detected, optical channel bonding is temporarily reallocated to ensure accelerated migration of model states to safe nodes, and local electrical planes dynamically reroute traffic around the compromised section. In concert with the aforementioned neurosymbolic orchestration engine, these reconfiguration processes occur swiftly and autonomously, ensuring both high availability and minimal performance degradation even under challenging operating conditions. By combining in-situ data transformation, dynamically reconfigurable photonic channels, neurosymbolic control, and proactive resilience measures, the inventive architecture delivers a transformative solution for next-generation large-scale distributed AI and HPC environments.

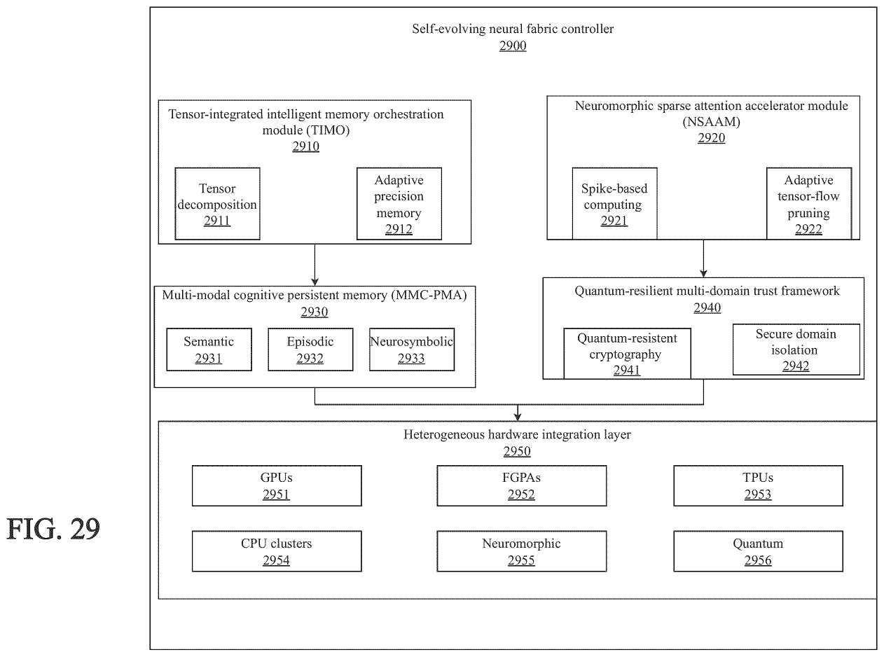

FIG. 29 is a block diagram illustrating an integrated intelligence orchestration environment representing a comprehensive hardware-software ecosystem that surpasses existing scheduling and orchestration frameworks for large language models and other AI workloads by synergistically combining multiple advanced technologies.

The self-evolving neural fabric controller 2900 serves as the central orchestration mechanism, employing predictive policy gradients to anticipate computational requirements, implement dynamic workload distribution across heterogeneous accelerator types, and ensure robust fault tolerance through intelligent resource allocation. This adaptive controller continuously optimizes system performance by leveraging historical workload patterns and real-time performance metrics to make informed scheduling decisions, dynamically adjusting resource allocation strategies to accommodate shifting computational demands. By incorporating reinforcement learning techniques that refine allocation policies over time, the controller achieves increasingly efficient workload distribution across diverse hardware accelerators while maintaining resilience against hardware failures or performance anomalies, thereby establishing a self-improving foundation for the entire orchestration environment.

The system integrates two complementary modules that manage memory and computational resources with unprecedented efficiency. The tensor-integrated intelligent memory orchestration module (TIMO) 2910 unifies memory hierarchies under an adaptive scheduling layer through its tensor decomposition engine 2911 and adaptive precision memory controller 2912. The tensor decomposition engine 2911 implements advanced methodologies including tensor-train and tucker decomposition, augmented by reinforcement learning optimization that dynamically partitions and distributes tensors across available accelerators. This approach ensures optimal utilization of computational resources while minimizing memory overhead through intelligent workload factorization. Working in concert with this engine, the adaptive precision memory controller 2912 employs error propagation metrics to continuously modulate numerical Precision Scaling at element- or tensor-wise granularity, enabling throughput optimization that balances computational efficiency, power consumption, and model accuracy far more effectively than conventional static precision approaches. On the computational side, the neuromorphic sparse attention accelerator module (NSAAM) 2920 introduces biologically-inspired spike-based computing engines 2921 that handle attention operations with sparse attention mechanisms achieving logarithmic scalability rather than the quadratic complexity of traditional dense attention implementations. These engines employ saliency processing to selectively focus computational resources on the most relevant data segments, substantially boosting performance for large-scale inference tasks. Complementing this approach, the adaptive tensor-flow pruning module 2922 implements on-the-fly pruning informed by tensor-flow analytics identifying and discarding less relevant intermediate states to achieve memory traffic reduction and free bandwidth for critical computations.

The system's long-term resilience and persistent capabilities are ensured through the multi-modal cognitive persistent memory architecture (MMC-PMA) 2930 which implements a sophisticated multi-layered approach to data storage and retrieval. This architecture weaves together complementary memory layers including semantic 2931, Episodic 2932, and neurosymbolic 2933 storage systems that enable context-aware inference and highly flexible retrieval of past computations or system states. The semantic layer 2931 organizes information according to conceptual relationships and meaning, while the episodic layer 2932 maintains temporal sequences and historical context. The neurosymbolic layer 2933 bridges connectionist and symbolic representations, enabling both statistical inference and logical reasoning capabilities. Together, these layers create a comprehensive memory infrastructure that supports complex reasoning, maintains contextual awareness across long time horizons, and enables efficient knowledge transfer between different computational domains or tasks. This cognitive architecture enables the system to maintain persistent state information, learn from previous executions, and continuously refine its operational parameters based on accumulated experience, significantly enhancing performance for iterative or sequential workloads that benefit from historical context.

Security and protection against emerging threats are provided by the quantum-resilient multi-domain trust framework (QR-MTF) 2940 which implements comprehensive safeguards through two primary components. The quantum-resistant cryptography module 2941 enforces post-quantum protocols robust key distribution mechanisms and comprehensive cryptographic hardening to ensure that sensitive data and computational processes remain secure even against attacks leveraging quantum computing capabilities. Operating in tandem with these cryptographic protections, the secure domain isolation 2942 implements strict resource protection, data isolation, and threat mitigation measures that prevent unauthorized access or data leakage between secured domains. At the foundation of the environment, the heterogeneous hardware integration layer 2950 enables seamless operation across diverse computing platforms including GPUs 2951, FPGAs 2952, TPUs 2953, CPU Clusters 2954, Neuromorphic processors 2955, and even Quantum computing resources 2956 where applicable. This comprehensive integration layer abstracts hardware-specific details, allowing higher-level components to operate efficiently across heterogeneous computing resources while maximizing performance through hardware-aware optimizations. By combining these advanced capabilities—tensor-based memory orchestration, neuromorphic sparse computation, multi-modal persistent memory, and quantum-resilient security—within a unified orchestration framework, the system achieves unprecedented levels of performance, adaptability, and security for large-scale AI workloads, substantially exceeding the capabilities of conventional platforms and enabling more efficient deployment of increasingly complex artificial intelligence models.

In another novel embodiment, an integrated intelligence orchestration environment is introduced that surpasses existing scheduling and orchestration frameworks for LLMs and other AI workloads by combining multiple advanced innovations into a single, cohesive, and highly scalable hardware-software ecosystem. This architecture delivers substantially enhanced performance, adaptability, and security through synergistic orchestration of heterogenous accelerators, intelligent memory subsystems, and dynamic scheduling layers. By seamlessly merging breakthroughs in tensor decomposition, neuromorphic sparse processing, adaptive precision control, multi-modal memory structuring, and quantum-resilient data protection, the proposed environment ensures robust, future-proof operations across diverse large-scale AI and high-performance computing workloads.

A key pillar of this environment is a Tensor-Integrated Intelligent Memory Orchestration Module (TIMO) that unifies memory hierarchies and computational resources under an adaptive scheduling layer. TIMO applies advanced tensor decomposition methodologies—such as Tensor-Train and Tucker—augmented by reinforcement-learning-based optimization. These techniques dynamically partition and distribute tensors across accelerators, ensuring optimal hardware utilization and minimal memory overhead. The orchestration layer further includes an Adaptive Precision Memory Controller (APMC), which continuously modulates numerical precision based on error propagation metrics. By applying element- or tensor-wise precision scaling in real time, the system optimizes throughput, power consumption, and model accuracy far more aggressively than conventional static or semi-dynamic frameworks.

Another core innovation lies in the Neuromorphic Sparse Attention Accelerator Module (NSAAM), an integration of biologically inspired, spike-based computing engines that handle computationally intensive attention operations in a sparse, logarithmically scalable manner. Traditional dense attention blocks suffer quadratic complexity with growing input sequence lengths, while the NSAAM selectively processes only salient data segments, providing a substantial boost in performance for large-scale inference tasks. Complementing this neuromorphic accelerator is an Adaptive Tensor-Flow Pruning Module (ATFPM), which implements on-the-fly memory state pruning informed by tensor-flow analytics. By intelligently identifying and discarding less relevant intermediate states, ATFPM reduces unnecessary memory traffic, thereby freeing bandwidth for more critical computations.

Finally, the embodiment ensures long-term resilience and security through a Multi-Modal Cognitive Persistent Memory Architecture (MMC-PMA) and a Quantum-Resilient Multi-Domain Trust Framework (QR-MTF). The MMC-PMA weaves together semantic, episodic, and neurosymbolic storage layers, enabling context-aware inference and highly flexible retrieval of past computations or system states. Meanwhile, the QR-MTF enforces quantum-resistant cryptographic protocols and secure domain isolation mechanisms that protect hardware resources and sensitive data from emerging quantum threats. By coupling these security measures with a Self-Evolving Neural Fabric Controller, which leverages predictive policy gradients to dynamically optimize workload distribution across GPUs, FPGAs, and neuromorphic cores, the environment achieves unmatched scalability, fault tolerance, and adaptive performance. Collectively, these integrated features create a future-ready orchestration ecosystem that substantially exceeds the capabilities of NVIDIA Dynamo and other conventional platforms, elevating large-scale AI processing to new heights of efficiency and robustness.

In an exemplary configuration, the Tensor-Integrated Intelligent Memory Orchestration Module (TIMO) spans multiple GPUs situated on one or more printed circuit boards (PCBs) through a specialized high-bandwidth interconnect fabric. Each GPU board hosts a dedicated TIMO controller block embedded alongside the GPU's local memory controller. This embedded controller continuously monitors memory operations, including tensor allocation, update, and retrieval events. By analyzing real-time performance statistics—such as memory throughput, latency, and usage heatmaps—the TIMO controller autonomously decides how to partition and distribute tensor blocks across available GPU memories and associated PCB interconnects. The goal is to minimize data travel distances while maximizing concurrency in computational pipelines, enabling adaptive scaling and efficient resource utilization.

Structurally, the TIMO controller block interfaces directly with dedicated bridging logic on each PCB, which is responsible for aggregating memory transactions from multiple GPU nodes and routing them through the high-speed interconnect fabric. This bridging logic includes configurable crossbar switches or advanced switchless topologies that link all GPU memory subsystems, forming a coherent “pool” of memory resources across the boards. Within this environment, the TIMO controller may dynamically shift or replicate partial tensor data among GPUs as demand fluctuates due to algorithmic constraints or workload transitions. For example, if one GPU's local memory becomes a performance bottleneck, the bridging logic—following the instructions from the TIMO controller—can redistribute relevant data segments to underutilized GPUs with available memory bandwidth, thereby reducing contention and accelerating critical kernel executions.

A further structural enhancement lies in specialized on-board memory aggregator units that function as hardware-based hubs for incoming and outgoing data streams. These aggregator units maintain a coherent view of the memory map across all GPUs on the PCB, and optionally, across multiple boards. They track tensor references and their physical storage locations, enabling the TIMO controller to rapidly access, update, and retrieve distributed data elements without requiring extensive software-level synchronization. The aggregator units additionally support advanced reliability features, such as hardware-level checkpointing and error correction, ensuring that critical tensors remain safe even in scenarios of partial node failures or transient link errors. By offloading these responsibilities to dedicated hardware, the entire memory orchestration framework experiences reduced overhead and improved real-time responsiveness.

Finally, to ensure seamless inter-board communication, the hardware fabric includes scalable link modules supporting optical or high-speed electrical connections. These links can be reconfigured or bonded on demand for large-burst tensor transfers, reducing overhead when shifting extensive model parameters during training or inference. Combined with the TIMO controller's policy engine—which learns from historical and predictive workload patterns—the system can optimize interconnect usage across boards, dynamically adjusting data flows to anticipate where upcoming computation will take place. By synchronizing hardware-based aggregator units, bridging logic, and per-GPU TIMO controllers, this architectural approach guarantees efficient, low-latency memory orchestration across multi-GPU, multi-board environments, significantly advancing the scalability and flexibility needed for modern AI and HPC workloads.

### Exemplary Computing Environment

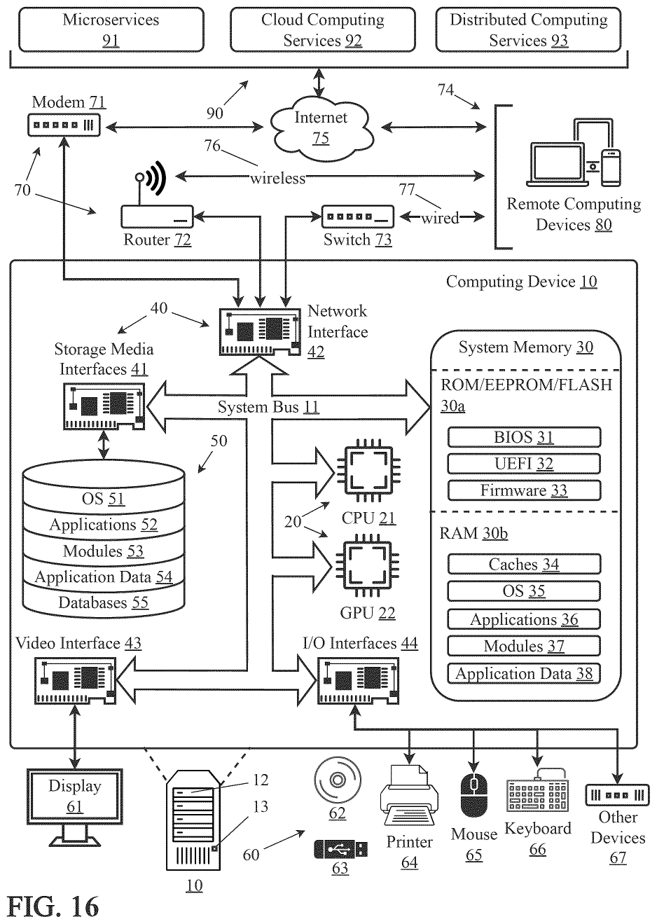

FIG. 16 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure. System bus 11 may additionally incorporate Photonic Integration Components including Integrated Laser Sources with heterogeneously integrated III-V gain media with silicon waveguides, Photonic Transceivers featuring on-package optical I/O with microring modulators (25-100 Gb/s per wavelength), Optical Switching Matrices providing non-blocking optical circuit switching capabilities, and Photonic Neural Networks with integrated phase-change materials. The bus architecture may further implement an Optical Interconnect Fabric using Active Optical Cables providing 10-25 TB/s aggregate bandwidth, Optical Backplane with passive polymer or silica waveguides embedded in PCB substrates, and Wavelength-Routed Networks with DWDM optical add-drop multiplexers. The Integrated Laser Sources specifically operate in the telecommunications-standard 1310 nm and 1550 nm wavelength bands, enabling compatibility with existing fiber optic infrastructure. The system's wavelength-division multiplexing capabilities support 32-64 independent channels per physical connection, dramatically increasing effective bandwidth while maintaining signal integrity over extended distances and reducing cross-talk between data streams.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, NVLink, BLUETOOTH® wireless interfaces, and so forth. NVLink interfaces provide high-speed, energy-efficient interconnects specifically optimized for GPU-to-GPU and GPU-to-CPU communications with throughput capabilities exceeding 25 GB/s per link direction and multi-link configurations supporting aggregate bandwidths of hundreds of GB/s. These interfaces enable coherent memory access across multiple processing elements, critical for accelerating distributed deep learning and scientific computing workloads. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10. Further, computing device 10 may comprise specialized processors including: Neural Processing Units (NPUs) with custom silicon optimized for matrix/tensor operations with 4-16 bit precision, featuring dedicated on-die memory (8-32 MB) and specialized dataflow architectures; Domain-Specific Accelerators providing custom silicon for specific workloads such as cryptography, genomics, and graph analytics with workload-optimized execution units; Reconfigurable Computing Elements featuring FPGA fabrics with high-bandwidth memory interfaces and partial reconfiguration capabilities, integrated via coherent interfaces (e.g., CCIX, CXL); and components for Quantum Computing Integration such as Quantum-Classical Interface Bridges providing standardized control signal generation and readout capabilities for various quantum processing units, along with Quantum Error Correction Modules for surface code implementation and syndrome measurement processing. These quantum computing components are further supported by Cryogenic Control Electronics featuring ultra-low-power signal conditioning and amplification circuits operating at 4K-20K temperatures, specially designed for precise quantum state manipulation and measurement. These cryogenic components enable direct interfacing with superconducting, ion trap, or photonic quantum processing units while maintaining quantum coherence.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance. System memory 30 may additionally incorporate advanced memory subsystems including: High-Bandwidth Memory Integration with HBM3/HBM4 memory stacks (4-16 GB per stack) providing 3-5 TB/s bandwidth via silicon interposers; Persistent Memory Pools featuring battery-backed or non-volatile memory regions with RDMA capabilities and atomic operation support; Computational Storage Elements with in-storage processing units providing near-data processing capabilities and programmable filtering/transformation engines; and Memory Semantic Fabrics with hardware support for global address space operations. System memory 30 may also implement advanced Memory Coherence Extensions such as Non-Uniform Cache Access (NUCA) Architecture with distributed last-level cache, Cache Coherence Domains offering configurable coherence boundaries with selective participation protocols, and Speculative Coherence Mechanisms featuring hardware predictors for coherence state transitions. These Memory Semantic Fabrics provide sophisticated capabilities including fine-grained access control mechanisms that operate at the hardware level, enabling precise permission management across distributed memory resources, along with memory-mapped device virtualization that allows consistent access patterns across heterogeneous memory technologies, significantly improving programming model coherence in complex memory hierarchies.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Interfaces 40 may leverage Advanced Packaging Technologies including Multi-Die Integration through Silicon Interposers providing 2.5D integration substrates with high-density redistribution layers, Through-Silicon Via (TSV) Arrays featuring high-aspect-ratio vertical interconnects with <1 pF capacitance, Chiplet Interfaces operating at 0.3-0.5 pJ/bit with multi-level signaling (PAM-4/PAM-8), and Active Interposers with integrated repeaters, re-timers, and protocol translation logic. These interfaces may further implement advanced Thermal Management Systems including Microfluidic Cooling Channels with integrated cooling structures providing localized hot-spot mitigation, Phase-Change Cooling Systems featuring two-phase cooling with working fluids optimized for 30-80° C. operation, and Thermoelectric Elements offering solid-state heat pumps for precision thermal gradient management at critical interfaces. The Silicon Interposers feature precisely engineered high-density redistribution layers with 1-2 μm pitch, enabling extremely dense interconnections between chiplets. Through-Silicon Via (TSV) Arrays are implemented with advanced high-aspect-ratio designs ranging from 10:1 to 20:1, maximizing vertical connection density while maintaining signal integrity. The Microfluidic Cooling Channels incorporate hydraulic diameters precisely calibrated between 50-200 μm, optimized for maximum thermal transfer efficiency while minimizing flow impedance.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

Computing device 10 may incorporate System Resilience Infrastructure to ensure reliable operation under varying conditions. This infrastructure includes Hardware Fault Detection mechanisms such as Radiation-Hardened Control Logic utilizing triple-modular redundancy for critical control paths with voter circuits, In-situ Aging Sensors featuring ring oscillator and critical path monitors for detecting timing degradation, and a Thermal Monitoring Grid with distributed thermal sensors offering 0.1° C. precision and <1 ms sampling rates. Additionally, Reliability Enhancement Features may be implemented, including Checkpoint/Restart Hardware with dedicated snapshot circuitry for register state capture with <100 ns latency, Heterogeneous Redundancy providing architectural diversity in redundant components to mitigate common-mode failures, and Progressive Degradation Management offering graceful performance throttling based on detected reliability metrics and lifetime prediction models.

Computing device 10 may implement comprehensive Hardware Security Infrastructure including Root-of-Trust Components such as Physical Unclonable Functions (PUFs) providing device-unique identifiers with >128-bit entropy, Secure Enclaves featuring isolated execution environments with hardware memory encryption and attestation mechanisms, and Cryptographic Accelerators with dedicated engines for AES, RSA, and ECC including side-channel attack countermeasures. Runtime Security Monitors may also be incorporated, implementing Hardware-Assisted Control Flow Integrity with shadow stack implementations and indirect branch monitoring, Memory Safety Engines providing temporal and spatial memory safety verification with minimal performance overhead, and Side-Channel Defenses featuring power and electromagnetic emission equalization circuits.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that enables packaging and running applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system, comprising:
a hardware memory, wherein the computer system is configured to execute software instructions stored on nontransitory machine-readable storage media comprising software instructions that:
receive non-human animal neural signal data;
receive non-human animal vocalization data that corresponds to the neural signal data;
receive non-human animal behavioral data that corresponds to the vocalization data;
receive metadata that corresponds to the neural signal data;
process the neural signal data, vocalization data, behavioral data, and metadata through a knowledge curation and generational learning subsystem, wherein the knowledge curation and generational learning subsystem is configured to:
associate received metadata with the neural signal data, vocalization data, and behavioral data;
input the neural signal data, vocalization data, behavioral data, and associated metadata to a large language model (LLM);
obtain an adaptive animal training curriculum from the LLM; and
render and present an audio/visual form of the adaptive animal training curriculum on an output device of the computing device.

2. The computer system of claim 1, wherein the knowledge curation and generational learning subsystem further comprises a phylogenetic analyst agent, wherein the phylogenetic analyst agent is configured to generate a phylogenetic tree based on the received non-human animal vocalization data.

3. The computer system of claim 2, wherein the computer system is further configured to generate a time-calibrated phylogenetic tree based on the generated phylogenetic tree, based on divergence times encoded into the received metadata.

4. The computer system of claim 1, wherein the LLM is further configured to generate one or more trait distributions based on the received non-human animal vocalization data, and wherein the knowledge curation and generational learning subsystem further comprises an embeddings cache, wherein the embeddings cache is configured to enable storage and retrieval of intermediate embeddings corresponding to the one or more trait distributions.

5. The computer system of claim 1, wherein the knowledge curation and generational learning subsystem further comprises a knowledge base, wherein the knowledge base is configured to enable storage and retrieval of knowledge representations derived from one or more animals.

6. The computer system of claim 1, wherein the knowledge curation and generational learning subsystem further comprises a geospatial information system, wherein the geospatial information system is configured to enable spatiotemporal tagging of the received non-human animal neural signal data.

7. The computer system of claim 1, wherein the knowledge curation and generational learning subsystem further comprises a multimodal reinforcement module, wherein the multimodal reinforcement module is configured to output one or more neural hints with audio patterns that correspond to the adaptive animal training curriculum.

8. The computer system of claim 7, wherein the multimodal reinforcement module is further configured to modify at least one of a pitch, tempo, and rhythm of the audio patterns.

9. A method for phylogenetic-based curating and transferring of knowledge across generations of animals, comprising:
receiving non-human animal neural signal data;
receiving non-human animal vocalization data that corresponds to the neural signal data;
receiving non-human animal behavioral data that corresponds to the vocalization data;
receiving metadata that corresponds to the neural signal data;
processing the neural signal data, vocalization data, behavioral data, and metadata through a knowledge curation and generational learning subsystem, wherein the knowledge curation and generational learning subsystem is configured to:
associate received metadata with the neural signal data, vocalization data, and behavioral data;
input the neural signal data, vocalization data, behavioral data, and associated metadata to a large language model (LLM);
obtain an adaptive animal training curriculum from the LLM; and
render and presenting an audio/visual form of the adaptive animal training curriculum on an output device of a computing device.

10. The method of claim 9, further comprising generating a phylogenetic tree based on the received non-human animal vocalization data.

11. The method of claim 10, further comprising generating a time-calibrated phylogenetic tree based on the generated phylogenetic tree, based on divergence times encoded into the received metadata.

12. The method of claim 9, further comprising:
generating one or more trait distributions based on the received non-human animal vocalization data; and
storing and retrieving intermediate embeddings corresponding to the one or more trait distributions in an embedding cache.

13. The method of claim 9, further comprising storing and retrieving knowledge representations derived from one or more animals in a knowledge base.

14. The method of claim 9, further comprising performing spatiotemporal tagging of the received non-human animal neural signal data.

15. The method of claim 9, further comprising using a multimodal reinforcement module to output one or more neural hints with audio patterns that correspond to the adaptive animal training curriculum.
